(19) United States
(12) Patent Application Publication
(10) Pub. No.: US 2002/0107873 A1
(43) Pub. Date: Aug. 8, 2002

(54) System and method for data collection, reporting, and analysis of fleet vehicle information

(75) Inventors: Mark Alan Winkler, Iowa City, IA (US); Troy Daniel Fridley, Nichols, IA (US); Dennis R. Hall, Muscatine, IA (US)

Correspondence Address: LEYDIG VOIT & MAYER, LTD, 6815 WEAVER ROAD, ROCKFORD, IL, 61114-8018, US

(73) Assignee: Bandag Licensing Corporation, Muscatine, IA

(21) Appl. No.: 10/083,260

(22) Filed: Oct. 19, 2001

Related U.S. Application Data
(60) Provisional application No. 60/267,062, filed on Feb. 7, 2001.

(51) Int. Cl. G06F 7/00

(52) U.S. Cl. 707/104.1

(57) ABSTRACT

Presented is a system and method of providing centralized management and analysis of fleet information. The system includes a centralized fleet information management server accessible via a communications network to thin clients. The communications network may be the Internet, and the thin clients are required to have only a web browser application to fully access the functionality of the server. A portable computing device, such as a Windows CE or Palm compatible device, may be used with an installed application program to conduct on-site, off-line inspections. The portable device includes a local database that may be populated with fleet information downloaded from the fleet information management server. Upon completion of the on-site inspection, the data stored in the local database may be uploaded to the server. The server may be used by thin clients to generate various reports based on the fleet data, including the estimation of operating cost savings.

### CROSS-REFERENCE TO RELATED PATENT APPLICATIONS

The present application is related to U.S. Provisional Application, serial No. 60/267,062, filed Feb. 7, 2001, the teachings and disclosure of which is hereby incorporated in its entirety by reference thereto.

### FIELD OF THE INVENTION

The present invention relates generally to collection and analysis tools for processing fleet vehicle information, and more particularly to collection and analysis tools for tracking tire and retread information for dispersed fleet vehicles.

### BACKGROUND OF THE INVENTION

Transportation companies and even manufacturing and retail companies that have their own transportation fleets, however small, have a need to track information about their vehicles. By tracking information about various operating parameters of their transportation vehicles, appropriate preventative maintenance may be scheduled in a timely manner to avoid more costly repairs that may be needed after a breakdown. However, in order to fully realize the benefits of fleet information management, the costs of collecting, analyzing, and distributing this information to the proper parties must not exceed the benefits gained thereby.

Particularly for transportation companies and companies that transport their merchandise over long distances, tracking tire wear and performance for their fleet is of heightened importance, both from a safety and an operating cost perspective. Possibly no other single component of an over-the-road vehicle contributes as much to, and may have the greatest impact on, the operational performance, cost, and safety of the vehicle. Tracking tire tread wear, tire pressure, valve performance, lug nut wear, etc. are all critical for such vehicles. Excessive tread wear can adversely affect the safety of the vehicle. Over and under inflation (which also affects fuel economy), valve performance, and lug nut wear all contribute to this excessive tread wear, as does simply operating the vehicle over time. As a result, tire and re-tread dealers have undertaken to provide this tracking to aid their transportation customers.

Unfortunately, current methods for providing this fleet tire performance tracking is quite labor intensive. Often, two people are needed to perform the vehicle tire inspections, especially for 18-wheeled over-the-road vehicles. While one person crawls around the vehicle measuring tire parameters, the other person in this two-person team records the information on preprinted forms. These forms are then taken back to the dealership where the hand written information is then typically given to a data entry clerk or secretary who recreates the information in typewritten form to improve legibility. For larger dealers and retread companies, the typed forms are then mailed or faxed to a central location where the data is entered into a computer system. A report for that particular dealer is then generated and mailed back to him so that the dealer can provided suggestions to the transportation company about their tire replacement and retread needs. Unfortunately, in addition to being labor intensive and prone to mistake, the long turn-around time from vehicle inspection to report generation and action plan development is quite long, often exceeding two weeks. This is unacceptable from both the dealer and operator perspective as detected conditions that may need addressed continue to exist during this period. While typically dealers immediately address any true safety issues, operational cost issues must often wait for the report cycle to be completed.

In recognition of this problem from a local dealer perspective, at least one tire tracking system has been produced that attempts to automate and computerize the tire inspection/action plan generation process. This system allows a single inspector at a local dealership to enter data in a custom handheld device, and then download that data to that dealer's office computer. The computer tracks individual tires sold by that dealer over each of the tires entire operational lives, from the time of each tire's sale to its final removal from service.

Unfortunately, this system requires the purchase of custom handheld hardware in addition to the software to be installed at the dealer's office. This system also does not allow for any type of national, regional, or even multi-dealer/location tracking of a transportation fleet. Such a limitation is unacceptable. Further, this existing system provides only individual tire tracking. It is unable to provide any type of fleet-wide extrapolation of measured tire data to allow a fleet manager to develop a preventative maintenance program. It only allows for reaction to existing problems once they are detected, it does not permit proactive maintenance. This presents a serious limitation in that operational costs cannot be optimized by preventing the occurrence of a problem before it affects fleet operations.

There exists, therefore, a need in the art for a system that minimizes the labor required to complete vehicle tire inspections, that provides the ability to assimilate data from multiple locations, and that provides operational trend reporting and action plan generation across an entire regionally, nationally, or globally dispersed fleet.

### BRIEF SUMMARY OF THE INVENTION

In view of the above, it is an object of the present invention to provide a new and improved fleet collection and analysis tool. More particularly, it is an object of another aspect of the invention to provide a new and improved fleet collection and analysis tool that can centrally assimilate information collected from various locations and provide reporting at a dealer and fleet level. It is a further object of another aspect of the present invention to provide such a tool that is capable of projecting trends from the collected information to enable the development of preventive maintenance programs. It is a further object of another aspect of the invention to provide such a tool that generates proposed maintenance programs and projects cost savings associated therewith.

In accordance with at least one of the above objects, it is a feature of an embodiment of the present invention to provide handheld computerized entry of inspection data without requiring customized hardware. Further, it is a feature of an embodiment of the present invention to provide wireless communication and exchange of fleet tire information with a local or centralized data store. It is an additional feature of an embodiment of the present invention to provide web-based access, data exchange, and report generation for both dealers and fleet managers on a global basis. Multi-language support is also a feature of an embodiment of the present invention.

The tool of the present invention aids dealers to collect, organize, and report current fleet tire conditions in a structured and efficient way. This facilitates analysis, suggestion of corrective/improved courses of action, and provides unique selling propositions based on providing actionable information based on fleet data. The results from fleet locations may be globally “rolled-up” into summary and comparative reports that may be supplied in the language of the particular customer. The data collection process and the accuracy of the collected data are both improved, as is the reporting processes, all with reduced cost and turn around time.

In one embodiment of the present invention, a web-based, centralized fleet tire information management system comprises a centralized production database and a fleet information management server. This server includes data communication circuitry that is adapted to connect to a distributed communications network, such as the Internet or an intranet. The server also includes business logic. The fleet information management server accesses the production database for the storage and retrieval of fleet information. Preferably, the fleet information management server has stored therein web pages accessible by thin clients to accept and supply fleet tire information. The thin clients are users that are only required to have a browser application to access the full functionality of the system of the present invention.

As an alternate embodiment of the present invention, a method of maintaining fleet tire information is presented. This method comprises the steps of launching an Internet browser application, connecting to a centralized fleet information management server through the Internet browser application, transmitting authentication information to the centralized fleet information management server, and accessing fleet tire information stored at the fleet information management server.

In yet a further alternate embodiment, a method of performing a fleet tire inspection is presented. In this embodiment the method also comprises the steps of launching an Internet browser application and connecting to a centralized fleet information management server through the Internet browser application. The method further comprises the steps of downloading fleet information to a portable computing device from the fleet information management server, and recording tire inspection data on the portable computing device.

The present invention also contemplates the still further alternate embodiment of a method of performing a fleet tire inspection. In this embodiment the method comprises the steps of launching an Internet browser application and connecting to a centralized fleet information management server through the Internet browser application. Further, the method includes the steps of accessing a fleet tire inspection page on the fleet information management server and recording tire inspection data on the fleet tire inspection page on the fleet information server.

Also presented as an embodiment of the present invention is a computer-readable medium having computer-executable instructions for performing steps stored thereon. These steps stored on the computer-readable medium comprise storing fleet profile information in a local database and displaying a user interface screen having a plurality of data entry fields. Further, the steps include receiving data input associated with the data entry fields and storing the data input in the local database. The steps of connecting to a web-based fleet information management server, and uploading the data input from the local database to the fleet information management server are also included in this embodiment.

As a further alternate embodiment, a method of determining an operational cost savings in a fleet tire management program by addressing a tire characteristic parameter is presented. In this embodiment, the method comprises the steps of selecting the tire characteristic parameter having an operational cost impact for a fleet vehicle, determining a number of tire samples that possess the selected tire characteristic parameter, and multiplying the number of tire samples by an operational cost impact factor. Examples of such operational cost savings parameters relate to crude oil consumption, scrapping of casings, use of retreads as spares, improper inflation, etc.

Other objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention in relation to several embodiments of the invention, and together with the description serve to explain the principles of the invention. In the drawings:

FIG. 1 is a simplified data capture framework illustration of an embodiment of the global fleet analyzer tool of the present invention;

FIG. 2 is a server model diagram of an embodiment of the present invention;

FIG. 3 is a server model diagram of an alternate embodiment of the present invention;

FIG. 4 is a simplified data reporting framework illustration of an embodiment of the present invention;

FIG. 5 is a simplified data analysis framework illustration of an embodiment of the present invention;

FIG. 6 is a simplified functional relationship illustration of the structure of the global fleet analyzer tool of an embodiment of the present invention;

FIG. 7 is a flow diagram illustrating inheritance of fleet information in an embodiment of the present invention;

FIG. 8 is a functional diagram illustrating the entrance of data values into an embodiment of the present invention;

FIG. 9 is a simplified workflow diagram of an embodiment of the present invention;

FIG. 10 is a functional dealer access diagram of an embodiment of the present invention;

FIG. 11 is an overall functional access rights diagram of an embodiment of the present invention;

FIG. 12 is a functional flow diagram illustrating the report generation process of an embodiment of the present invention;

FIG. 13 is a block diagram illustrating the logical entity relationships of an embodiment of the present invention;

FIG. 14 is a flow diagram illustrating fleet registration in accordance with an embodiment of the present invention;

FIG. 15 is a flow diagram illustrating an inspection registration flow in accordance with an embodiment of the present invention;

FIG. 16 is a handheld-based user interface screen illustration of a “GFAT” screen generated by an embodiment of the present invention;

FIG. 17 is a handheld-based user interface screen illustration of a “Survey List” screen generated by an embodiment of the present invention;

FIG. 18 is a handheld-based user interface screen illustration of a “Location/General” screen generated by an embodiment of the present invention;

FIG. 19 is a handheld-based user interface screen illustration of a “Location/Language” screen generated by an embodiment of the present invention;

FIG. 20 is a handheld-based user interface screen illustration of a “Vehicle Classification” screen generated by an embodiment of the present invention;

FIG. 21 is a handheld-based user interface screen illustration of a “Vehicle Classification/General” screen generated by an embodiment of the present invention;

FIG. 22 is a handheld-based user interface screen illustration of a “Vehicle Classification/Axle Types” screen generated by an embodiment of the present invention;

FIG. 23 is a handheld-based user interface screen illustration of a “Vehicle Classification/Matrix” screen generated by an embodiment of the present invention;

FIG. 24 is a handheld-based user interface screen illustration of a “Vehicle Classification/Matrix pull down” screen generated by an embodiment of the present invention;

FIG. 25 is a handheld-based user interface screen illustration of an “OOSTA/General” screen generated by an embodiment of the present invention;

FIG. 26 is a handheld-based user interface screen illustration of an “OOSTA/Participants” screen generated by an embodiment of the present invention;

FIG. 27 is a handheld-based user interface screen illustration of an “OOSTA Tires” screen generated by an embodiment of the present invention;

FIGS. 28A-C are a handheld-based user interface screen illustration of an “OOSTA-Tire/Readings” screen generated by an embodiment of the present invention;

FIG. 29 is a handheld-based user interface screen illustration of an “OOSTA Tire/Condition Codes” screen generated by an embodiment of the present invention;

FIG. 30 is a handheld-based user interface screen illustration of an “In Service/General” screen generated by an embodiment of the present invention;

FIG. 31 is a handheld-based user interface screen illustration of an “In Service/Participants” screen generated by an embodiment of the present invention;

FIG. 32 is a handheld-based user interface screen illustration of an “In Service Vehicles” screen generated by an embodiment of the present invention;

FIG. 33 is a handheld-based user interface screen illustration of an “In Service Vehicle/Vehicle” screen generated by an embodiment of the present invention;

FIG. 34 is a handheld-based user interface screen illustration of an “In Service Vehicle/Comment” screen generated by an embodiment of the present invention;

FIG. 35 is a handheld-based user interface screen illustration of an “In Service Tires” screen generated by an embodiment of the present invention;

FIGS. 36A-B are a handheld-based user interface screen illustration of an “In Service-Tires/Details” screen generated by an embodiment of the present invention;

FIGS. 37A-B are a handheld-based user interface screen illustration of an “In Service-Tire/Visual” screen generated by an embodiment of the present invention;

FIG. 38 is a handheld-based user interface screen illustration of an “In Service Tire/Conditions” screen generated by an embodiment of the present invention;

FIG. 39 is a handheld-based user interface screen illustration of an “In Service Tire/Actions” screen generated by an embodiment of the present invention;

FIG. 40 is a handheld-based user interface screen illustration of a “Vehicle Inspection/General” screen generated by an embodiment of the present invention;

FIG. 41 is a handheld-based user interface screen illustration of a “Vehicle Inspection/Participants” screen generated by an embodiment of the present invention;

FIG. 42 is a handheld-based user interface screen illustration of a “Vehicle Inspection-Vehicles” screen generated by an embodiment of the present invention;

FIG. 43 is a handheld-based user interface screen illustration of a “Vehicle Inspection-Vehicle/Vehicle” screen generated by an embodiment of the present invention;

FIG. 44 is a handheld-based user interface screen illustration of a “Vehicle Inspection-Vehicle/Category 1” screen generated by an embodiment of the present invention;

FIG. 45 is a handheld-based user interface screen illustration of a “Vehicle Inspection-Vehicle/Category 2” screen generated by an embodiment of the present invention;

FIG. 46 is a handheld-based user interface screen illustration of a “Perf. Test/General” screen generated by an embodiment of the present invention;

FIG. 47 is a handheld-based user interface screen illustration of a “Perf. Test/Participants” screen generated by an embodiment of the present invention;

FIG. 48 is a handheld-based user interface screen illustration of a “Perf. Test Vehicles” screen generated by an embodiment of the present invention;

FIG. 49 is a handheld-based user interface screen illustration of a “Perf. Test Tires” screen generated by an embodiment of the present invention;

FIGS. 50A-C are handheld-based user interface screen illustrations of “Perf. Test-Tires/Inspect” screens generated by an embodiment of the present invention;

FIG. 51 is a flow diagram illustrating out of service tire analysis (OOSTA) using a handbeld device in accordance with an embodiment of the present invention;

FIG. 52 is a flow diagram illustrating out of service tire analysis (OOSTA) using a web-based interface device in accordance with an embodiment of the present invention;

FIG. 53 is a flow diagram illustrating out of service tire analysis (OOSTA) using printed web-based forms in accordance with an embodiment of the present invention;

FIG. 54 is a flow diagram illustrating in service tire analysis using a handheld device in accordance with an embodiment of the present invention;

FIG. 55 is a flow diagram illustrating in service tire analysis using a web-based interface device in accordance with an embodiment of the present invention;

FIG. 56 is a flow diagram illustrating in service tire analysis using printed web-based forms in accordance with an embodiment of the present invention;

FIG. 57 is a flow diagram illustrating performance testing using a handheld device in accordance with an embodiment of the present invention;

FIG. 58 is a flow diagram illustrating performance testing using printed web-based forms in accordance with an embodiment of the present invention;

FIG. 59 is a flow diagram illustrating vehicle inspection using a handheld device in accordance with an embodiment of the present invention;

FIG. 60 is a flow diagram illustrating vehicle inspection using printed web-based forms in accordance with an embodiment of the present invention;

FIG. 61 is a web-based user interface screen illustration of a “Recently Used” screen generated by an embodiment of the present invention;

FIG. 62 is a web-based user interface screen illustration of a “Search for Fleet” screen generated by an embodiment of the present invention;

FIG. 63 is a web-based user interface screen illustration of a “Fleet Maintenance” screen generated by an embodiment of the present invention;

FIG. 64 is a web-based user interface screen illustration of a “Search for Fleet Location” screen generated by an embodiment of the present invention;

FIG. 65 is a web-based user interface screen illustration of a “Fleet Location Maintenance” screen generated by an embodiment of the present invention;

FIG. 66 is a web-based user interface screen illustration of a “Search for Dealer” screen generated by an embodiment of the present invention;

FIG. 67 is a web-based user interface screen illustration of a “Dealer Location HQ Maintenance” screen generated by an embodiment of the present invention;

FIG. 68 is a web-based user interface screen illustration of a “Search for Dealer Locations” screen generated by an embodiment of the present invention;

FIG. 69 is a web-based user interface screen illustration of a “Dealer Locations/Franchises Maintenance” screen generated by an embodiment of the present invention;

FIG. 70 is a web-based user interface screen illustration of a “Fleet Vehicle Types” screen generated by an embodiment of the present invention;

FIG. 71 is a web-based user interface screen illustration of a “Location Vehicles” screen generated by an embodiment of the present invention;

FIG. 72 is a web-based user interface screen illustration of a “Search for Surveys” screen generated by an embodiment of the present invention;

FIG. 73 is a web-based user interface screen illustration of another “Search for Surveys” screen generated by an embodiment of the present invention;

FIG. 74 is a web-based user interface screen illustration of an “In Service Tire Inspection” screen generated by an embodiment of the present invention;

FIG. 75 is a web-based user interface screen illustration of an “In service Inspection-Vehicle overview” screen generated by an embodiment of the present invention;

FIG. 76 is a web-based user interface screen illustration of an “In service Inspection analysis” screen generated by an embodiment of the present invention;

FIG. 77 is a web-based user interface screen illustration of an “Out Of Service Analysis” screen generated by an embodiment of the present invention;

FIG. 78 is a web-based user interface screen illustration of an “Out of service analysis-Tire overview” screen generated by an embodiment of the present invention;

FIG. 79 is a web-based user interface screen illustration of another “Out of service analysis” screen generated by an embodiment of the present invention;

FIG. 80 is a web-based user interface screen illustration of a “Vehicle Inspection” screen generated by an embodiment of the present invention;

FIG. 81 is a web-based user interface screen illustration of another “Vehicle Inspection” screen generated by an embodiment of the present invention;

FIG. 82 is a web-based user interface screen illustration of a “Search for Reports” screen generated by an embodiment of the present invention;

FIG. 83 is a web-based user interface screen illustration of another “Search for Reports” screen generated by an embodiment of the present invention;

FIG. 84 is a web-based user interface screen illustration of a “Select Surveys for the Report” screen generated by an embodiment of the present invention;

FIG. 85 is a web-based user interface screen illustration of a “Report Maintenance” screen generated by an embodiment of the present invention;

FIG. 86 is a web-based user interface screen illustration of a “Download Surveys” screen generated by an embodiment of the present invention;

FIG. 87 is a web-based user interface screen illustration of a “Fleet tire types” screen generated by an embodiment of the present invention;

FIG. 88 is a “Tires Inspected by Vehicle Type” report component generated by the global fleet analyzer tool of an embodiment of the present invention;

FIG. 89 is a “Casing Brands by Vehicle Type” report component generated by the global fleet analyzer tool of an embodiment of the present invention;

FIG. 90 is a “Retread Brand by Vehicle Type” report component generated by the global fleet analyzer tool of an embodiment of the present invention;

FIG. 91 is a “Tires Inspected by Tire Size” report component generated by the global fleet analyzer tool of an embodiment of the present invention;

FIG. 92 is a “Tires Inspected by Brand” report component generated by the global fleet analyzer tool of an embodiment of the present invention;

FIG. 93 is an “Original Tires Inspected by Brand” report component generated by the global fleet analyzer tool of an embodiment of the present invention;

FIG. 94 is a “Tires Inspected by Retread Brand” report component generated by the global fleet analyzer tool of an embodiment of the present invention;

FIG. 95 is a “Retread by Axle Type” report component generated by the global fleet analyzer tool of an embodiment of the present invention;

FIG. 96 is a “Retread Potential” report component generated by the global fleet analyzer tool of an embodiment of the present invention;

FIG. 97 is a “Spare Tires by Tire Size” report component generated by the global fleet analyzer tool of an embodiment of the present invention;

FIG. 98 is a “Tread Depth in Fleet” report component generated by the global fleet analyzer tool of an embodiment of the present invention;

FIG. 99 is an “Inflation in Fleet” report component generated by the global fleet analyzer tool of an embodiment of the present invention;

FIG. 100 is a “Valves in Fleet” report component generated by the global fleet analyzer tool of an embodiment of the present invention;

FIG. 101 is an “Immediate Actions in Fleet” report component generated by the global fleet analyzer tool of an embodiment of the present invention;

FIG. 102 is an “Immediate Actions by Axle” report component generated by the global fleet analyzer tool of an embodiment of the present invention;

FIG. 103 is a “Mismatch in Fleet” report component generated by the global fleet analyzer tool of an embodiment of the present invention;

FIG. 104 is a “Tread Depth Mismatch in Fleet” report component generated by the global fleet analyzer tool of an embodiment of the present invention;

FIG. 105 is an “Inflation Mismatch in Fleet” report component generated by the global fleet analyzer tool of an embodiment of the present invention;

FIG. 106 is a “Potential Savings” report component generated by the global fleet analyzer tool of an embodiment of the present invention;

FIG. 107 is an “Immediate Actions” report component generated by the global fleet analyzer tool of an embodiment of the present invention;

FIG. 108 is a “Work Order” report component generated by the global fleet analyzer tool of an embodiment of the present invention;

FIG. 109 is an “OOSTA Summary” report component generated by the global fleet analyzer tool of an embodiment of the present invention;

FIG. 110 is an “Usable Tread by Action” report component generated by the global fleet analyzer tool of an embodiment of the present invention;

FIG. 111 is a “Times Retreaded by Brand” report component generated by the global fleet analyzer tool of an embodiment of the present invention;

FIG. 112 is a “Casing Age by Brand” report component generated by the global fleet analyzer tool of an embodiment of the present invention;

FIG. 113 is an “OOS Category by Brand” report component generated by the global fleet analyzer tool of an embodiment of the present invention;

FIG. 114 is an “OOS Cause by Brand” report component generated by the global fleet analyzer tool of an embodiment of the present invention;

FIG. 115 is an “OOS Cause Category by Retread” report component generated by the global fleet analyzer tool of an embodiment of the present invention;

FIG. 116 is a “Casing Age by Retread Brand” report component generated by the global fleet analyzer tool of an embodiment of the present invention;

FIG. 117 is a “Casing Age by Times Retreaded” report component generated by the global fleet analyzer tool of an embodiment of the present invention; and

FIG. 118 is a “Casing Collection Note” report component generated by the global fleet analyzer tool of an embodiment of the present invention.

While the invention will be described in connection with certain preferred embodiments, there is no intent to limit the invention to those embodiments. On the contrary, the intent is to cover all alternatives, modifications and equivalents as included within the spirit and scope of the invention as defined by the appended claims. For example, the intent is to cover all suitable alternative processing and programming including alternative processing flow and software orientation. The present invention can be practiced in any computer format with any geographic separation between ports and components.

### DETAILED DESCRIPTION OF THE INVENTION

An embodiment of the present invention establishes a single standard data collection and reporting environment that may be used by tire and retread dealers for their individual local accounts, and regional, national, and global fleet managers. In this way, the system of an embodiment of the present invention is capable of reporting all activities relating to a fleet's tires at any level of reporting from a single dealership to the many thousand fleet locations for a national or global transportation company. An embodiment of the present invention provides a platform for the systematic management of a fleet's tire program that enables a dealer to provide more value added service, and allows a fleet manager to better control the operating costs associated with the fleet's tires.

The system of the present invention preferably utilizes Internet based technology to allow access to reporting information in real time on a global scale. In this way, once an in-service tire inspection is completed, the findings may be presented to the fleet manager immediately regardless of the manager's location, as opposed to the several weeks that the prior systems would have taken. Reports of immediate actions to be taken may be printed on site so that the maintenance personnel can fix a detected problem before the transportation vehicle is involved in a safety-related incident. The Internet-based centralized data accessibility is particularly suited to enable a fleet manager to compare various parameters across all of its fleet locations on both a national and global scale. Such national and global comparisons allow trends between different locations to be easily seen so the corrective actions may be targeted to the areas needed. For example, a comparison across multiple fleet locations may reveal that a single location only had 10% uninflated tires whereas the fleet as a whole had 20%. As a result of this comparison, the fleet manager may be able to model his other locations after the better performing location to improve the fleet as a whole. This comparison benchmarking, as well as the ability to trend individual locations or the entire fleet across any time period, provide a significant advantage to the management of the operational costs associated with the transportation fleet's tire management program. Specifically, by maintaining historical data records a fleet manager is able to perform comparison benchmarking for different periods of time. Such comparisons reveal an individual location's ability to maintain the fleet vehicles over time. When a negative trend of increased service problems is observed, the global fleet manager may require additional training or make personnel adjustments.

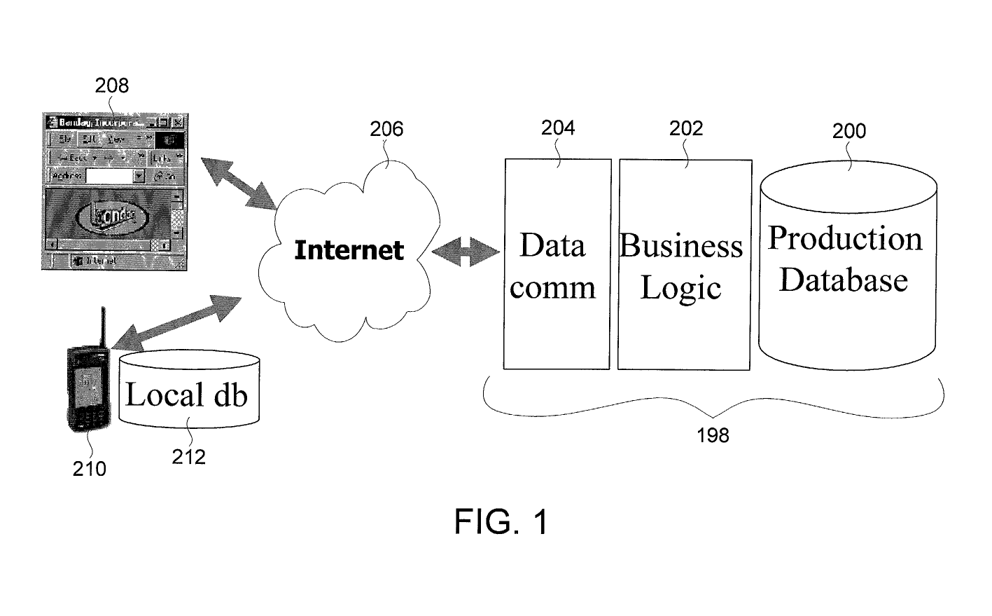

To provide the capability of monitoring fleet trends, an embodiment of the present invention utilizes an Internet based centralized analysis tool. This global fleet analyzer tool (GFAT) employs a centralized fleet information management server 198 that includes a centralized production database 200 as illustrated in FIG. 1. While particular advantage is provided by having this centralized production database 200 available on a regional/national/global scale through the web-based server 198, one skilled in the art will recognize that such a database 200 may be maintained by the individual dealer if so desired, or in other suitable manners. In association with this production database 200, business logic 202 is also provided as a front-end interface to service inquiries and requests received by the data communications circuitry/logic 204 from the Internet 206. Such business logic 202 may provide user authentication through customer ID and password or other secure communication mechanisms, such as public/private key encryption, verification of secure link, etc.

Further, the functionality of these components may be combined or separated in any suitable manner as will be appreciated by those skilled in the art. From the individual dealer perspective, entry and retrieval of customer profile, fleet profile, and fleet data information may be accomplished via a web browser application 208 that may connect to the GFAT home page. There is no requirement for the local dealership to maintain a local database or any business logic on its computer system. Accessibility to the production database 200 and the associated business logic 202 is accomplished by only having a browser application available on the local dealership's computer system. This “thin client” architecture greatly reduces the cost of implementing such a system from the individual dealership perspective, while greatly increasing that dealership's capability to provide timely reporting and analysis of the data collected by that dealership to the local transportation fleet manager. Alternatively, as will be appreciated by those in the art, the client computer could maintain data and software to perform some of the functionality. Further, there could be provided any type of link between client and the server software including but not limited to direct lines.

In an embodiment of the GFAT of the present invention, the local tire dealer may also utilize a handheld or portable computing device 210 that has loaded thereon a local database 212 and an application program to be discussed more fully below. This handheld device 210 may be preferably a Windows CE compatible device running the GFAT handheld application program thereon. Alternatively, this handheld device may be a Palm compatible device running such application or any other suitable interface. This handheld device 210 may also utilize other technology, and may be, for example, a wireless web compatible device or digital phone from which the user may access the centralized production database 200 and business logic 202. The handheld device embodiment could similarly link to a local database in any manner which later can be accessed to transfer data. This handheld device 210 may also incorporate speech recognition technology to greatly simplify the data entry process during the vehicle fleet inspection conducted by the local dealer.

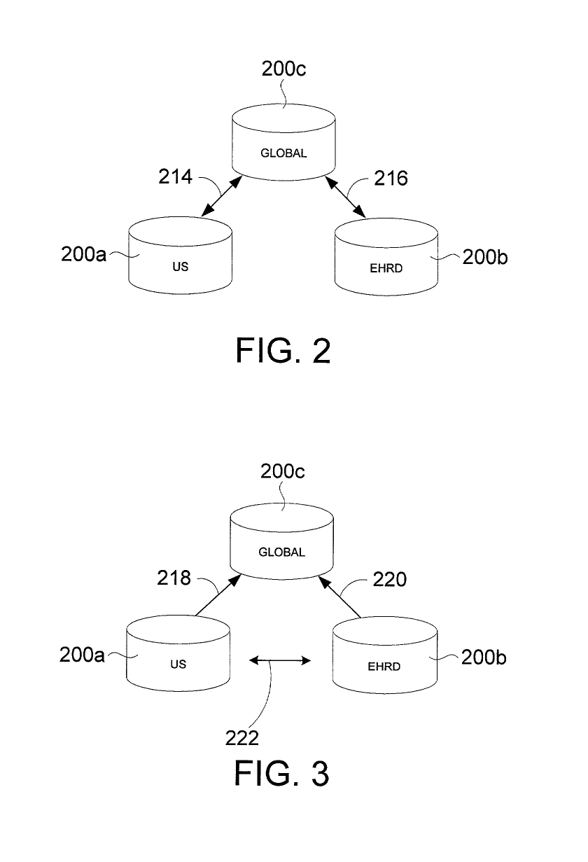

When implemented on a global scale, the centralized production database 200 may utilize a server topology such as that illustrated in FIG. 2. Under this server topology, a centralized production database 200a is established for the U.S. or North American market and a separate production database 200b is established for the European market. A global production database 200c is also established to provide data information on a global scale. This global database 200c incorporates the information from both the U.S. and European databases 200a, 200b. Also, additional production database sites may be established in each of the geographic markets served, with communication to the global database 200c. In this way, multinational transportation companies may be provided with all of the data analysis and reporting of the present invention on a global scale while their regional or national fleet managers may access only their relevant data. Under this particular server model, communication and data transfer between server sites is limited to communications between the U.S. 200a and global 200c sites through bi-directional communication 214, and between the European 200b and global 200c sites through bi-directional communication 216. Alternatively, a communications structure such as that illustrated in FIG. 3 may be established whereby communications from the U.S. and European databases 200a, 200b is one way 218, 220 to the global database 200c, but is bi-directional 222 between each of the geographically located databases 200a, 200b. Further, the client's may link to such data bases through different URLs set for the region.

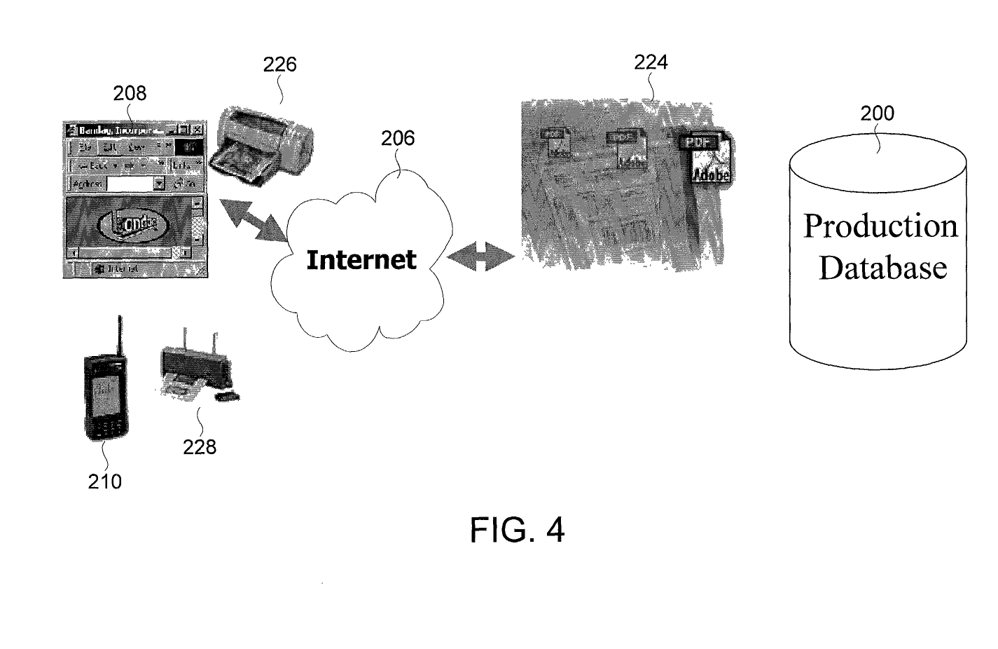

Once the data acquisition from a fleet inspection has been completed (a process that will be described more fully below), the system of the present invention may utilize the Internet-based infrastructure to provide a data reporting framework as illustrated in FIG. 4. As may be seen from this FIG. 4, the information from the production database 200 is utilized to produce a desired report 224 that is accessible to the dealer browser 208. These reports 224 may be printed by a local or networked printer 226, or by a portable wireless printer 228 at the site of the inspection. Preferably, the reports are provided in PDF format to assure good printing on each type of printing device, although they may be provided in other formats as appropriate.

In one embodiment of the system of the present invention, there is no reporting back from the production database 200 to the handheld device 210. Instead, all reports generated by the handheld device 210 are produced from the handheld device's local database 212 (see FIG. 1). In an alternate embodiment, however, the handheld or wireless web accessible device 210 may provide the same report accessibility as the browser application 208 at the dealer's location. In either of these embodiments, immediate action reporting and generation of work orders may be produced at the completion of the inspection of the transportation fleet vehicles so that the information collected may be immediately acted upon by the transportation fleet manager at that location.

The data analysis framework of the GFAT of an embodiment of the present invention is illustrated in FIG. 5. As may be seen from this FIG. 5, the production database is accessed by an analysis relational database management system (RDBMS) 230. An on-line analytical processing system, such as the Hyperion Essbase 232, provides the interface and enabling technology to the analysis RDBMS 230 to enable the analysis, data warehousing, and data mining required to generate the various reports 234 available through the GFAT of an embodiment of the present invention. Through this configuration, rapid multi-user access to consolidated enterprise performance data can be viewed from multiple dimensions, regardless of the complexity of the query. Examples of these reports will be described in greater detail below. A person skilled in the art will recognize that other suitable structures may be employed to perform the same functions.

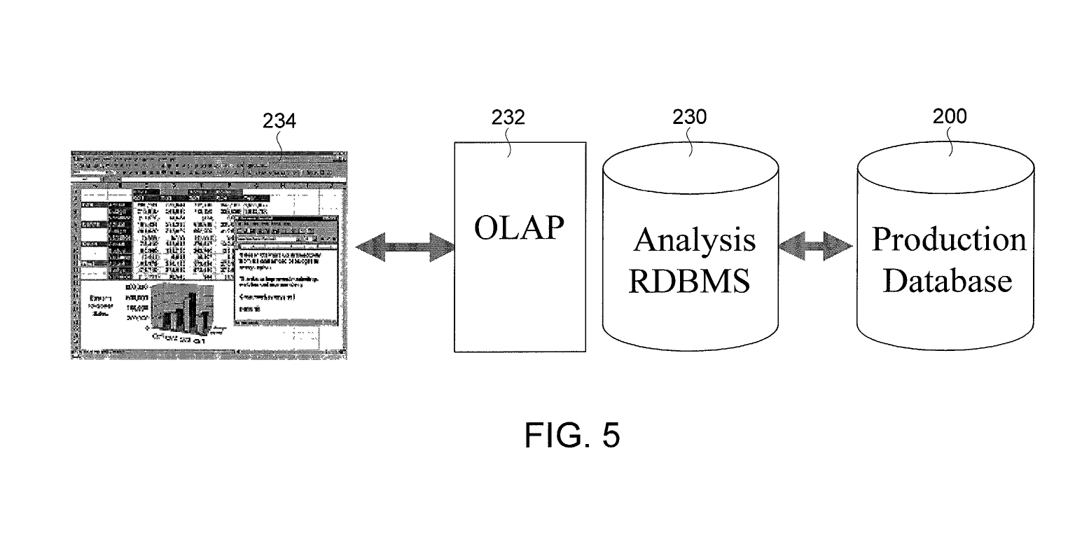

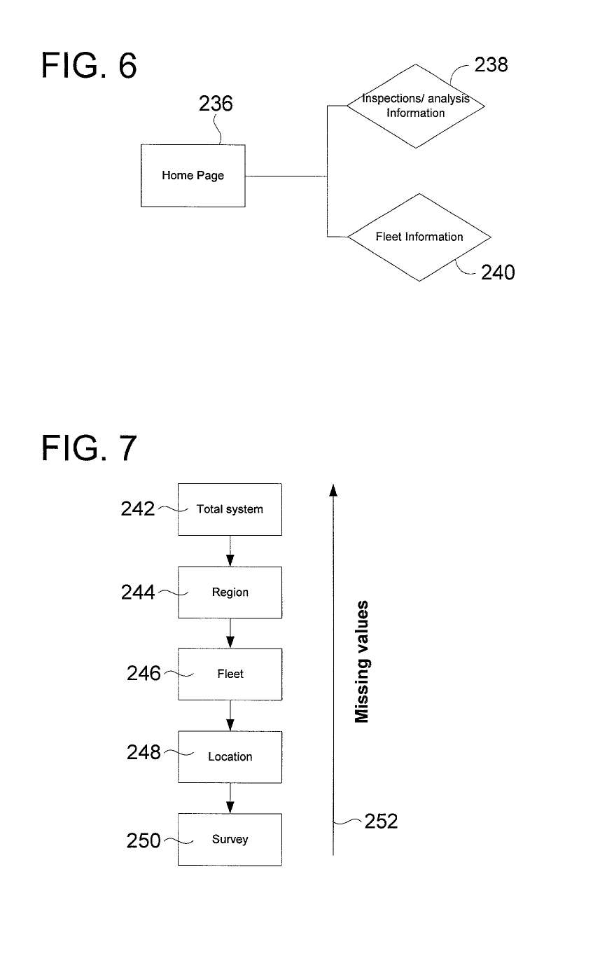

To operate the GFAT system of the present invention, a user accesses an Internet browser application, such as Internet Explorer, and connects to the GFAT home page 236 illustrated in block form in FIG. 6. An embodiment of the present invention requires that users enter their user name and password to access the GFAT application. Alternatively, the system may utilize some other security mechanism as discussed above. By checking the user name and password or other security information, an embodiment of the present invention can determine the preferences of that particular user, and automatically display web pages and output report data in the correct user language. Additionally, the system may limit access to certain information in the database, displaying only that information to which that particular user has access. The multilanguage support is preferably enabled through the utilization of the Unicode standard. Once the user has gained access to the appropriate home page 236, the user may open an inspection/analysis information page 238, or a fleet information page 240. From the inspections/analysis link 238 the user may search for the appropriate or desired group of inspections. From the fleet information link 240, the user may search for desired or appropriate fleet data.

With respect to fleet data, FIG. 7 illustrates the inheritance flow of information to construct and complete or supplement the production database 200. As illustrated in this FIG. 7, fleet information can be inherited based on its classification by the location in the architectural hierarchy to which it relates or from which it was originally entered from a top-down fashion. That is, if information exists from or related to any higher level such as the total system 242, it will be passed down to the next lower level in the system. As illustrated in FIG. 7, the flow of information proceeds from the total system 242 to the region 244 to the individual fleet 246 to the individual location 248 down to the individual survey 250. However, if any information required by the survey 250 is not provided by this information flow-down, the missing values entered in the survey 250 will be passed up 252 to complete or supplement the database. Typically, these missing values are the individual readings from the tire inspections at the dealer location. An example of information that is passed down from the total system 242 is information concerning the name and address and other corporate information of the overall fleet. By following this information flow-down architecture, the completion of the fleet inspections may be conducted with minimal effort on the part of the dealer as all of the known information throughout the system is automatically provided, thereby eliminating the necessity of re-entering information that is otherwise available in the system.

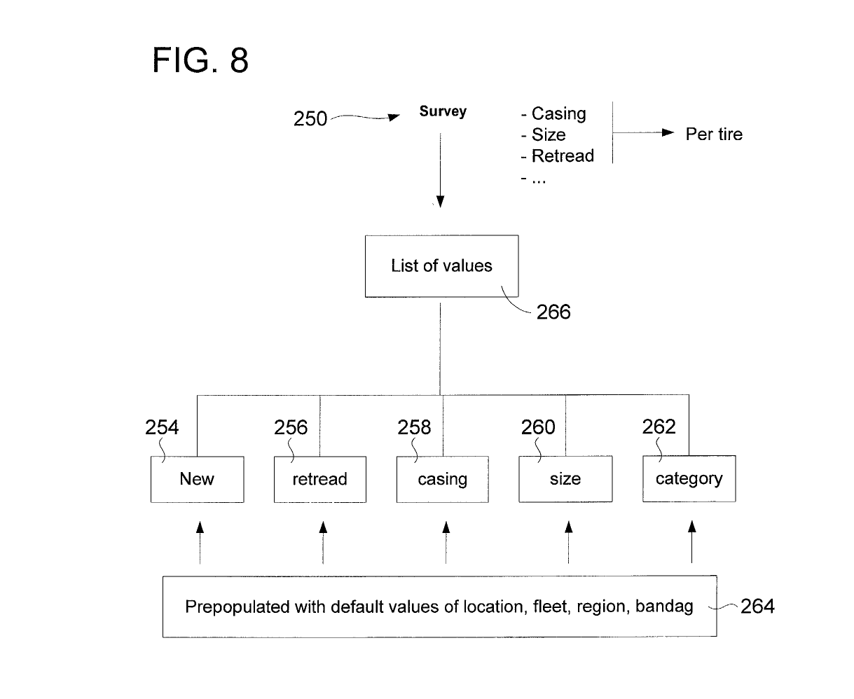

As an example of the types of information populated by the system and those intended to be completed during the survey, reference is now made to FIG. 8. As may be seen, generalized information relating to new 254, retread 256, casings 258, size 260, and category 262 of tires may all be populated with default values 264 from the higher levels of priority in the system. All of this information is utilized to provide a list of values 266 available to the survey 250. However, in completing the survey 250 the user will enter information regarding the actual casing, size, retread, etc. per tire of the inspected vehicles. This specific information is used to complete the list of values 266 that will be passed to the system and made available for the data analysis and reporting.

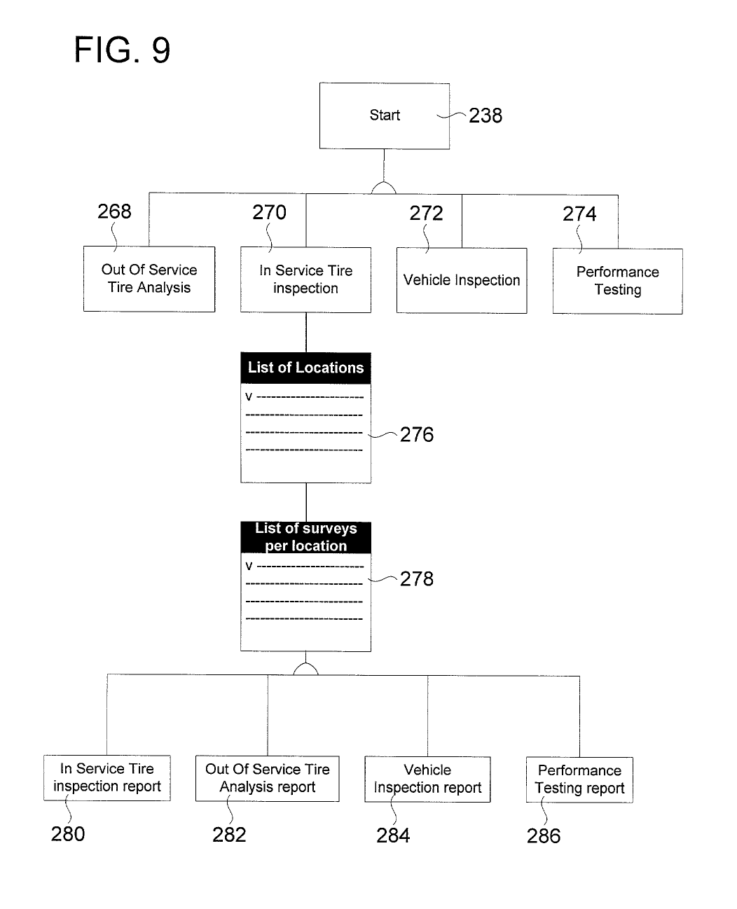

As discussed briefly above with regard to FIG. 6, an embodiment of the present invention provides the ability for a user to access the inspections/analysis information 238 as desired using a standard web browser application. The simplified screen flow of FIG. 9 illustrates this accessibility in a more detailed exemplary manner. Once the user has selected the inspections/analysis information page 238, the user is presented with various selections available through the tool. As an example, these selections may include an out-of-service tire analysis 268, an in-service tire inspection 270, a vehicle inspection 272, and performance testing 274. The details of each of these exemplary selections will be discussed more fully below with regard to the various flow diagrams presented herein. As an example of the typical flow, however, assume that a user has selected the in-service tire inspection 270. Such selection provides the user with a list of locations 276 for which the in-service tire inspection data is available, or possibly the ability to add a new location. Once the user has selected an appropriate location 276, the user is presented with a list of surveys that are available for the selected location 278. Examples of such surveys may include an in-service tire inspection report 280, an out-of-service tire analysis report 282, a vehicle inspection report 284, and a performance testing report 286.

While FIG. 9 illustrates the accessibility of various inspections/analysis reports by a user, the particular type of access granted to the user depends upon the classification of that user. FIG. 10 illustrates in greater detail these different types of access classifications to an embodiment of the GFAT system. Typical users or dealers 288 have creation access with regard to creating new fleets, locations, and entering fleet survey information 290 into the GFAT system of the present invention. Once the dealer 288 has created a fleet, location, or entered survey information 290, the dealer's headquarters 292 has read access to all items that the dealer has created. Of course, all authorized users of such embodiment of the GFAT system of the present invention have default read access to at least a portion of the information contained therein. Specifically, this default read access is segregated only to the applicable fleets for which the user has been authorized. That is, information concerning other fleets is not accessible to fleet managers for other transportation companies. The system administrator 294 has read and update access to all of the information entered by the various dealers 288. Additionally, the user who creates a new item may have default update access for this item and all levels below that item. If a user receives update rights for a specific item in the inspection flow, this update access will only be valid for that item and lower levels, and may not flow to higher levels within the information system.

As an example, while a dealer 228 may be able to update or change information for a fleet that exists, that same dealer may not change or gain access to other associated fleets with a national account status. Likewise, while a dealer may be able to delete a fleet that exists, that same dealer is not permitted to delete associated fleets that have a national account status or are required to be accessible to other dealers. In this way, an individual dealer may not affect information that may have been entered by other dealers and that may need to be accessible on a regional/national/global scale. This flow-down of access rights may be better understood with reference to FIG. 11. As illustrated, the access rights 296 flow down from the system administrator 298, to the fleet 300, to the individual location 302, to the individual survey 304, and finally, to the individual report 306. No one with creation or modification rights granted at a certain level may delete or modify any information originating from a level higher to or above their source of rights. However, ones skilled in the art will recognize alternative embodiments whose access and creation/modification rights may be shared or other preferences may be provided.

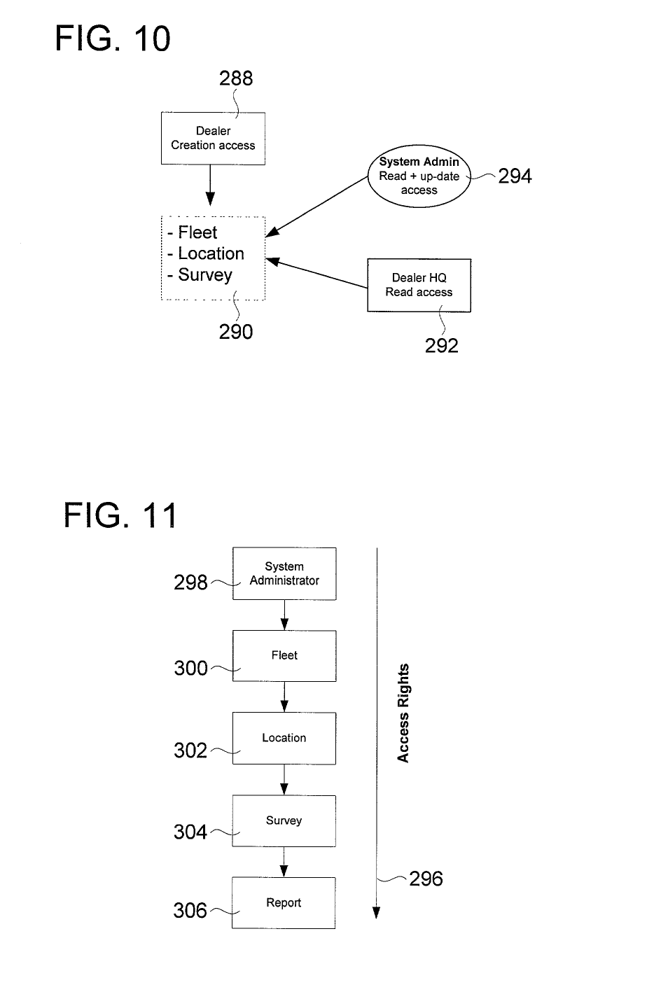

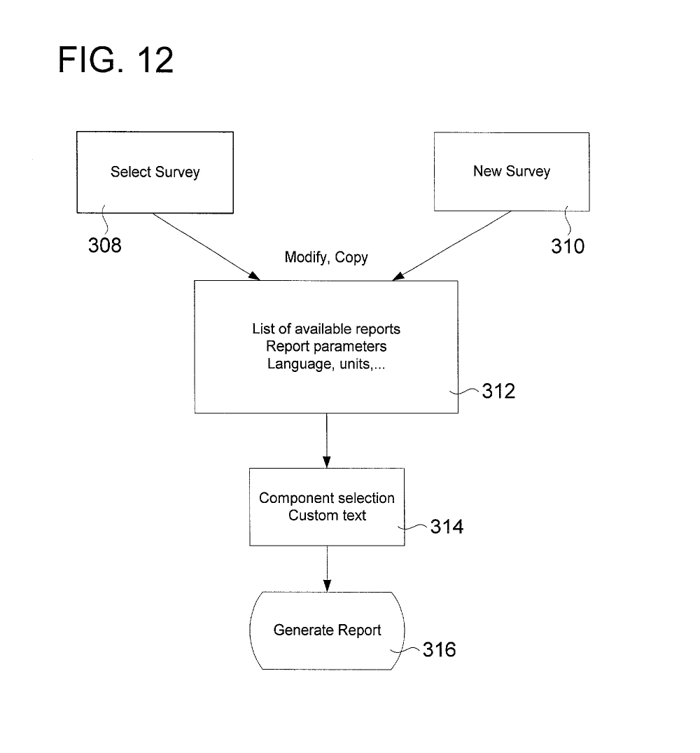

Once the proper access has been determined, a user may either select an established survey 308 or may choose to enter data into a new survey 310 as illustrated in FIG. 12. Once this selected survey 308 or new survey data 310 is entered into an embodiment of the GFAT system, a list of available reports, report parameters, language, units, etc. 312 may be made available for user selection. After the desired components have been selected 314, the GFAT system of the present invention proceeds to utilize the information from the selected or new survey in association with the selected components and text elements to generate a report 316 for downloading, printing, or simply viewing on the browser application.

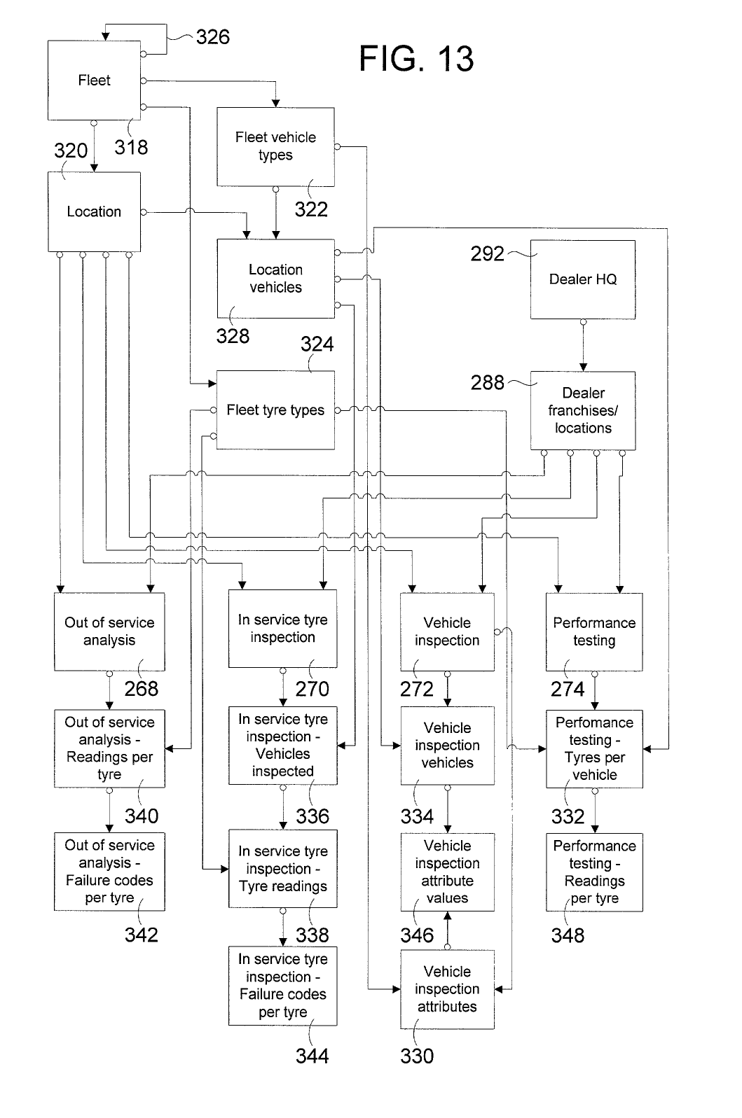

The logical relationship of the entities that comprise a portion of an embodiment of the GFAT system are illustrated in FIG. 13. Recalling the introductory discussion of the out-of-service analysis 268, the in-service tire inspection 270, the vehicle inspection 272, and the performance testing 274 of FIG. 9, the information utilized by these inspections/analysis entities may now be visualized. In particular, fleet information 318 is logically related to the fleet locations 320, the fleet vehicle types 322, the fleet tire types 324, as well as to generalized fleet information illustrated by circular logical link 326. The location information 320 provides a logical relationship to the location vehicles 328, as does the fleet vehicle type entity 322. The location information entity 320 also provides a logical relationship to the out-of-service analysis entity 268, the in-service tire inspection entity 270, the vehicle inspection entity 272, and finally, to the performance testing entity 274. In addition to providing a logical relationship to the location vehicle entity 328, the fleet vehicle type entity 322 also provides a logical relationship to the vehicle inspection attributes entity 330. The location vehicles information entity 328 provides a logical relationship to the performance testing-tires per vehicle entity 332, to the vehicle inspection vehicles entity 334, and to the in-service tire inspection vehicles inspected entity 336. The fleet tire type information entity 324 provides a logical relationship to the performance testing-tires per vehicle information entity 332, to the in-service tire inspection-tire readings entity 338, and to the out-of-service analysis-readings per tire entity 340.

As indicated previously, the dealer headquarters 292 provides a logical relationship to the dealer franchises/locations 288. From these locations 288 a logical relationship as previously discussed exists to each of the out-of-service analysis entity 268, the in-service tire inspection entity 270, the vehicle inspection entity 272, and the performance testing entity 274. With respect to the out-of-service analysis entity 268, a logical relationship is provided to the out-of-service analysis-readings per tire entity 340, and from that entity 340 to the out-of-service analysis-failure codes per tire entity 342. From the in-service tire inspection entity 270 a logical relationship is provided to the in-service tire inspection-vehicles inspected entity 336, and from there 336 to the in-service tire inspection-tire readings entity 338. Finally, this entity 338 provides a logical relationship to the in-service tire inspection-failure codes per tire entity 344. The vehicle inspection entity 272 provides a logical relationship to the vehicle inspection vehicles entity 334, and from there to the vehicle inspection attribute values 346. This entity 396 also has a logical relationship provided to it by the vehicle inspection attributes entity 330 previously discussed. Finally, the performance testing entity 274 provides a logical relationship to the performance testing-tires per vehicle entity 332, and from there to the performance testing-readings per tire entity 348.

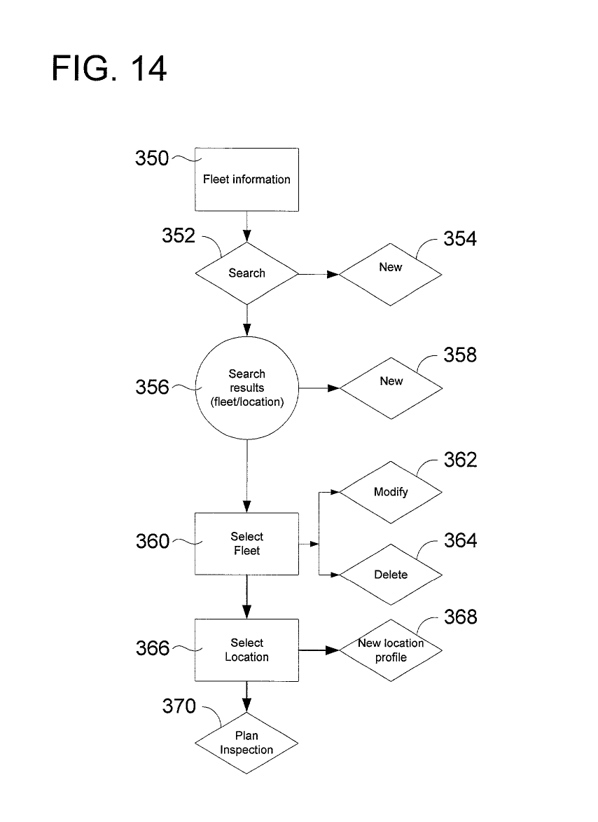

A further understanding of the maintenance of fleet information in the context of planned and executed inspections, analysis, etc. may be had with reference to FIG. 14. As illustrated in this flow diagram, a user desiring to manage fleet information 350 may search the production database to determine if information on the desired fleet exists at step 352. If the desired fleet does not currently exist in the production database, the user may then enter the new information for the fleet at step 354. Further, if results are provided to the user from the search step 352, the user may search these results 356 to determine if the fleet/location desired exists. If, after a search of the results reveals that the particular fleet information desired does not exist, the user may again create a new fleet at step 358. However, if the search of the results at step 356 yields the desired fleet, the user may select that fleet 360 from the returned results. Once selected, the user with appropriate access may choose to modify 362 or delete 364 the selected fleet. Alternatively, the user may choose to select a particular location for the selected fleet at step 366 if multiple locations are available. If, for the selected fleet, the user wishes to enter a new location profile, such may be done at step 368. Once the user has selected the desired fleet and location, the user may then plan an inspection of that fleet location as indicated by step 370.

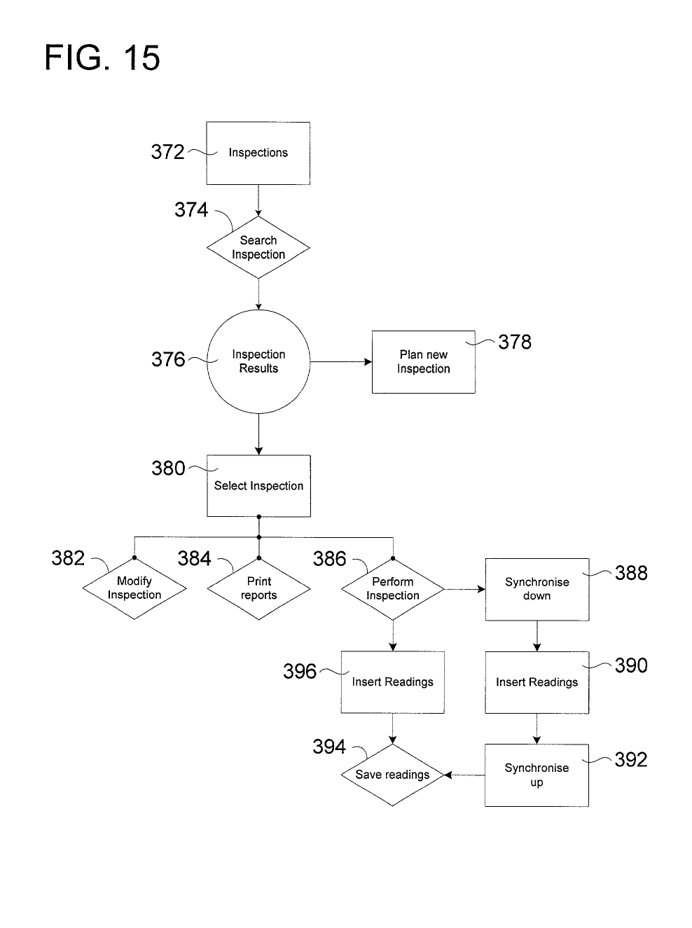

As illustrated in FIG. 15, once a user decides to plan an inspection 372, the user first searches the inspections that have already been conducted at step 374. Once the results from this search are displayed 376, the user can determine whether it is necessary to plan a new inspection 378, or whether one of the inspections previously conducted may be selected 380. If an inspection has previously been conducted that meets the user's requirements, the user may choose to modify that inspection 382 with appropriate access, print reports relating to that inspection 384, or perform the selected inspection 386.

The performance of the inspection 386 may be accomplished in various different ways through the system of the present invention. One method for performing the inspection is to utilize the handheld device discussed previously at the fleet location. When this method is to be used, information pertaining to the inspection is synchronized down to the handheld device 388 to properly fill the local database contained thereon with appropriate information concerning the desired inspection to be performed. The user then inserts readings 390 into the handheld device while conducting the inspection at the fleet location to fill the local database with the required information for the particular inspection selected. This information in the local database is then synchronized 392 up to the production database where the readings are saved 394. Alternatively, the inspection may be performed offline using preprinted forms taken to the fleet location and later inserted 396 at the dealer location to be saved in the production database 394. As a further alternative, the dealer may utilize a laptop or other wireless web enabled device at the fleet location or conduct inspections at the dealer location and directly insert the readings 396 of the inspection through the browser application to be saved at the production database 394. Persons skilled in the art will recognize that any suitable interface may be used to collect and enter the data.

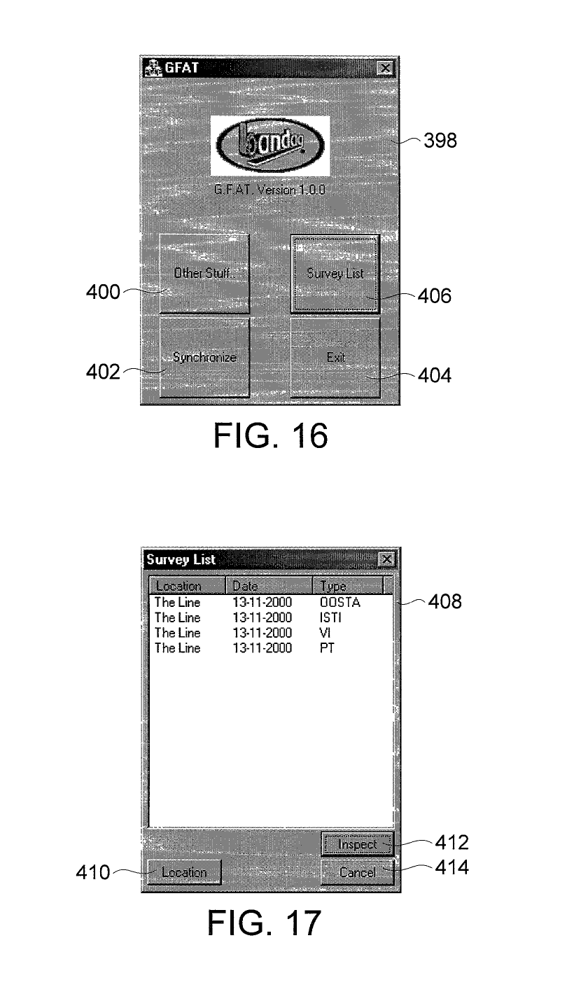

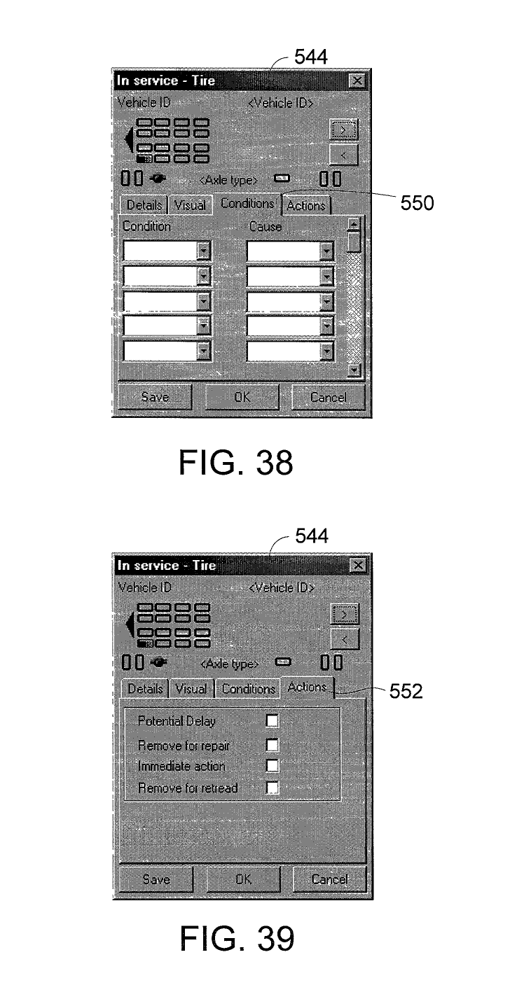

As discussed previously, there is no requirement for the dealer location to maintain a separate local database or application program on that dealer's computer system other than a browser application capable of connecting through the Internet to the GFAT server. However, the utilization of the handheld device usually includes an application program and local database while conducting the on-site inspection. Alternatively, the input device or handheld could link directly with the GFAT server or through the Internet. An exemplary embodiment of such an application program to be run on a handheld device to enable the dealer to perform on-site fleet location inspections without using preprinted forms will be discussed with regard to the application program user interface screens illustrated in FIGS. 16-50. Upon launching the GFAT application on the handheld device, the user is presented with an opening screen 398. This opening screen 398 provides information about the version of the GFAT handheld application, and provides user selectable links, illustrated in this exemplary embodiment as buttons. In one embodiment these links include button 400 to link the user to miscellaneous information, button 402 to initiate the synchronization to the production database, button 404 to allow the user to exit the program, and button 406 to link the user to the list of surveys available.

Once the user selects the survey list button 406 from the welcome screen 398, the list of available surveys is displayed in a window 408, such as that illustrated in FIG. 17. This window 408 displays the location, date, and type of survey available. The exemplary surveys listed include the out-of-service tire analysis (OOSTA), the in-service tire inspection (ISTI), the vehicle inspection (VI), and the performance testing (PT) as previously discussed. From this screen 408, the user is also provided selection buttons for location 410, inspection 412, and a cancel button 414 to take the user back to the previous screen 398. In an alternative embodiment, new locations may be added with the input device.

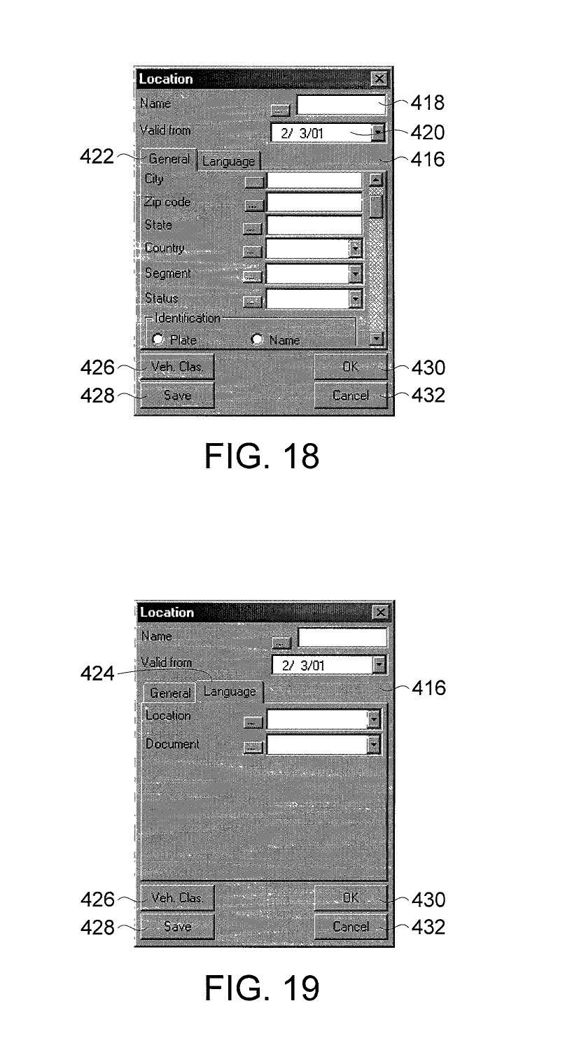

If the user selects the location button 410 from screen 408 to enter new location information, a new screen 416 such as that illustrated in FIG. 18 is displayed. On this location screen 416 the user may enter the name of the location in field 418 and the date of creation in field 420. Under the general information tab 422, the user may enter the requisite information for the location in the fields provided. Under the language information tab 424 illustrated in FIG. 19, the user may select the location and document information to ensure proper formatting for this location.

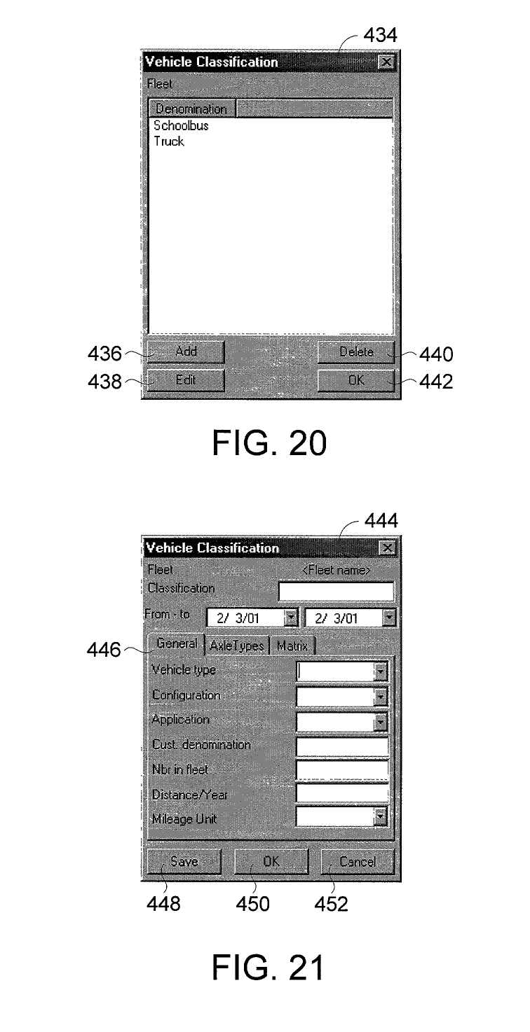

From the new location screen 416, the user is also provided with selection buttons for links to the vehicle classification 426. The user is also provided with a button to allow the user to save the entered information 428, to accept the information as displayed via OK button 430, or to cancel and return to the previous screen via button 432. If the user selects the vehicle classification button 426 from screen 416, a vehicle classification screen 434 is displayed to the user as illustrated in FIG. 20. This screen 434 allows the user to select the proper denomination of the fleet vehicle classification. The user is also provided with the option to add a fleet denomination via button 436, to edit a selected denomination via edit button 438, to delete a denomination via delete button 440, or to accept a selection via OK button 442.

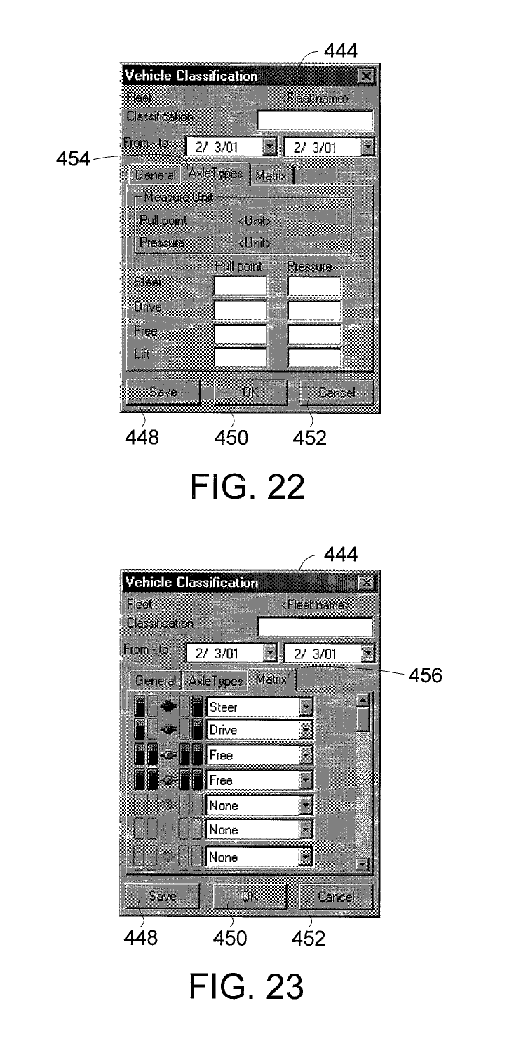

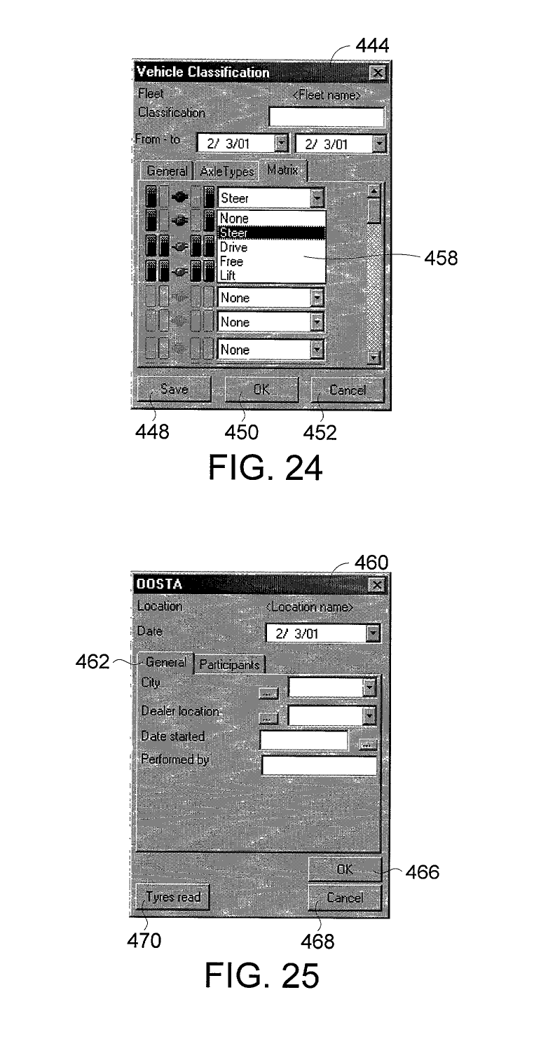

If a user chooses to add a new fleet vehicle denomination by selecting the add button 436, a vehicle classification add screen 444 such as that illustrated in FIG. 21 is displayed. On this screen the fleet name is displayed for the selected fleet, and a field is provided for the user to enter a new classification. For each fleet vehicle classification, general information under the general tab 446 can be entered by the user by selecting the appropriate vehicle type, configuration, and application from pull-down menus provided therein. Additionally, the user may directly enter a new vehicle type, configuration or application as required. Additional information may also be entered including customer denomination, the number in the fleet, the distance per year expected to be traveled, and the mileage unit to be used in the calculations. This window 444 also provides a save button 448, an OK button 450, and a cancel button 452. Under the “axle types” tab 454 of the vehicle classification window 444 additional information relating specifically to the axle types may be entered as illustrated in FIG. 22. FIG. 23 illustrates the information entered under the matrix tab 456 on this window 444. As may be seen from this FIG. 23, this application program provides a graphical interface that allows the user to simply conFIG. the matrix of the particular vehicle both for number and configuration of tires and for the axle type. While not visible from the illustration of FIG. 23, the different axle types (steer, drive, free, lift illustrated in the pull-down menu 458 of FIG. 24) are illustrated to the user in different colors to signify visually the type of axle for each set of wheels.

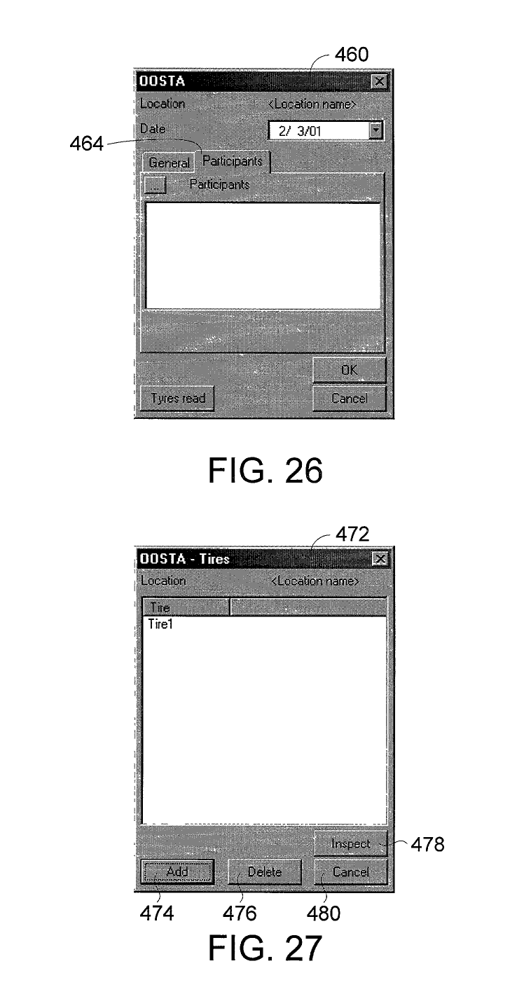

Once all of the new information has been entered and saved, the user is returned to the survey list screen 408 illustrated in FIG. 17. From this screen 408, the user selects one of the displayed survey lists for the location and type desired by highlighting the desired entry. The user may then select the inspect button 412 for the particular selected survey. If the user selects the out-of-service tire analysis (OOSTA) entry on screen 408, the OOSTA screen 460 illustrated in FIG. 25 will be displayed upon selection of the inspect button 412. On this screen 460 the location name is displayed and the user is prompted to enter the date of the OOSTA. Information to be provided under the general tab 462 includes the city, dealer location, date started, and the name of the individual that performed the OOSTA. Additional information may be provided under the participants tab 464 as illustrated in FIG. 26. This OOSTA screen 460 also includes an OK button 466, a cancel button 468, and a tires read button 470. If the user selects the tires read button 470, the OOSTA-tires screen 472 is displayed. This screen provides information regarding all of the tires read in the survey. This window 472 also allows a user to add a tire via button 474, delete a tire entry via button 476, conduct an inspection of a selected tire via button 478, or cancel via button 480.

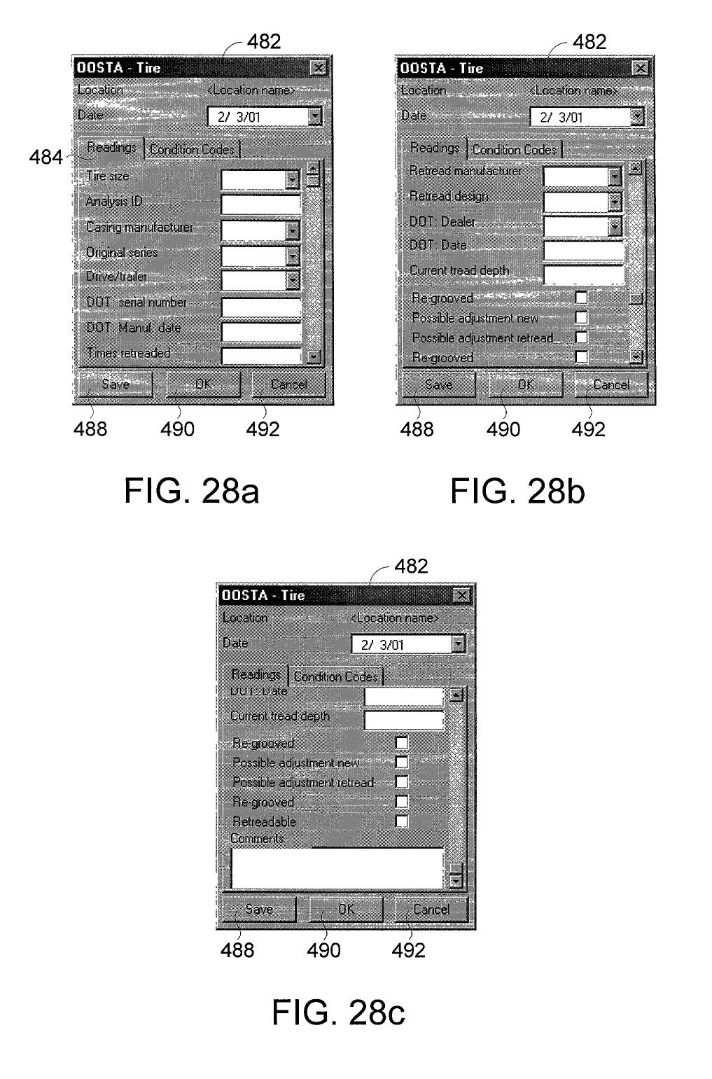

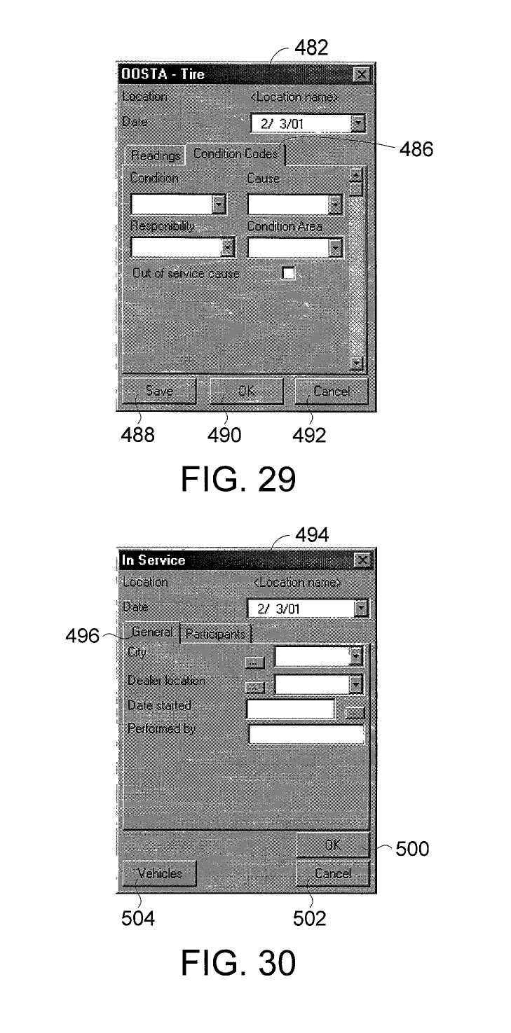

If the user wishes to conduct an inspection of any of the listed tires, the user simply selects the appropriate tire entry and the inspect button 478. These actions result in the OOSTA-tire screen 482 of FIG. 28a to be displayed. This screen 482 displays the location name and date of the tire inspection. The user enters the inspection data under the readings tab 484 as illustrated. Several of the fields may include pull-down selection menus to further aid the user in completing the inspection process. While any desired information may be included under the readings tab, FIGS. 28a, 28bB and 28c indicate a preferred listing of inspection data to be taken during the tire inspection. As may be seen in FIG. 28c, an additional region to allow the inspector to enter any desired comments is also provided. This screen 482 also includes information that may be entered by the individual conducting the inspection under the condition codes tab 486 as illustrated in FIG. 29. As illustrated, window 482 also includes a save button 488, an OK button 490, and a cancel button 492. Once all of the OOSTA information has been recorded, the user is returned to the survey list screen 408 illustrated in FIG. 17.

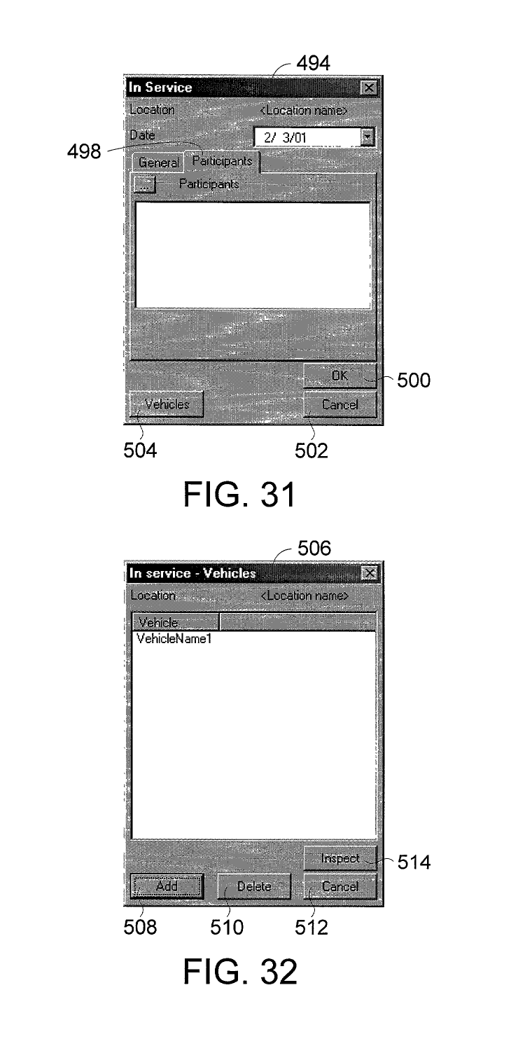

If the user selects the ISTI listing and then taps the inspect button 412, the in-service window 494 illustrated in FIG. 30 is displayed. This in-service window 494, includes an indication of the location name and the date. Information provided under the general tab 496 includes the city, dealer location, date started, and a field to enter the name of the inspector. This window 494 also includes an area to enter additional information regarding participants under the participants tab 498 as displayed in FIG. 31. The in-service window 494 also includes an OK button 500, a cancel 502, and a vehicles button 504.

If the vehicles button 504 is selected by the user, the in-service vehicles screen 506 illustrated in FIG. 32 is displayed. This window 506 provides a listing of all the in-service vehicles for that location name. This window also includes an add button 508, a delete button 510, a cancel button 512, and an inspect button 514. If a user wishes to inspect any particular vehicle in the vehicle list, the user simply selects the entry for the vehicle and taps the inspect button 514.

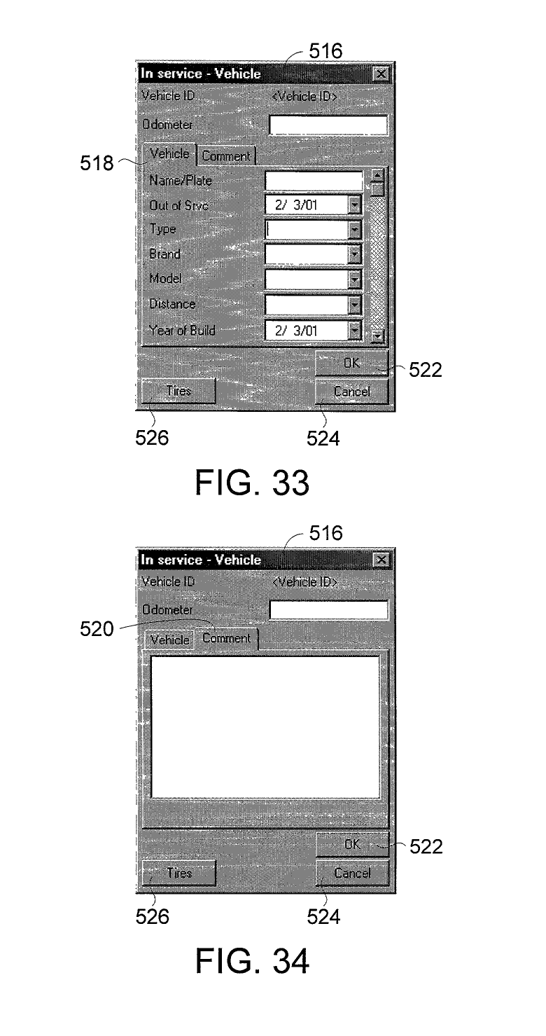

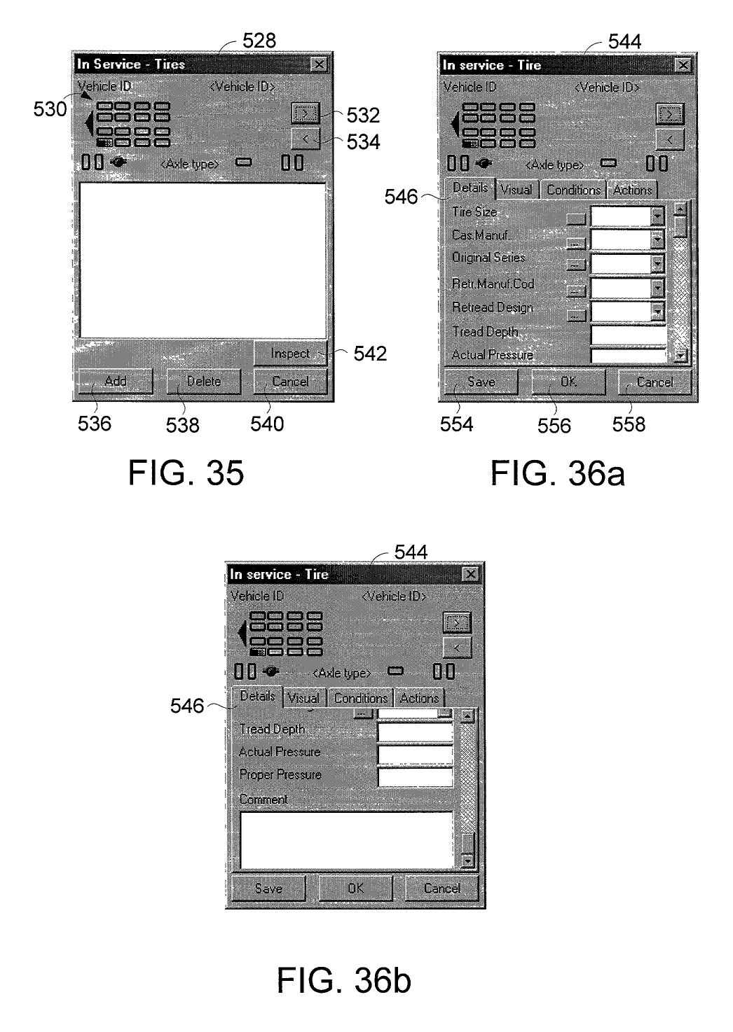

When the user has selected a vehicle and tapped the inspect button 514, the in-service vehicle inspection window 516 illustrated in FIG. 33 is displayed. This window 516 displays the vehicle identification and provides a field for the inspector to enter the odometer reading at the time of inspection. Additional information is provided under the vehicle tab 518 for the particular vehicle. Additional inspector's comments may be included under the cominents tab 520 as illustrated in FIG. 34. This window 516 also includes an OK button 522, a cancel button 524, and a tires button 526. Upon selection of the tires button 526, the in-service-tires window 528 illustrated in FIG. 35 is displayed. From this window 528 the user may graphically select the tire configuration for the particular vehicle through the graphical display illustrated at 530. The selection of any individual tire in the tire matrix for the vehicle may be selected through the use of scroll buttons 532, 534. This window 528 also includes an add button 536, a delete button 538, a cancel 540, and an inspect button 542.

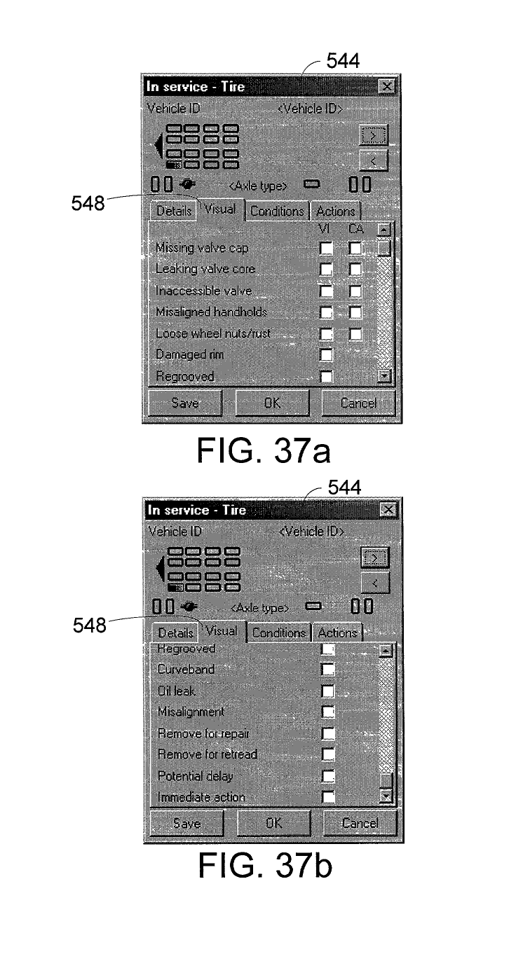

Once a particular tire has been selected from the graphical display, the user may tap the inspect button 542 to commence inspection of that tire. Once the inspection has been commenced, the in-service tire inspection screen 544 illustrated in FIG. 36a is displayed. The details of the inspection may be entered in the various fields provided under the details tab 546 on this window 544. While various items of information may be included, a preferred embodiment of the present invention utilizes the fields illustrated under the details tab 546 in FIGS. 36a and 36b, including providing a section for inspector comments. This window 544 also includes a visual tab 548 under which additional information accumulated during the inspection may be entered. While various types of information may be included, a preferred embodiment of the present invention includes the items listed under the visual tab 548 illustrated in FIGS. 37a and 37b. This window 544 also includes a conditions tab 550 under which the inspector may note various conditions and causes observed during the tire inspection. Further, the inspector may note suggested actions under the actions tab 552 to aid the fleet manager in the determination of any required maintenance and its potential impact on his fleet. This window 544 also includes a save button 554, an OK button 556, and a cancel button 558. Once the required information has been saved, the user is again returned to the survey list window 408 illustrated in FIG. 17.

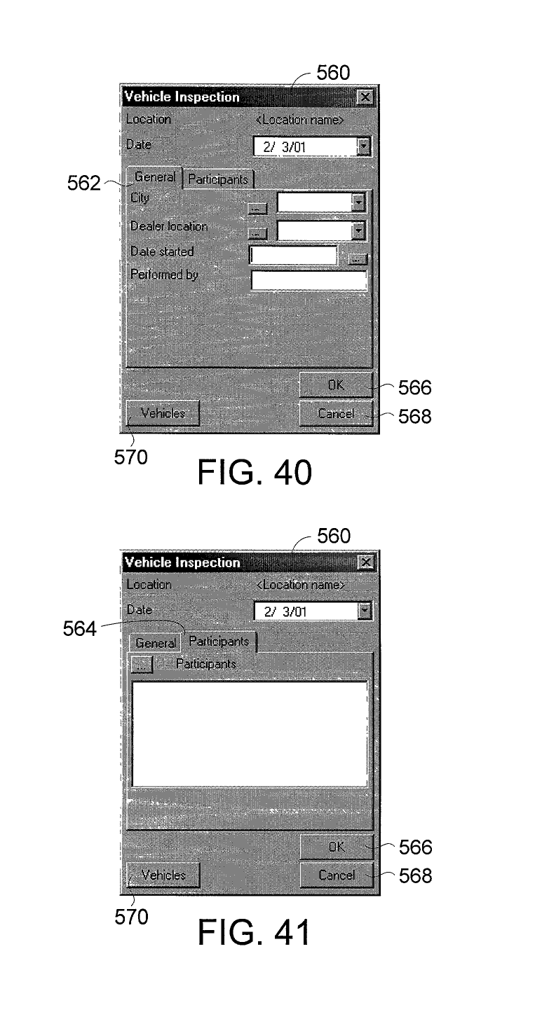

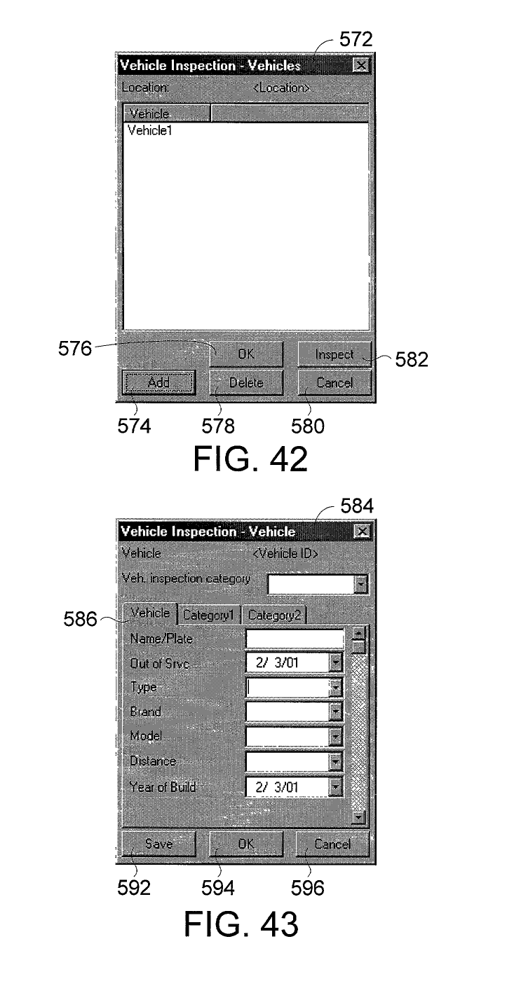

The vehicle inspection window 560 illustrated in FIG. 40 indicates to the user the location name and allows the user to enter the date of the vehicle inspection. The information that may be entered under the general tab 562 includes the city, dealer location, date started, and the name of the individual that performed the vehicle inspection. As illustrated in FIG. 41, additional information regarding the participants of the vehicle inspection may also be entered under the participants tab 564 of this window 560. The vehicle inspection window 560 also includes an OK button 566, a cancel button 568, and a vehicles button 570. Selection of the vehicles button 570 results in the vehicle inspection-vehicles screen 572 as illustrated in FIG. 42 to be displayed. This window 572 includes a listing of all vehicles for the fleet at the given location. This window 572 also provides an add button 574, an OK button 576, a delete button 578, a cancel button 580, and an inspect button 582.

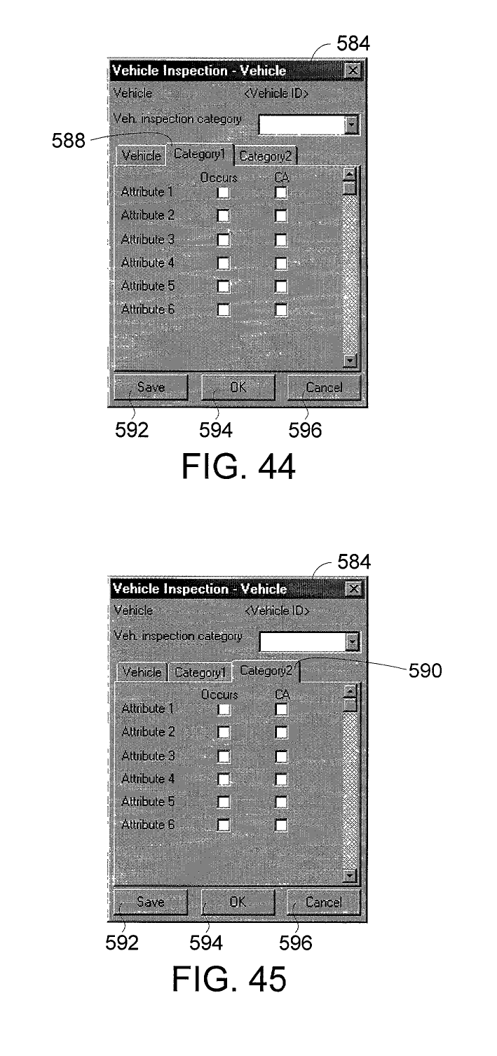

If a user wishes to conduct a vehicle inspection for a particular vehicle, the vehicle entry on window 572 is selected, followed by the selection of the inspect button 582. At this point, the vehicle inspection-vehicle screen 584 illustrated in FIG. 43 is displayed. This window 584 displays the vehicle identification and allows the user to select a vehicle inspection category from a pull-down menu. The information for the particular vehicle may be entered under the vehicle tab 586. Additionally, information collected during the vehicle inspection may be entered under the category 1 tab 588 and the category 2 tab 590 illustrated in FIGS. 44 and 45, respectively. While these two FIGs. illustrate generic attributes to be included, particular attributes for the selected vehicle type may be entered based upon the requirements of the particular fleet manager. The vehicle inspection-vehicle window 584 also includes a save button 592, an OK button 594, and a cancel button 596. Once the vehicle inspection has been completed and all of the relevant data saved, the user is returned to the survey list screen 408 illustrated in FIG. 17.

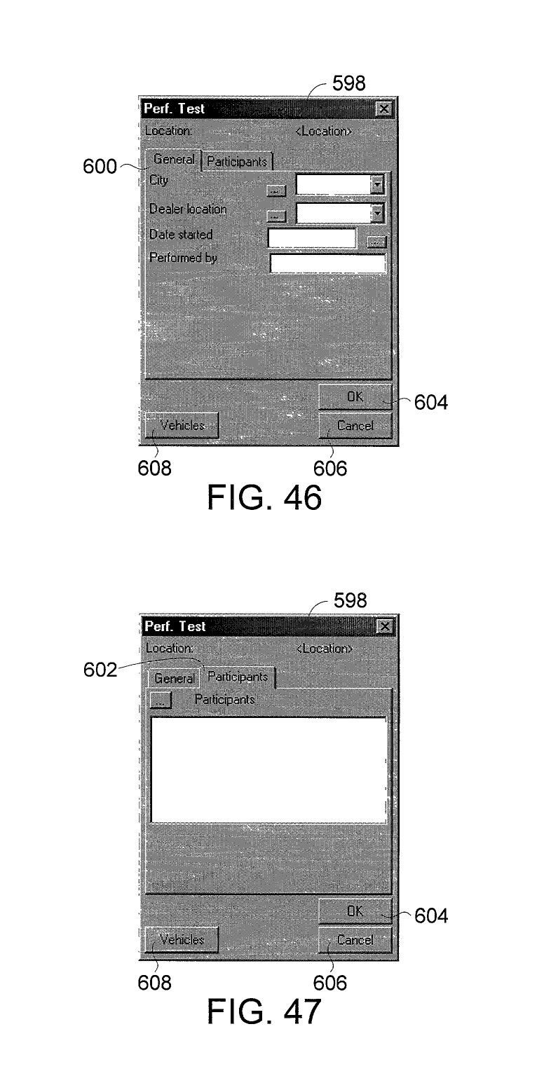

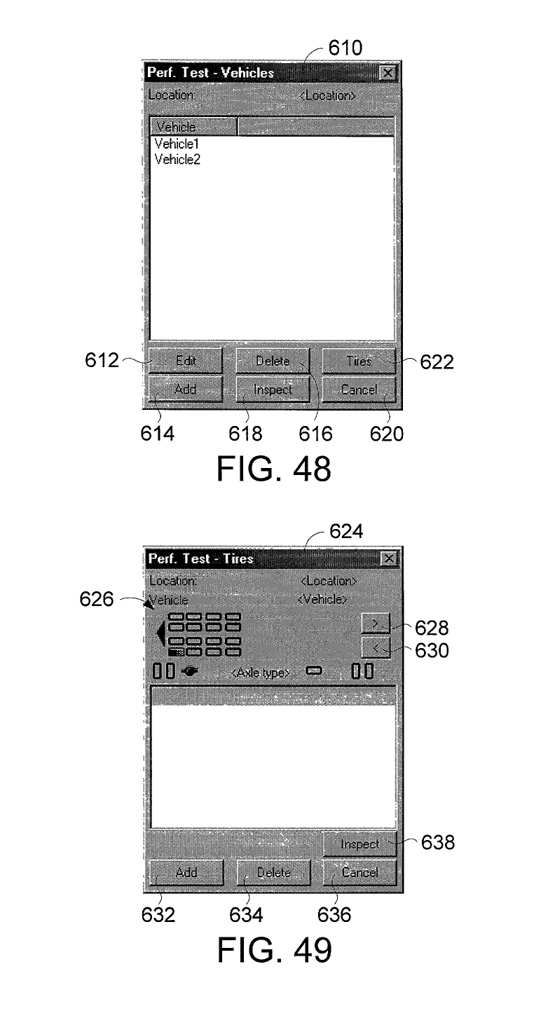

From the survey list screen 408, the user may choose to perform the performance test inspection by highlighting the PT entry and selecting the inspect button 412. This results in screen 598 illustrated in FIG. 46 to be displayed. This performance test screen 598 allows the user to input general information under the general tab 600 relating to the performance test inspection. Additional information regarding the participants may also be entered under the participants tab 602 illustrated in FIG. 47. This window 598 also includes an OK button 604, a cancel button 606, and a vehicles button 608. Upon selection of this vehicles button 608, the performance test-vehicles screen 610 illustrated in FIG. 48 is displayed. This screen 610 provides a listing of all vehicles available for performance testing at that particular location. This screen 610 also includes an edit button 612 and a vehicle add button 614, a delete button 616, an inspect button 618, a cancel button 620, and a tires button 622.

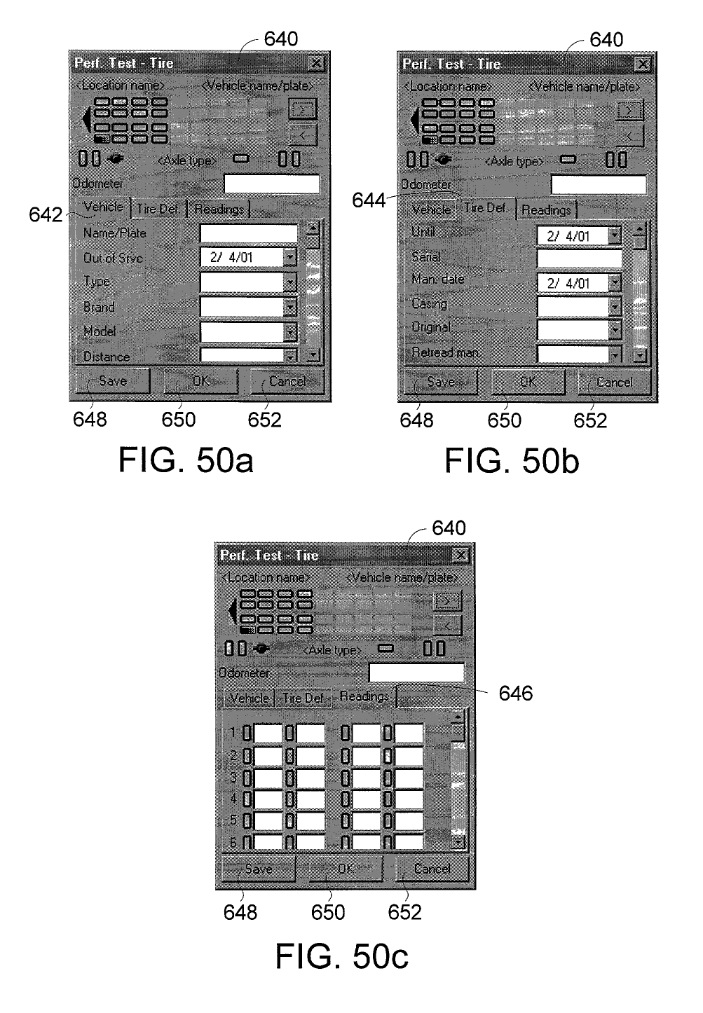

Upon selection of the tires button 622 on the performance test-vehicles screen 610, the performance test-tire screen 624 illustrated in FIG. 49 is displayed. As with screen 528 illustrated in FIG. 35, the performance test-tire screen 624 provides a graphical illustration 626 of the vehicles tire configuration for ease of selection by the inspector. Selection buttons 628, 630 may be used to select any particular tire in the vehicle tire configuration for inspection. This screen also includes an add button 632, a delete button 634, a cancel button 636, and an inspect button 638. Upon selection of the inspect button 638, the performance test-tire inspection screen 640 illustrated in FIG. 50a is displayed. This screen 640 displays both the location name and the vehicle nameplate to identify the vehicle and to allow the entry of the information pertinent thereto. Vehicle information is provided under the vehicle tab 642, while tire definition information is provided under the tire def. tab 644 illustrated in FIG. 50b, and individual reading information is provided under the reading tab 646 illustrated in FIG. 50c. This screen 640 also includes a save button 648, an OK button 650, and a cancel button 652.

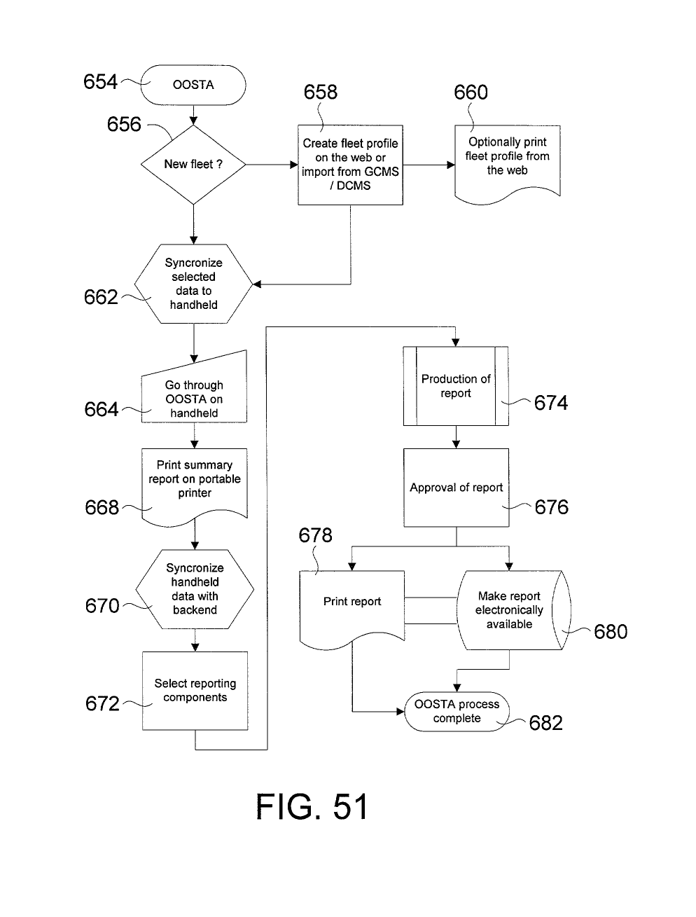

The flow diagram of FIG. 51 illustrates in greater detail the out-of-service tire analysis (OOSTA) method of an embodiment of the present invention performed with a handheld application such as discussed above. However, alternative data entry method may be utilized in accordance with the present invention such as computers, wireless devices, etc. Upon initiation of the OOSTA 654, an embodiment of the present invention determines whether or not the analysis will be performed on a new or an existing fleet at step 656. If a new fleet is to be inspected, a new fleet profile usually may be created on the web or the data imported from the GCMS/DCMS at step 658. Once this fleet profile has been created, a user may optionally print this profile from the web as indicated at step 660. Once the fleet profile has been created either as a result of the creation step 658 or previously for an existing fleet, the selected data is then synchronized or downloaded to the handheld device at step 662. The handheld device is then taken to the fleet location where the OOSTA is actually performed as indicated at step 664.

Once the OOSTA has been completed, a summary report may be printed on a portable printer, such as a thermal or ink-jet printer immediately at the fleet location as indicated by step 668. The data collected and stored in the local database on the handheld device is then synchronized with the back-end server of the GFAT system of the present invention at step 670. Once the data has been synchronized, the desired reporting components can be selected at step 672 to be used for the production of a report at step 674. Once the report has been produced, it is approved at step 676. Once approved, the report may be printed at step 678 and/or made electronically available at step 680 before completing the OOSTA process 682.

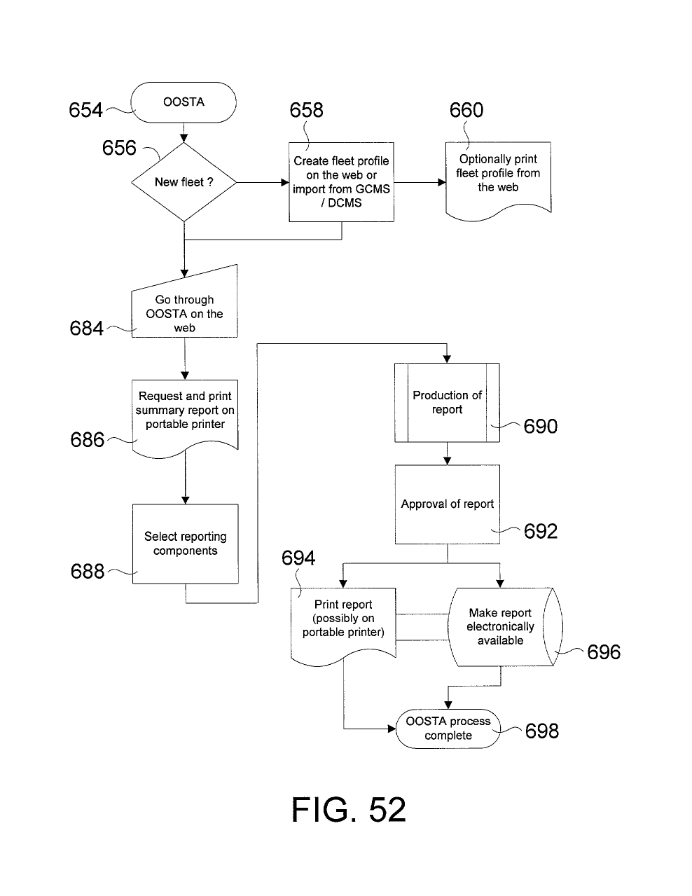

If the user were to desire to complete the OOSTA without the use of a handheld device, the process as illustrated in the flow diagram of FIG. 52 would be followed. As discussed briefly above, the completion of this OOSTA without the use of a handheld device is possible with a web-enabled device such as a wireless laptop, or other wireless web enabled device that may be used at the fleet location. Further, such a process may be followed if the OOSTA were to be conducted at the dealer location by entering the data directly on the dealer's PC connecting through the browser application. In any event, once the OOSTA is begun 654 the status of the fleet must be determined at step 656. If the fleet to be inspected is new, a fleet profile is created on the web or the data is imported from the GCMS/DCMS at step 658. The fleet's profile may be optionally printed from the web at step 660. Once the proper fleet profile information has been retrieved, the OOSTA is completed by entering the data directly through the browser application at step 684. Once the OOSTA has been completed, the user may request and print a summary report on a portable or networked printer at step 686 for immediate delivery to the fleet manager. The user may then select the reporting components desired at step 688, after which the reports may be produced at step 690. Once the report has been approved 692, it may be printed 694, and/or made electronically available 696 before the OOSTA process completes 698.

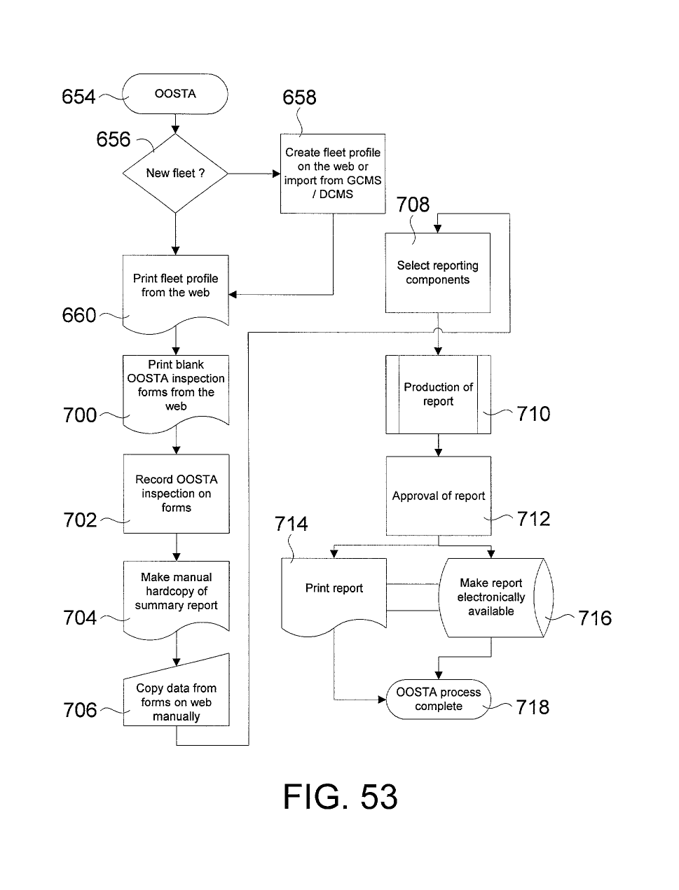

An embodiment of the present invention also provides the flexibility to dealers to conduct the OOSTA in a conventional fashion using preprinted inspection forms if they so desire or if the situation does not lend itself to the more automated completion of the process by using the handheld device or the web as discussed above. Such a method is illustrated in the flow diagram of FIG. 53. Upon selection of the OOSTA 654, the determination of the fleet information is conducted at step 656. If the fleet to be inspected is new, the fleet profile is created on the web or imported from GCMS/DCMS at step 658. Once the fleet profile information is in the system, either through step 658 or because the fleet is an existing fleet, the dealer prints the fleet profile from the web at step 660. The blank OOSTA inspection forms are also printed from the web at step 700. These forms are then taken to the inspection site where the user records the OOSTA inspection results on the preprinted inspection forms at step 702. The user then makes the manual hard copy of the summary report 704 to be provided to the fleet manager at the conclusion of the OOSTA. The data recorded on the preprinted OOSTA forms is then copied manually or scanned onto the web application at step 706. Once this data has been entered, the reporting components are selected 708 so that the reports may be produced at step 710. Once the reports have been approved 712, they may be printed 714 and/or made electronically available at step 716 before the process completes at step 718.

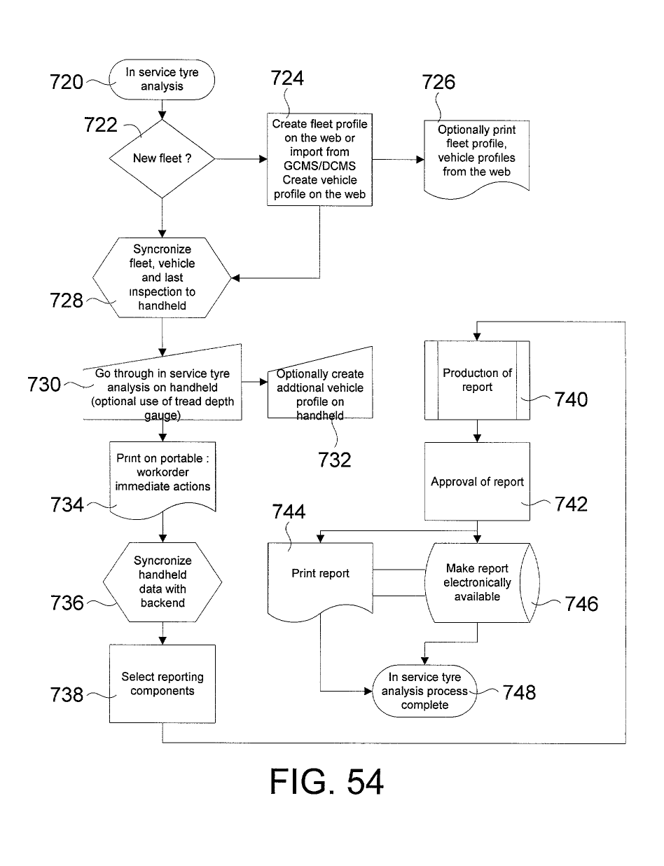

To complete the in-service tire analysis using the handheld device, the method of the present invention proceeds in accordance with the flow diagram of FIG. 54. Once the in-service tire analysis 720 is selected, the system determines the availability of the fleet information at step 722. If the fleet to be inspected is a new fleet, a fleet profile is created on the web or imported from the GCMS/DCMS at step 724. Additionally, the vehicle profiles for the fleet may also be created at this point. The fleet profile and vehicle profiles may optionally be printed at step 726. Once the fleet and vehicle information is available, it is synchronized along with the last inspection conducted to the handheld device at step 728. Once the required information is synchronized to the handheld device, the user may conduct the in-service tire analysis at step 730. The user may also optionally create additional vehicle profile on the handheld device at step 732. In this way, the user may inspect all vehicles at that time, even if new vehicles have been added since the last inspection and their information was not downloaded. Once the in-service tire analysis has been completed, any work orders or immediate action reports may be printed on the portable printer for immediate delivery to the fleet manager at step 734. Upon returning to the office, the handheld device is synchronized with the back-end web server at step 736. The reporting components may then be selected at step 738 to produce the report at step 740. Once the report has been approved at step 742, it may be printed at step 744 and/or made electronically available at step 746 before the in-service tire analysis process is completed 748.

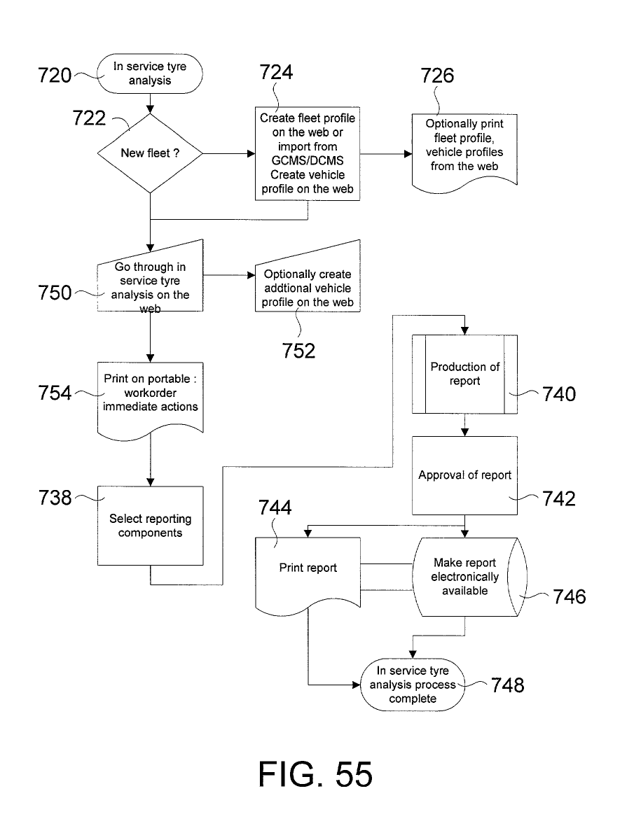

If the dealer chooses to conduct the in-service tire analysis directly on the web without utilizing the handheld device, the flow diagram illustrated in FIG. 55 may be utilized. Once steps 720-726 have been completed as discussed above, the user then performs the in-service tire analysis directly on the web at step 750. As with the ability provided on the handheld device, the user may optionally create additional vehicle profiles on the web at step 752. Once the in-service tire analysis has been completed, any work orders or immediate action reports may be printed at step 754 for immediate delivery to the fleet manager. Once this is complete, the selection of the reporting components and generation approval and delivery of the reports discussed above with regard to steps 738-748 may be completed.

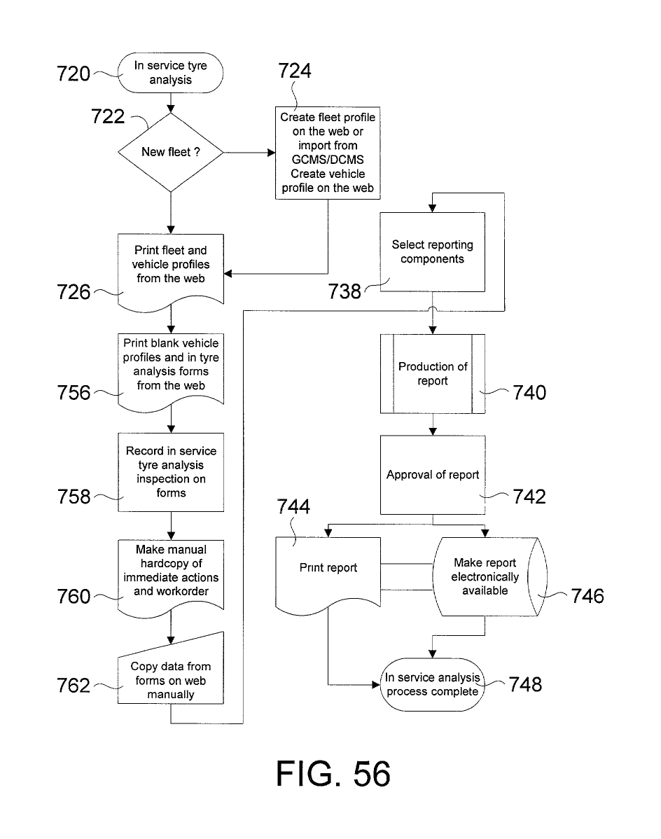

If the in-service tire analysis must be completed using preprinted hard copy forms, the flow diagram illustrated in FIG. 56 may be utilized. As with the other methods for conducting this in-service tire analysis, steps 720-726 are followed as before. However, once the fleet and vehicle profiles have been printed, the user must also print blank vehicle profiles and in-service tire analysis forms at step 756. During the performance of the in-service tire analysis, the user records the in-service tire analysis data on the preprinted forms at step 758. The user may then make manual hard copies of any immediate action reports and work orders required as a result of the analysis at step 760. Once the user returns to the dealer location, the data from the forms recorded during the in-service tire analysis are either manually copied to the web server at step 762, or may be scanned into the system. Once this data is available on the web, the selection, production, and approval of the report as well as the printing and the making of the report electronically available are completed as before in accordance with steps 738-748.

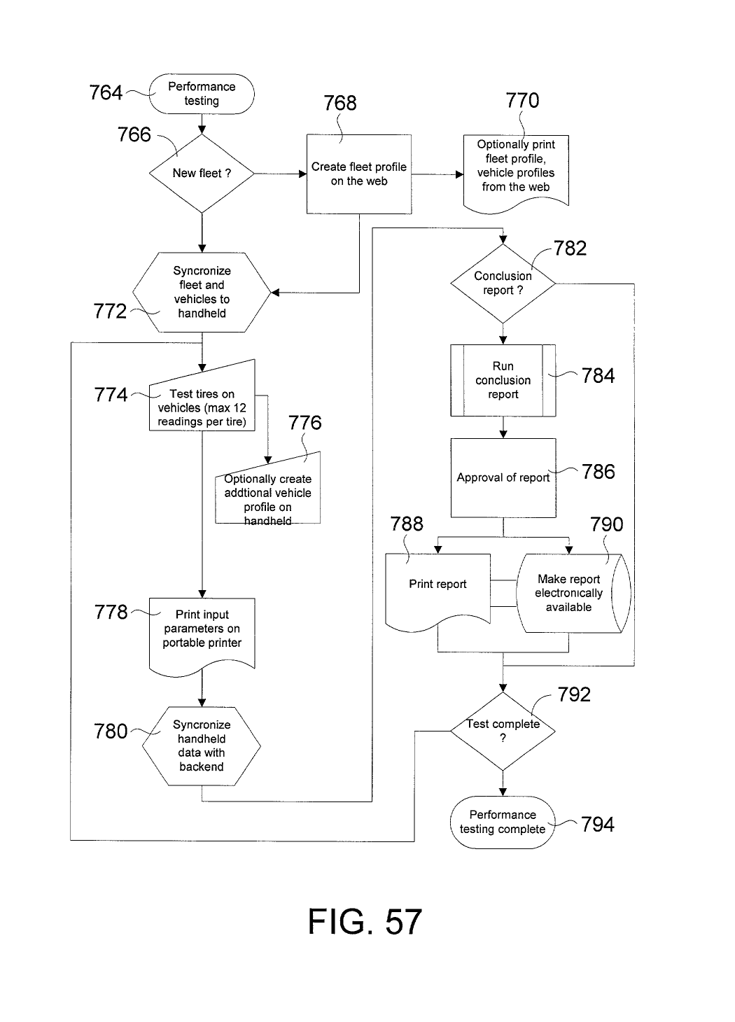

FIG. 57 illustrates the performance testing method provided by an embodiment of the present invention utilizing the handheld device discussed above. Once the performance testing has been selected at step 764, this embodiment checks to determine if the fleet information is available at step 766. If the performance testing is to be performed on a new fleet, the new fleet profile is created on the web at step 768. This fleet profile, as well as the vehicle profiles for that fleet may optionally be printed from the web at step 770. Once the fleet and vehicle profiles are available in the system, that data is synchronized to the handheld device at step 772. The performance testing is then conducted on the tires of the vehicle at step 774. As discussed above, the handheld device allows for the optional creation of additional vehicles for the fleet at the fleet location at step 776 if need be. Once the performance testing is completed, the input parameters may be printed on the portable printer at step 778 for immediate delivery to the fleet manager. The information from the handheld device is then synchronized with the back-end server application at step 780. The system then checks to determine if it is appropriate to run the conclusion report at step 782. If so, the conclusion report is run at step 784, is approved at step 786, and may be printed at step 788 and/or made electronically available at step 790. If it is not appropriate to run the conclusion report, or once the conclusion report has been run and made available, the system checks to determine if the performance testing is complete at step 792. If the testing is not complete, the user proceeds to again test tires on the vehicles at step 744, etc. If, however, the test is complete, the performance testing process concludes at step 794.

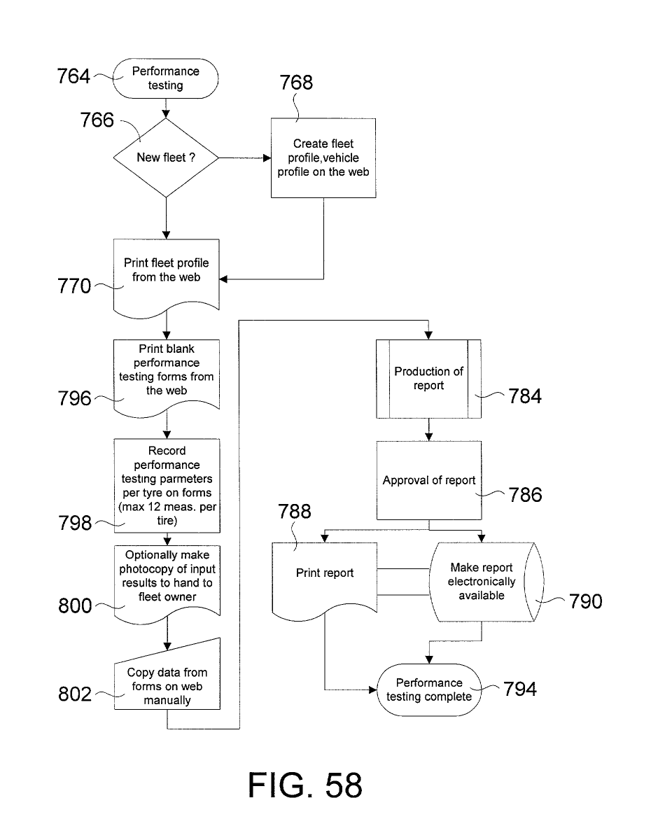

If the dealer chooses to run the performance testing with preprinted forms, the process proceeds in accordance with the flow diagram of FIG. 58. As with the performance testing method using the handheld device, the performance testing using preprinted form proceeds with the same initial steps 764-770. However, once the fleet profile has been printed at step 770, the user must print blank performance testing forms from the web at step 796. The performance testing parameters per tire are then recorded on the forms at step 798. If desired or required, the user may optionally make photocopies of the input results to provide to the fleet owner at step 800. Once the user is able to access the GFAT web server, the data from the performance testing forms is manually entered or scanned into the system. Once this information is available, the production and approval of the report, as well as the printing and/or making the report electronically available before completing the performance testing proceeds in accordance with steps 784-794 as discussed above.

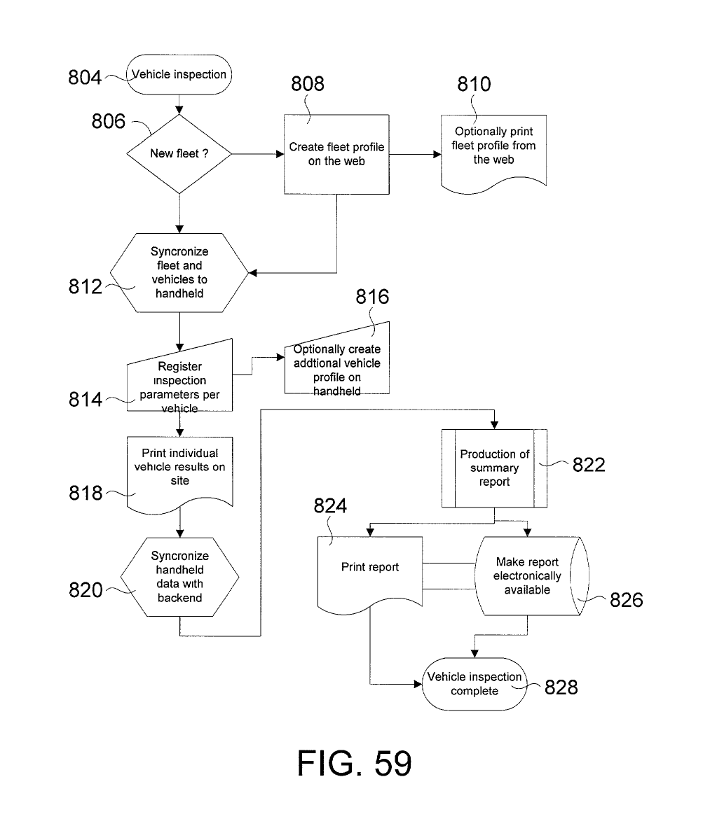

To perform the above-described vehicle inspection using the handheld device, an embodiment of the present invention utilizes the flow diagram illustrated in FIG. 59. Once the vehicle inspection has been selected 804, the embodiment checks to determine if it has fleet profile information available at step 806. If the fleet profile information is not available because the fleet is new, the user may create the fleet profile on the web at step 808. The user may also optionally print the fleet profile from the web at step 810. Once the fleet profile information is available, it is synchronized to the handheld device at step 812. The user then utilizes the handheld device to register the inspection parameters per vehicle at step 814. If new vehicles have been added to the fleet, the handheld device may be used to optionally create additional vehicle profiles at step 816 so that a complete inspection of the entire fleet may be conducted. Once the inspection is complete, individual vehicle results may be printed on site for immediate delivery to the fleet manager at step 818. The data collected in the handheld device is then synchronized with the GFAT back-end server at step 820. A summary report may then be produced at step 822 and printed at step 824 and/or made electronically available at step 826 before completing the vehicle inspection process at step 828.

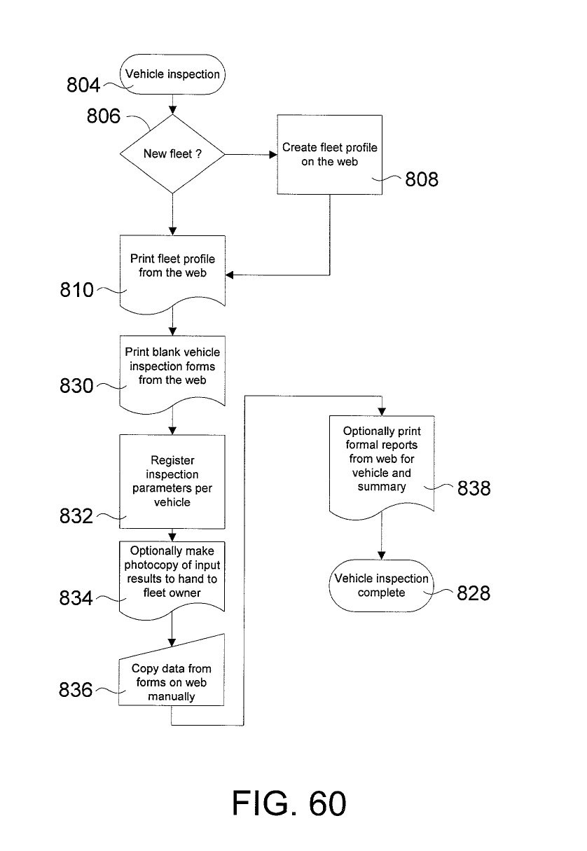

If the user chooses to conduct the vehicle inspection via preprinted forms, the system of the present invention as illustrated in the flow diagram of FIG. 60 proceeds steps 804, 806, 808, and 810 as described above. Thereafter, the blank vehicle inspection forms are printed from the web at step 830. The user then registers the inspection parameters per vehicle on the preprinted forms at step 832. A photocopy of the input results may optionally be made to deliver to the fleet owner at the time of the vehicle inspection at step 834. Once access to the web server is available, the data from the forms is manually entered or scanned at step 836. The user may then choose to optionally print formal reports from the web for vehicle and summary at step 838 before completing the inspection process at step 828.

As discussed, the web-based GFAT application portion of the system of the present invention may be accessed by a user through a browser application, such as e.g. Microsoft's Internet Explorer. As such, the individual dealers and users of the GFAT system may be considered to be thin clients, i.e. they do not need to run the GFAT application locally. In one embodiment of the invention, when the client accesses the GFAT application server through the web-browser he must enter a user name and password to gain access to the system. This log-in process also allows the system to provide the requested information in the proper language for the user.

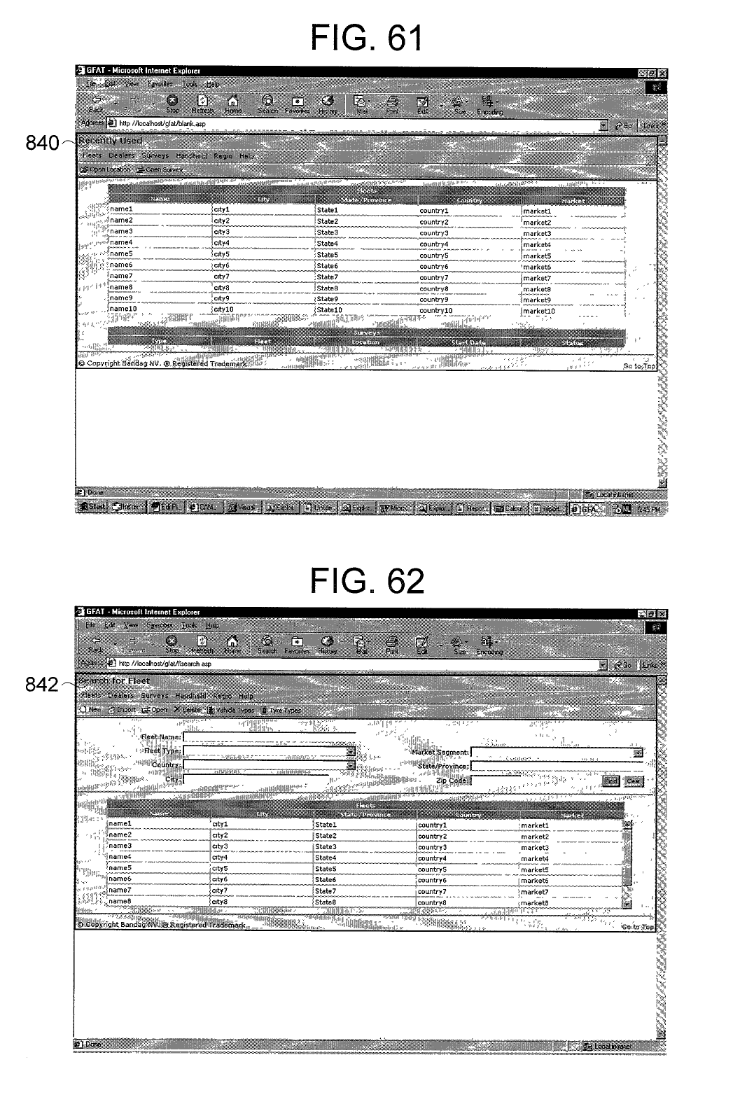

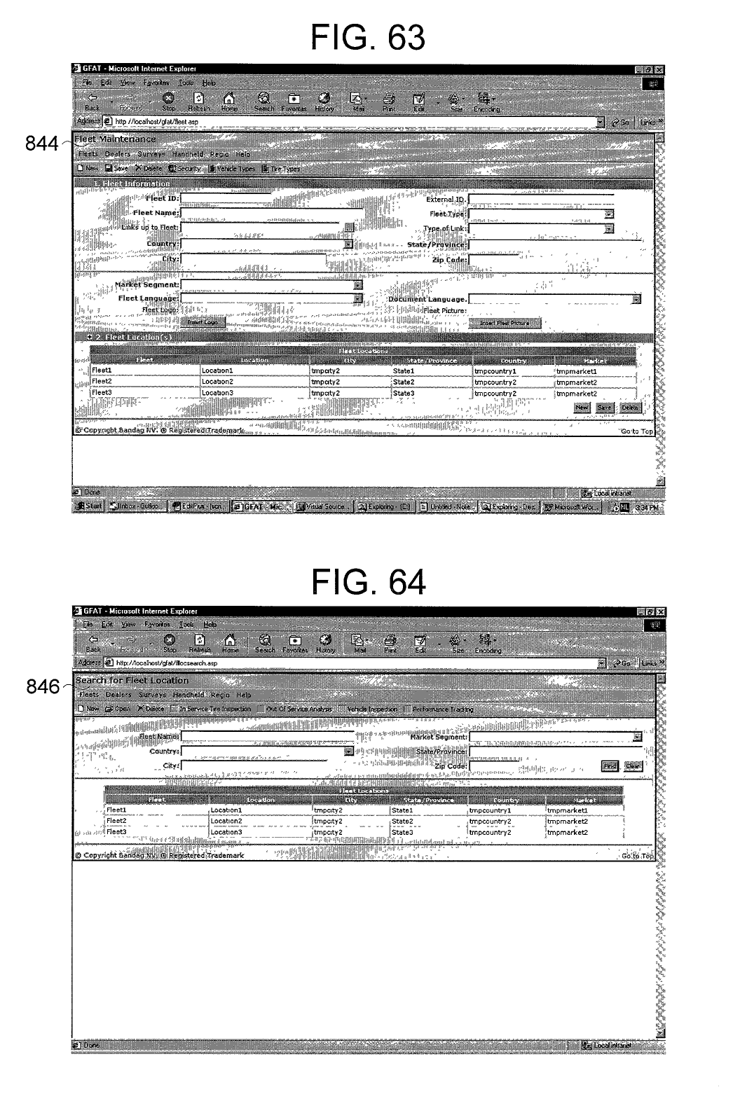

Once the log-in process is complete, the user is presented with a “Recently Used” page 840 such as that illustrated in FIG. 61. This page displays previously accessed fleets and surveys for user selection. If the information desired is not included in the recently used listings, the user may choose to search for a particular fleet by accessing the “Search for Fleet” page 842 illustrated in FIG. 62. From this page 842 the user may enter any known information about the fleet. Once the information is entered, the user may search the system's database to determine if any fleet profile matching the search criteria exists. If the desired fleet profile does not exist, the user may access the “Fleet Maintenance” page 844 to create such profile illustrated in FIG. 63. This page 844 allows the user to enter both general fleet information as well as information relating to each of the various fleet locations.

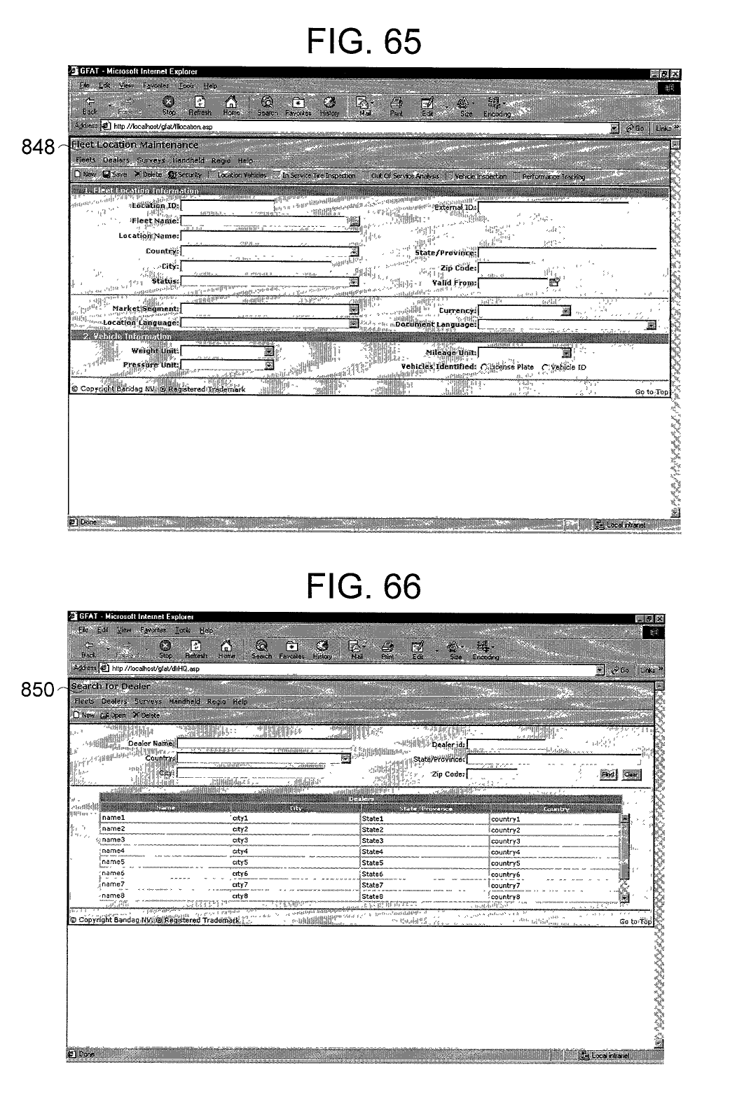

In addition to being able to search for a desired profile by fleet, the system of the present invention also allows a user to search based on a particular fleet location through the “Search for Fleet Location” page 846 illustrated in FIG. 64. As with the prior search page 842, this search page 846 allows a user to supply whatever information is known in an effort to locate a fleet location profile. If the fleet location does not exist in the system, the user may access the “Fleet Location Maintenance” page 848 illustrated in FIG. 65. In addition to the general fleet location information, the user may also enter vehicle information to complete the profile.

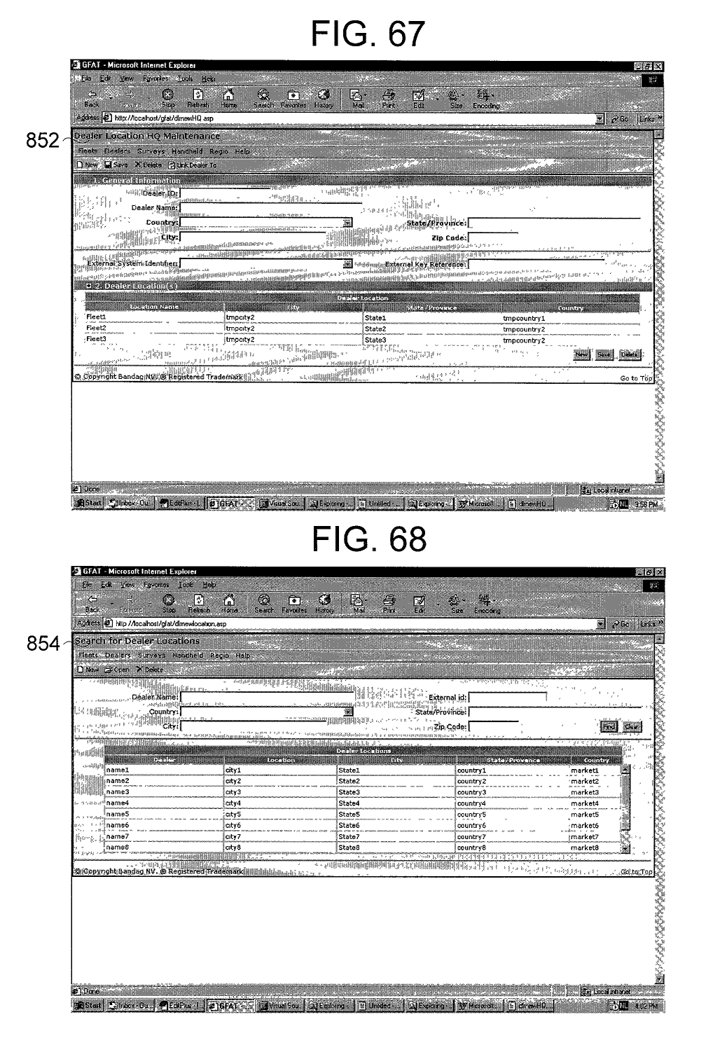

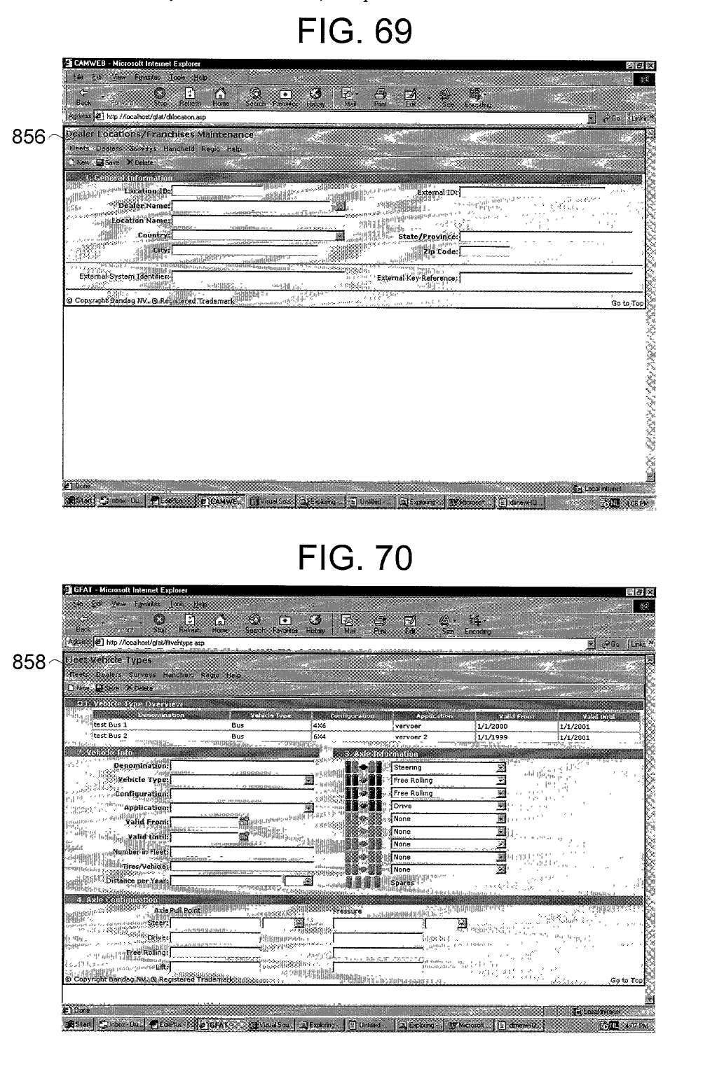

The user may also search the GFAT database by accessing the “Search for Dealer” page 850 illustrated in FIG. 66. The user may enter any known information about the desired dealer in an effort to locate information about that dealer. If a profile for that dealer does not exist in the system, the user may create a dealer profile from the “Dealer Location HQ Maintenance” page 852 illustrated in FIG. 67. Both general dealer information and specific dealer location information may be entered into the profile. Additionally, the user may search the database for the desired profile by dealer location via the “Search for Dealer Location” page 854 illustrated in FIG. 68. If the individual dealer location does not exist in the database, the user may create a dealer location profile by accessing the “Dealer Location/Franchise Maintenance” page 856 illustrated in FIG. 69.

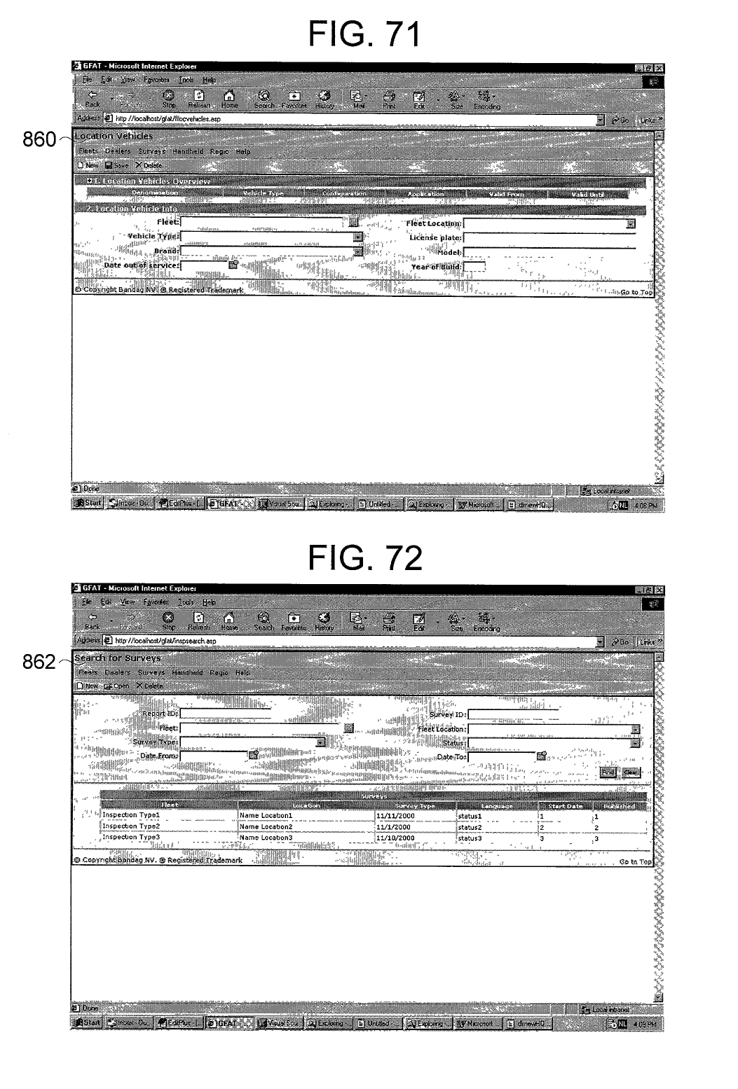

Once the various profiles for the dealers and fleets have been entered into the system, information on the various fleet vehicle types may be entered via the “Fleet Vehicle Types” page 858 as illustrated in FIG. 70. In addition to the textual data that may be entered to complete the vehicle type profile, graphical information of the vehicle tire and axle configuration is also entered. As discussed above, this graphical information aids in the completion of the various inspections discussed above. Vehicle information may also be entered via the “Location Vehicles” page 860 illustrated in FIG. 71.

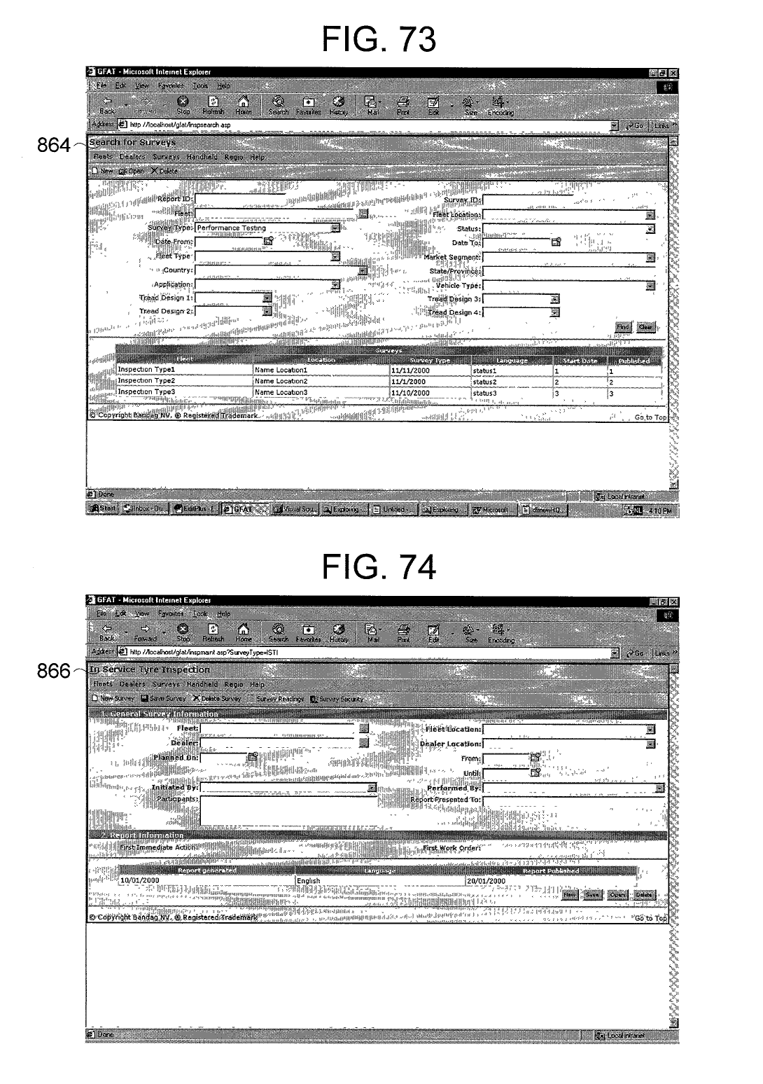

In addition to searching for fleet and dealer profiles contained in the system of the present invention, the user may also choose to search for individual surveys via the “Search for Surveys” page 862 illustrated in FIG. 72. As with the other search pages, the user may enter any information known in an attempt to find a particular survey. An alternate embodiment of a “Search for Surveys” page 864 is illustrated in FIG. 73 providing additional searching criteria to aid the user in finding the desired survey.

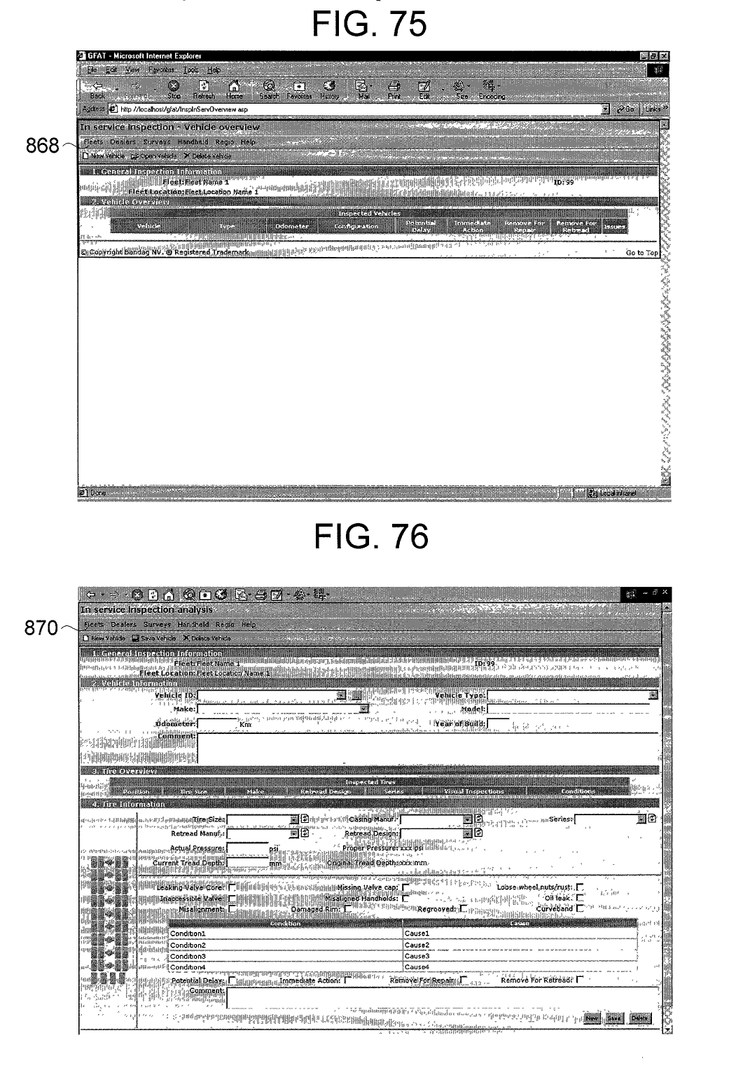

As discussed above, the dealer or user may decide to perform the various inspections/analyses by connecting with the web based GFAT server. This method is an alternate to using the handheld device or the preprinted forms also discussed above. To perform the in-service tire inspection, the user connects to the “In-Service Tire Inspection” page 866 illustrated in FIG. 74. The user inputs the general survey information for the particular fleet or location for which this in-service tire inspection is to be performed. Once the appropriate information has been entered or pulled up through the system, the user may access the “In-Service Inspection-Vehicle Overview” page 868 illustrated in FIG. 75 to enter or view specific information with regard to the fleet vehicles. Once all of the appropriate information for the particular fleet and vehicles for which the in-service tire inspection is to be performed is entered or available, the user connects to the “In-Service Inspection Analysis” page 870 illustrated in FIG. 76 to actually record the readings from the in-service inspection. As with the handheld device, this page 870 includes a graphical illustration of the tire and axle configuration of the particular vehicles under inspection. As will be recognized by one skilled in the art, these pages 866-870 are also utilized when the in-service tire inspection has been performed using the preprinted forms and the data is to be manually entered into the GFAT web based server application.

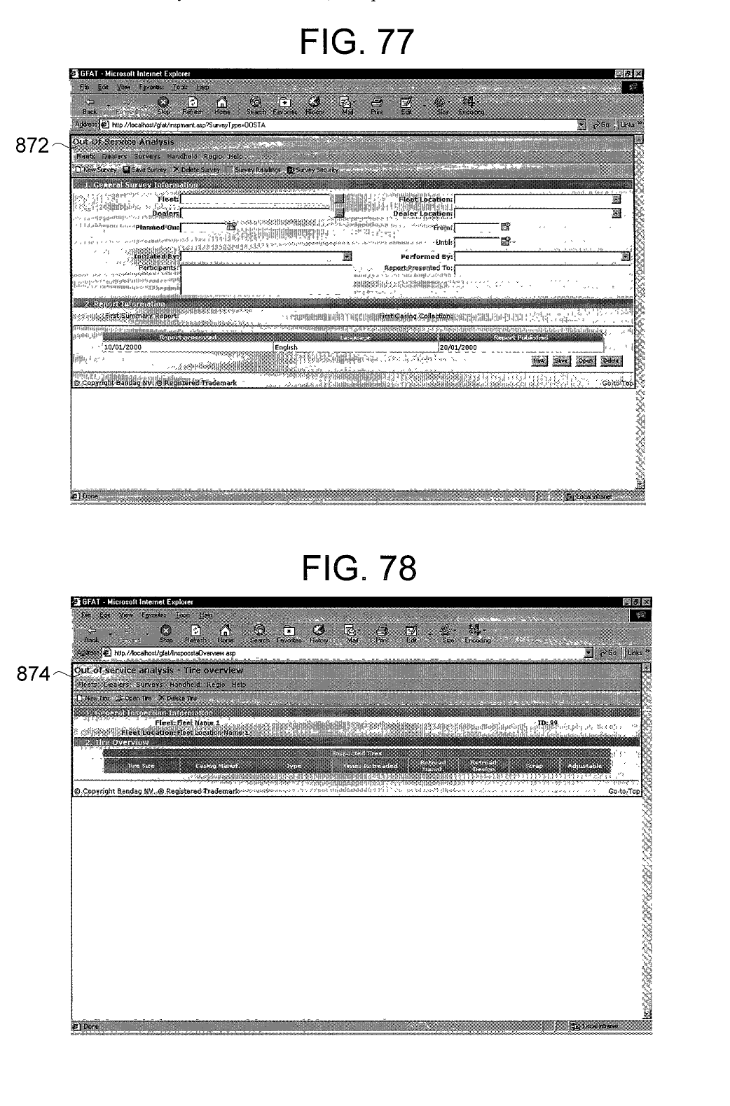

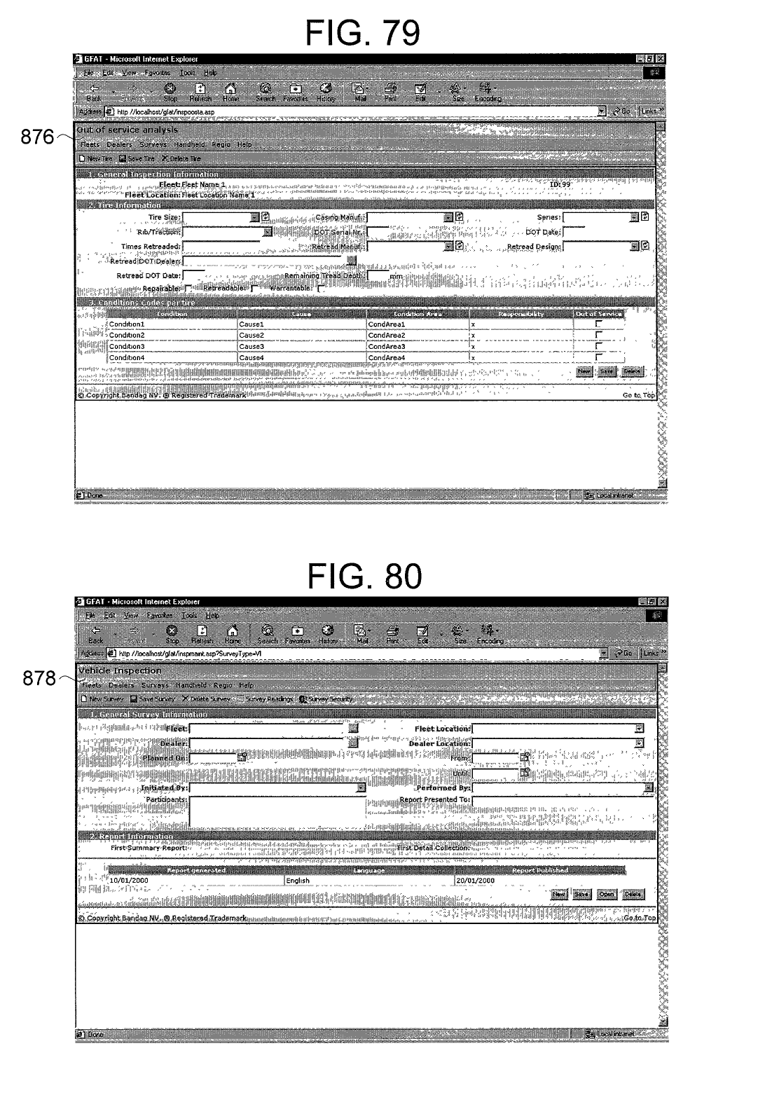

The performance or data entry of the out-of-service analysis is begun by first accessing the “Out-Of-Service Analysis” page 872 illustrated in FIG. 77. Here the user inputs or selects the general information for the particular fleet/location for which the out-of-service analysis is to be or has been performed. Particular information relating to the tire overview for the out-of-service analysis is entered or selected from the “Out-Of-Service Analysis-Tire Overview” page 874 illustrated in FIG. 78. Once the appropriate information has been entered or selected on pages 872 and 874, the actual out-of-service analysis may be performed by selecting the “Out-Of-Service Analysis” page 876 illustrated in FIG. 79. On this page, 876, all relevant information relating to the tire and conditions per tire is recorded. As discussed briefly above, this information may be entered in real time during the out-of-service analysis, or may be manually transposed from the performance of the out-of-service analysis utilizing the preprinted forms.

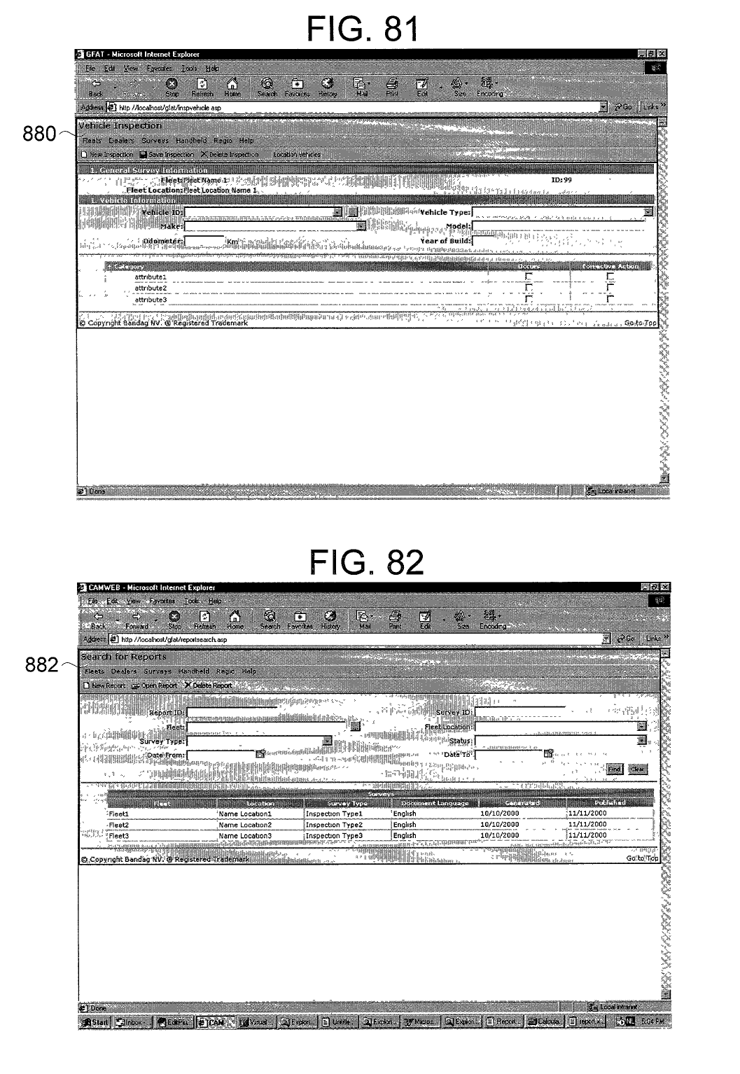

If the user wishes to perform or enter information relating to a vehicle inspection, the user connects to the “Vehicle Inspection” page 878 illustrated in FIG. 80. As with the previous analysis pages, this vehicle inspection page 878 allows the user to enter general survey information about the fleet/location. Also as with the previous initial analysis pages, appropriate information may simply be selected from the various pull-down menus available in the various fields under the general survey information section. Once the general information has been entered or selected on the vehicle inspection page 878, the user may enter vehicle specific information on the “Vehicle Inspection” page 880 illustrated in FIG. 81. As with the previous vehicle information pages, vehicle specific information may be simply selected from the pull-down menus, or may be entered manually for new vehicles. The information provided in the pull-down menus is appropriate to the particular dealer selected. This page 880 may also be used to enter the information collected during the vehicle inspection.

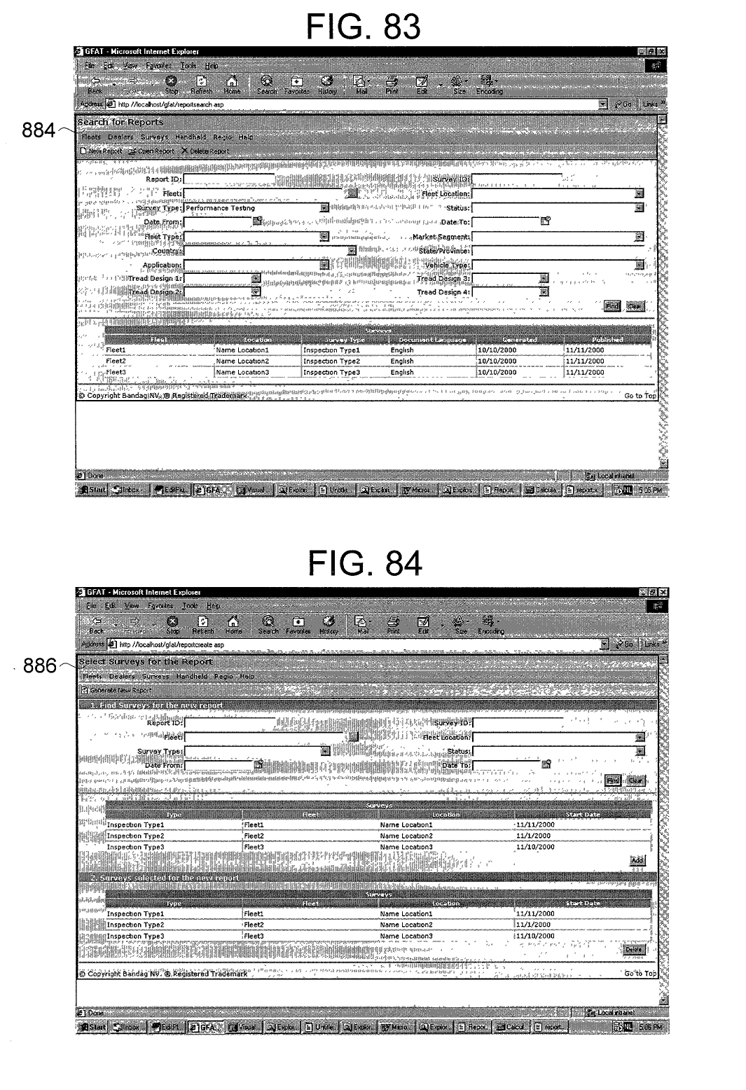

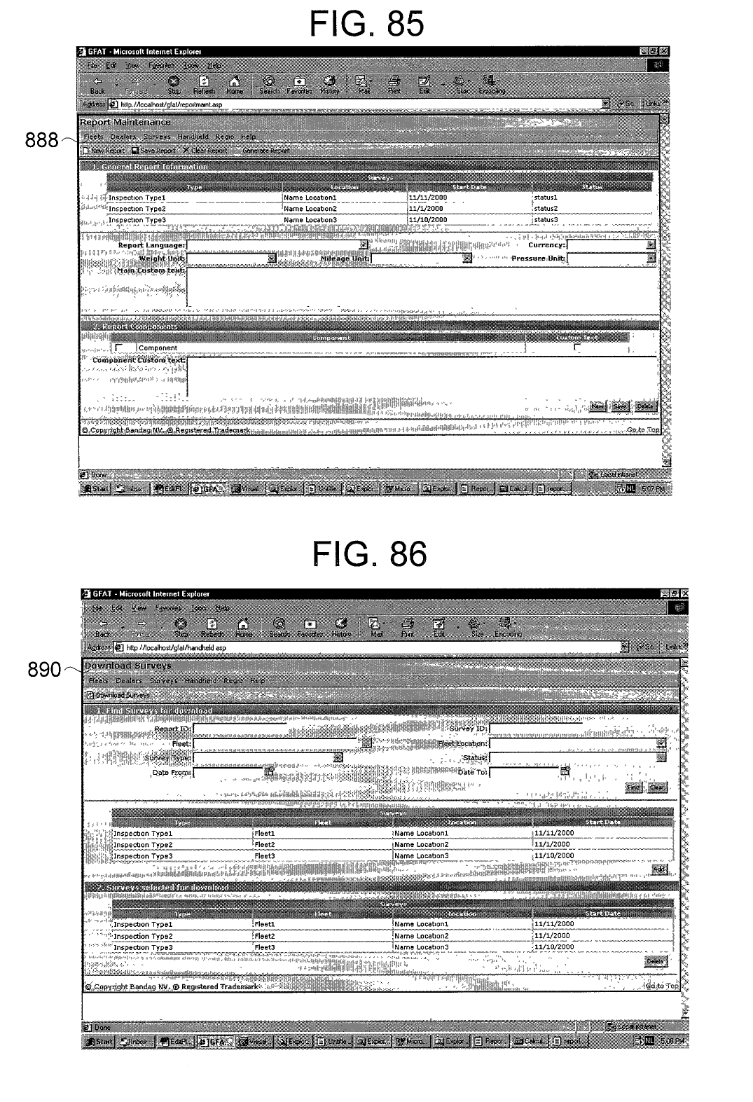

The various users of the web based GFAT system of the present invention may also search for and generate all of the various reports available through the system. This process may be begun by accessing the “Search For Reports” page 882 illustrated in FIG. 82. From this page the user is able to select any known parameters for the desired report. An alternate embodiment of the “Search For Reports” page 884 is illustrated in FIG. 83. As may be seen, this alternate search page 884 provides additional detail information to allow the user to find or generate the appropriate report based on information known to the user. If, however, the user wishes to generate a report that has not previously been generated, the user may simply access the “Select Surveys For The Report” page 886 illustrated in FIG. 84. From this page 886, the user may search for the various surveys that may be utilized in the generation of the new report. The surveys available are displayed, and may be simply selected for inclusion in the report generation. The “Report Maintenance” page 888 illustrated in FIG. 85 allows the user to review the general report information, and select the appropriate parameters to be utilized in the generated report. This allows the user to customize the report that is generated by the system of the present invention so that the output makes sense to that particular customer. For example, the report language, weight unit, mileage unit, currency, and pressure units may all be selected so that the output data is presented in an understandable format for the particular user. All back-end conversions are performed by the system of the present invention regardless of the units utilized in the actual recording of the information during the particular analysis survey.

As discussed above with regard to the performance of the various surveys available through the system of the present invention via the handheld device, the user may download survey information to populate the handheld device's local database for the particular fleet/location and analysis to be performed. This download from the web based GFAT server application is accomplished by accessing the “Download Surveys” page 890 illustrated in FIG. 86. From this page 890 the user selects or enters the appropriate information for the inspections to be performed for the particular fleet/location. Once the known information is entered, the available surveys are displayed for selection by the user. Once selected, the surveys may be downloaded to the handheld device to allow the user to complete the inspection without having to re-enter all of the information that is already known in the system by hand.

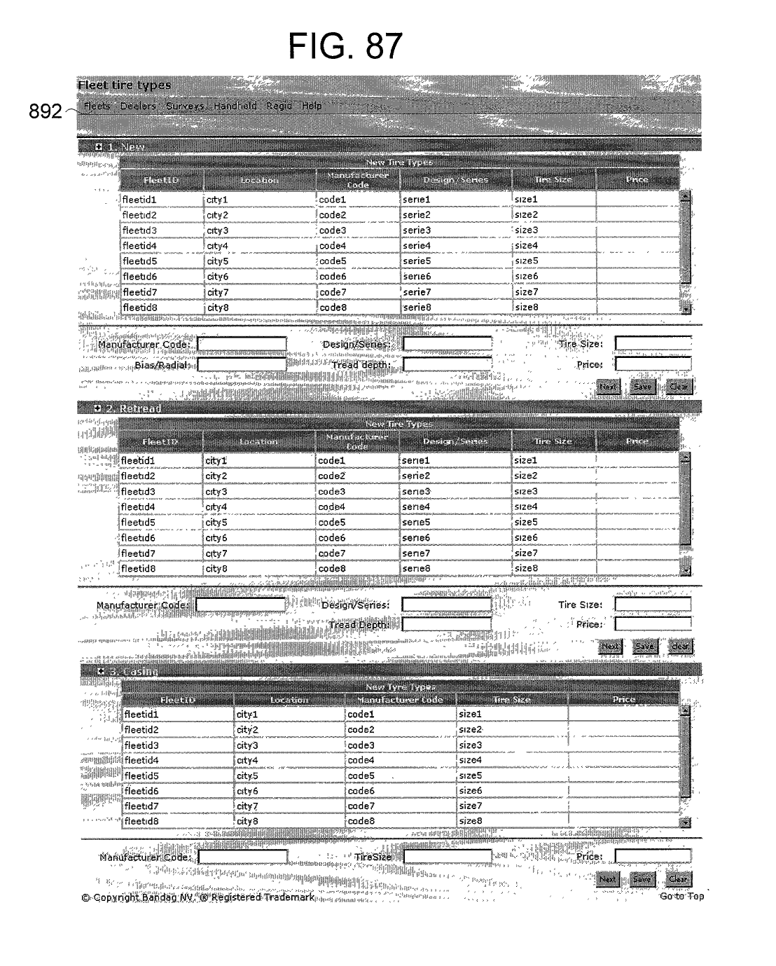

Entry and maintenance of individual fleet tires is accomplished through the web based GFAT application by accessing the “Fleet Tire Types” page 892 as illustrated in FIG. 87. This page 892 allows a user to enter or select information relating to new tires, retreads, as well as casings, including price information as well. Existing tires may be selected, and new tire information may be entered via this fleet tire types page 892.

As indicated above, after the completion of the in-service tire inspection, a user may choose to have summary reports printed or made electronically available through an embodiment of the present invention. The GFAT system provides the on-line requesting, assembling, and printing of the in-service tire inspection summary reports as a result of an in-service tire inspection. Alternatively, other processors could conduct the analysis and prepare the reports. One report contains information obtained from the physical inspection of the fleet combined with the cost data and industry standards. Of significant advantage to the user is a calculated estimate of the potential savings in tire costs based on various recorded parameters such as insufficient tread depth, improper inflation, potential service delays, irregular wear, dual mismatch, etc. In essence, the in-service tire inspection summary report highlights the potential savings in the tire cost of the fleet to the user so that appropriate adjustments in the tire management of the fleet may be accomplished. Preferably, this in-service tire inspection summary report is printed each time an in-service tire inspection is performed. While current memory limitations in the preferred handheld devices precludes the generation and printing of this summary report therefrom, the generation and printing of this report via the web based GFAT application may be accomplished nearly immediately once the data from the handheld device is uploaded. In an alternate embodiment of the present invention, a handheld device with increased memory capacity does allow for this summary report generation and printing.

As with other reports to be discussed, the user of the in-service tire inspection report can select different components that need to be included in the summary report of the inspection. These components may include the tires, casing brands, and retreads brands inspected by vehicle type, tires inspected by tire size and brand, original tires by brand, tires inspected by retread brand, retreads by axle type, retread potential, spare tires by tire size, tread depths in fleet, inflation in fleet, valves in fleet, immediate actions in fleet, immediate actions by axle, mismatch in fleet, tread depth mismatch in fleet, inflation mismatch in fleet, potential savings, etc.

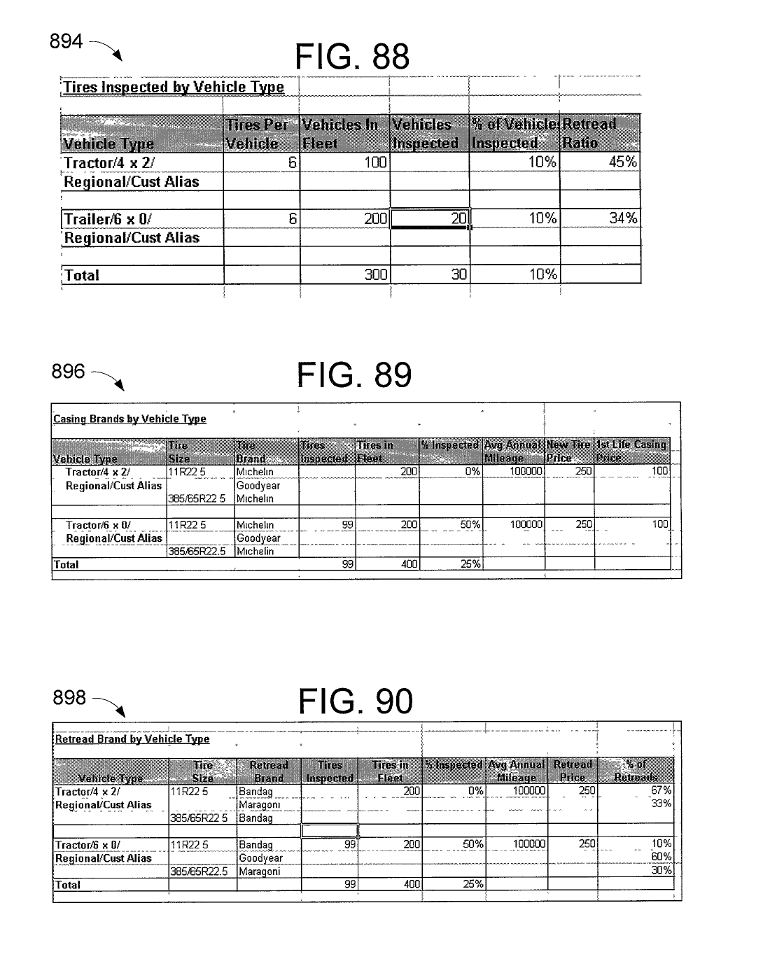

FIG. 88 illustrates an example of a “Tires Inspected By Vehicle Type” component 894 that displays all inspected vehicle classifications to explain the percentage of inspected vehicles and the retread ratio. This component contains all of the fleet vehicle classifications selected via the in-service tire inspections, tire readings, and survey vehicles. FIG. 89 illustrates the “Casing Brands By Vehicle Type” component 896, which contains an overview of all casing brands that were inspected in the selected in-service tire inspection, grouped per vehicle type. FIG. 90 illustrates an exemplary “Retread Brand By Vehicle Type” component 898 that provides an overview of all inspected retreaded tires per vehicle classification. If there is custom text specified for this component in the in-service tire inspection, the text is reported with the appropriate document language to be printed on this report component.

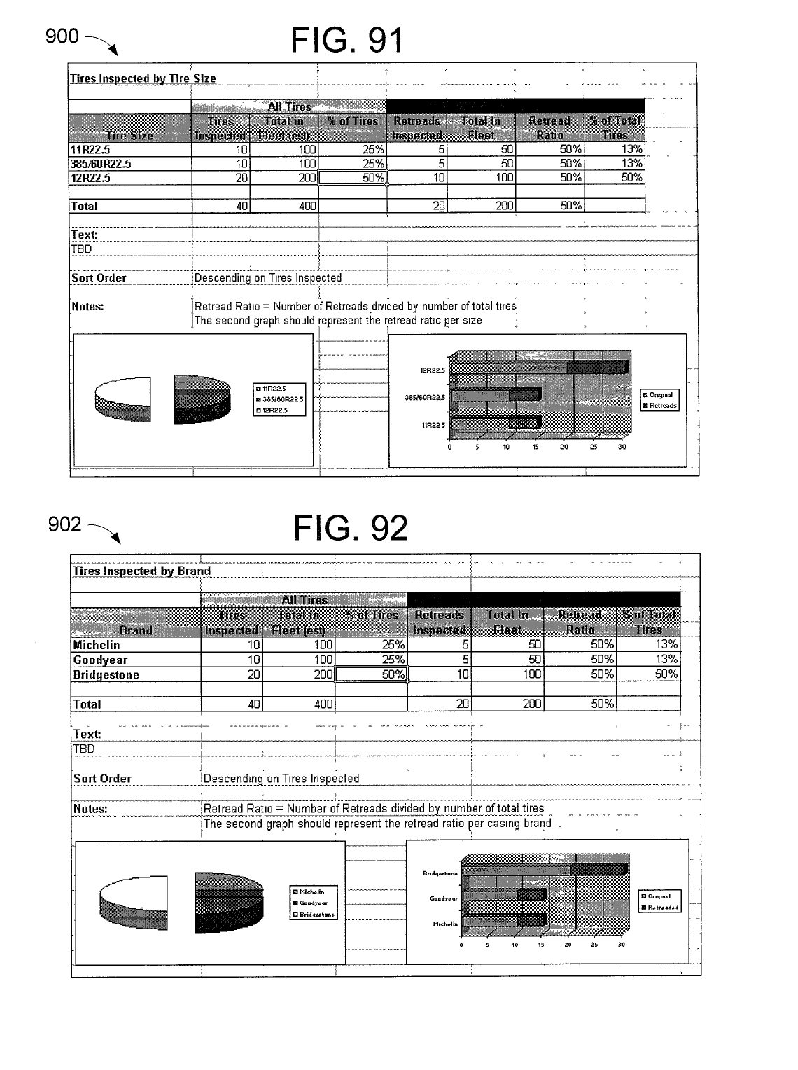

FIG. 91 illustrates an exemplary “Tires Inspected By Tire Size” component 900 that displays an overview of the inspected tires and the total number of tires in the fleet. In this component 900 the relation between new and retread tires is made clear. Such graphing capability is available through all components. In this component, an estimate of the total tires in the fleet is calculated as the number of vehicles in the fleet times the number of tires per vehicle classification divided by the total of inspected tires in the survey. The result of this calculation is an extrapolation factor that may be multiplied by the number of inspected tires to arrive at the estimate for the total number of tires in the fleet by tire size. Likewise, the total number of retreads in the fleet is also estimated by multiplying the total number of vehicles in the fleet by the number of tires per vehicle classification divided by the total of inspected tires in the survey to arrive at the extrapolation factor. The number of inspected retreads is then multiplied by this extrapolation factor to arrive at the estimate for the total number of retread tires in the fleet per brand.

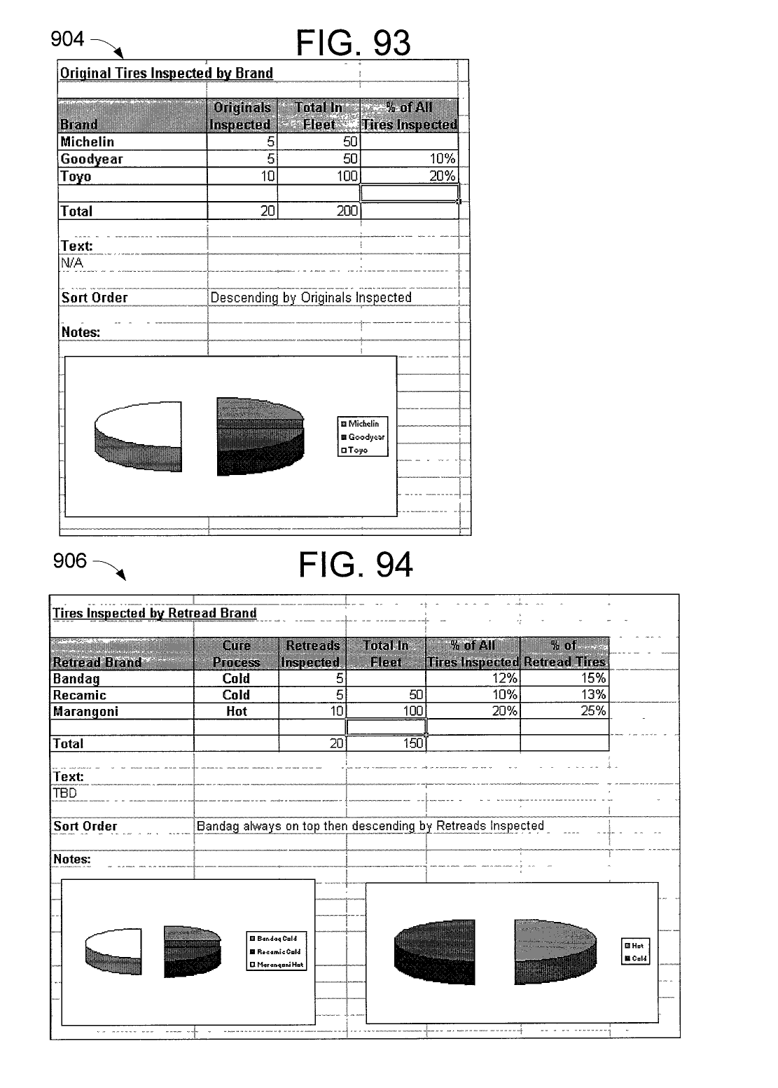

An exemplary “Tire Inspected By Brand” component 902 is illustrated in FIG. 92. This report component 902 displays the relationship between new tire brand and the number of retreads for each inspected brand in the selected survey. As with the previous component, the total number of tires in the fleet and the total number of retreads in the fleet are both extrapolated estimates based upon the survey data points contained in the system. FIG. 93 illustrates an exemplary “Original Tires Inspected By Brand” component that displays an overview of the number of original tires surveyed per brand. As with the previous report components, the total number of tires is extrapolated based upon the recorded data points and the information known about the fleet. An exemplary “Tires Inspected By Retread Brand” report component 906 is illustrated in FIG. 94. This report component 906 visualizes the relationship between the different retread brands and the cure process for the fleet. Once again, the system of the present invention extrapolates the recorded data points and the other information known about the particular fleet to derive an estimate of the total number of each category in the fleet.

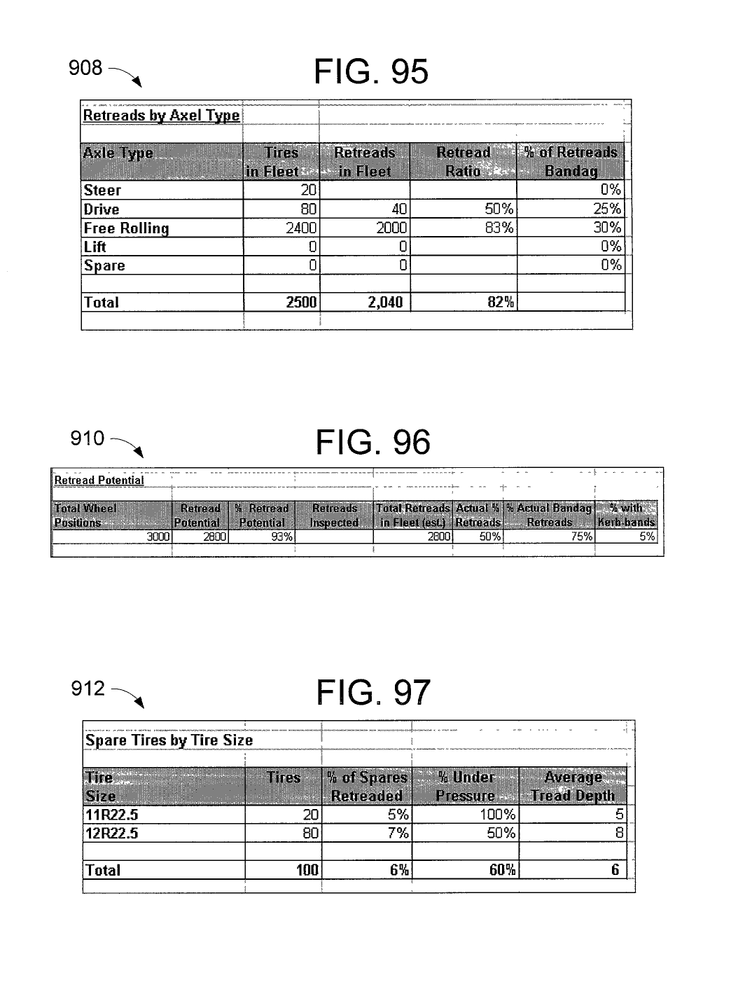

FIG. 95 illustrates an exemplary “Retreads By Axle Type” report component 908. This report component 908 displays the relation between the number of retreads and the axle types. This component is particularly useful to explain the potential crude oil savings and scrap casings available in the fleet. In addition to the numeric information illustrated in FIG. 95, this component 908 typically includes a potential cost savings text that may be highlighted to the fleet manager. This text may include a statement such as “By increasing your retreading to your potential of xxx (fleet specification of potential retreads) wheel positions, your contribution and decreasing consumption of crude oil would be xxxx gallons.” The calculation used by an embodiment of the present invention to derive these figures multiplies the actual number of retreads by the extrapolation factor and subtracts this number from the retread potential to derive the number of tires that are not retreaded but that could be. This value is then multiplied by a weight figure and a coefficient figure, and by the market price of crude oil to derive the potential savings. In an exemplary embodiment the weight figure is 45 kg and the coefficient figure is 0.8, although each of these figures may be adaptable in time, as is the price of oil.

This report component may also generate text indicating additional potential savings of the scrap casings. Such text may read as follows: “By increasing the retreading ratio, you would decrease the scrap casings needed recycling by xx. This would save you xxx in scrapping costs.” The calculations behind this potential savings statement multiplies the actual number of retreads by the extrapolation factor and subtracts this number from the retread potential. The dollar value is calculated by multiplying the actual number of retreads by a scrap cost per casing times the extrapolation factor and then subtracting this number from the retread potential. FIG. 96 also illustrates an exemplary “Retread Potential” report component 910 that also displays the relation between the retread potential and the actual retreads to explain the potential savings when the fleet respects the retread potential. This component may also print the above-described text estimating the potential in cost savings for both crude oil and scrapping costs.

FIG. 97 illustrates an exemplary “Spare Tires By Tire Size” report component 912 that displays the inspected spare tires per tire size to explain the savings when the fleet would use used retreads for the spare tires. In addition to the numeric information illustrated in FIG. 97, this report component may generate text indicating an estimate of the potential savings of using retreads for all spare wheels. This estimate is calculated by adding the tire price of each spare tire times the extrapolation factor and subtracting from this value the retread price of each tire times the same extrapolation factor. This component 912 may also provide text indicating an estimate of the potential savings if the client were to eliminate the spare wheels and utilize a breakdown service by multiplying the sum tire price of each spare tire times the extrapolation factor. Additionally, this component can provide text indicating an estimate of the decrease in scrap casings needing recycling by increasing the tire ratio based upon a calculation of the retread potential minus the actual retreads times the extrapolation factor.

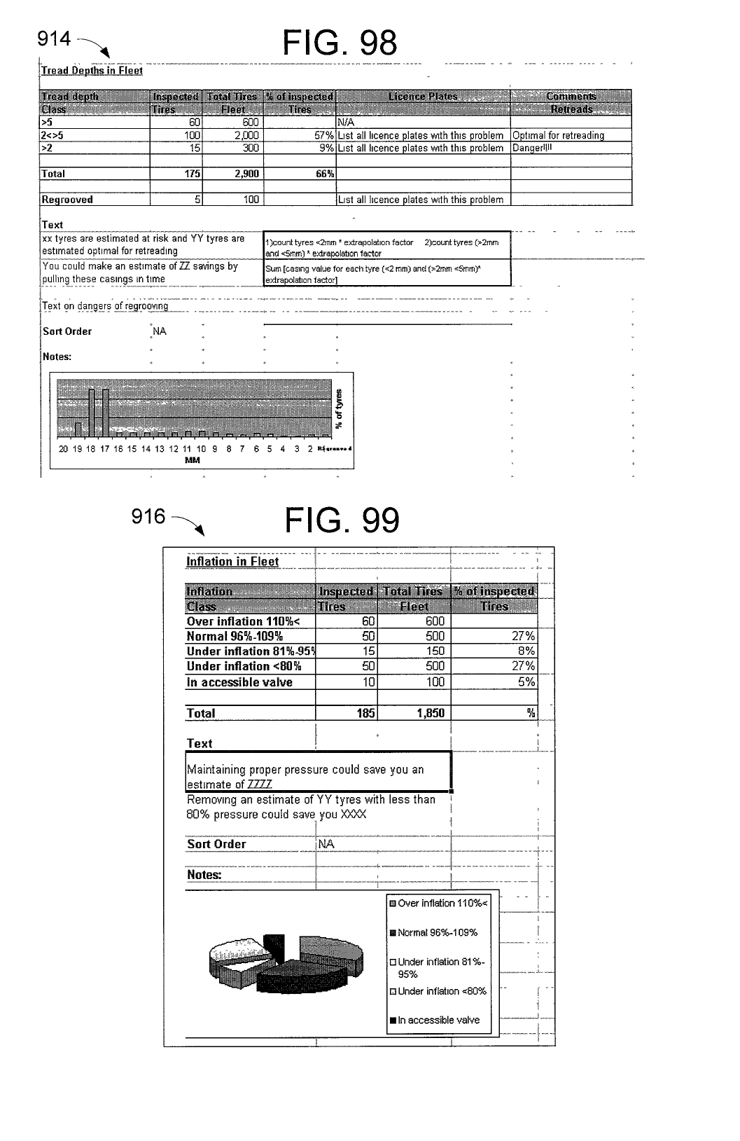

An exemplary “Tread Depth In Fleet” report component 914 is illustrated in FIG. 98. This component displays for the selected in-service tire inspection all vehicles with license plate or vehicle name for tires that have optimal tread depth for retreading, not enough tread depth, and that are grooved. For each of the three classifications of tread depth, comments may be provided indicating both a potential savings and potential safety issues. Also illustrated in this exemplary component 914 is the text indicating the estimated tires at risk and tires optimal for retreading. This calculation performs a count of the actual tires in each of the two classes and multiplying them by the extrapolation factor. Text indicating an estimate of the savings by pulling these casings in time is also provided and has as its underlying calculation a sum of the casing value for each tire less than 2 millimeters and those between 2 and 5 millimeters times the extrapolation factor. Further, text on the dangers of regrooving may also be included.

FIG. 99 illustrates an exemplary “Inflation In Fleet” report component 916 that displays for the selected in-service tire inspection the tires in the different inflation classes. In addition to the numeric and graphical information, this report component may also provide an estimate of the potential cost savings by maintaining proper pressure, and an estimate of the potential cost savings for removing a number of tires with less than 80% pressure. The first estimate is provided by looking at all tires with a pressure problem excluding the less than 80% problem and summing the tire values times the extrapolation factor times a factor relating to a service loss percentage. This service loss percentage factor may vary based on observations and actual data accumulated by the dealers. As an example, a service loss of 13% may be used for tires underinflated by 10%, a loss of 19% for underinflation by 15%, a service loss of 26% for a 20% underinflation, a 39% loss for 25% underinflation, a 52% loss for a 30% underinflation, and a 59% service loss for an underinflation of 35%. The factor may also utilize overinflation as a factor, for example, a 5% service loss for overinflations between 10% and 20%, and a 15% service loss for overinflations by 20-30%.

FIG. 100 illustrates an exemplary “Valves In Fleet” report component 918 that displays an overview of the valve problems for the selected in-service tire inspection. In addition to the numeric information illustrated in FIG. 100, textural information indicating a percentage of the tires that are inaccessible and presumably underinflated may also be provided. Based on this number, the system of the present invention also estimates the potential loss resulting therefrom. This potential loss is calculated by multiplying the number of tires with inaccessible valves times the extrapolation factor multiplied by the service loss percentage discussed above for each tire and then summing these individual results.

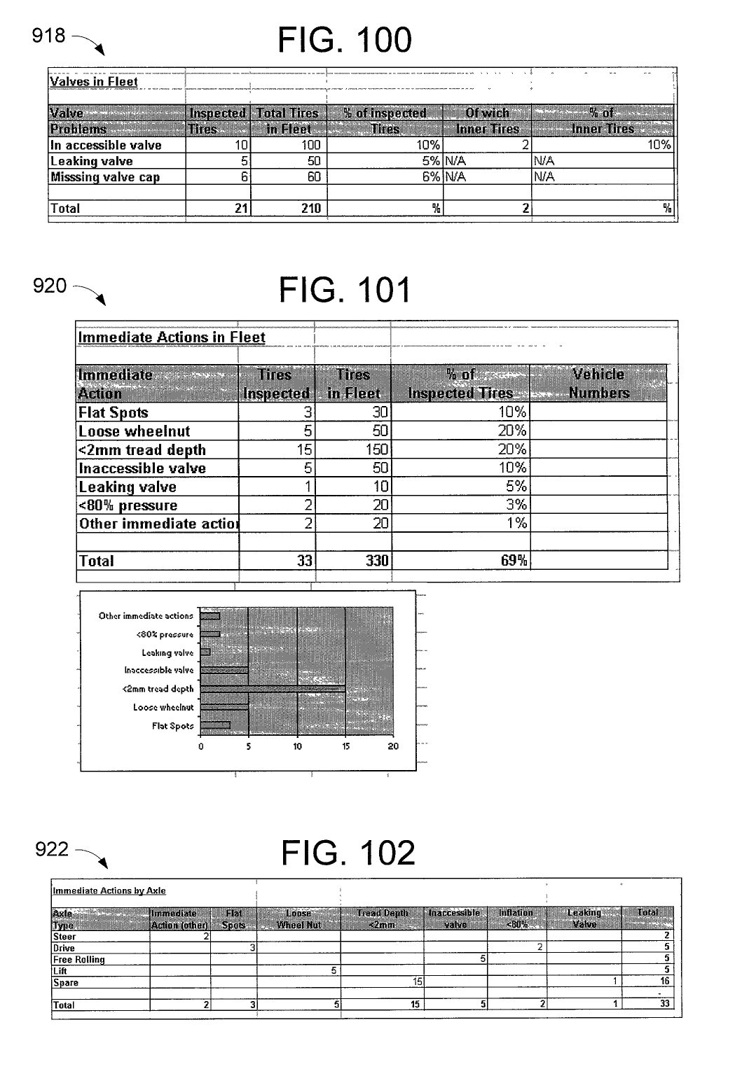

An exemplary “Immediate Actions In Fleet” report component 920 is illustrated in FIG. 101. This component 920 displays an overview of the number of tires that need some sort of an immediate action. FIG. 102 displays an exemplary “Immediate Actions By axle” report component 922 that displays the tires per axle and per immediate action type.

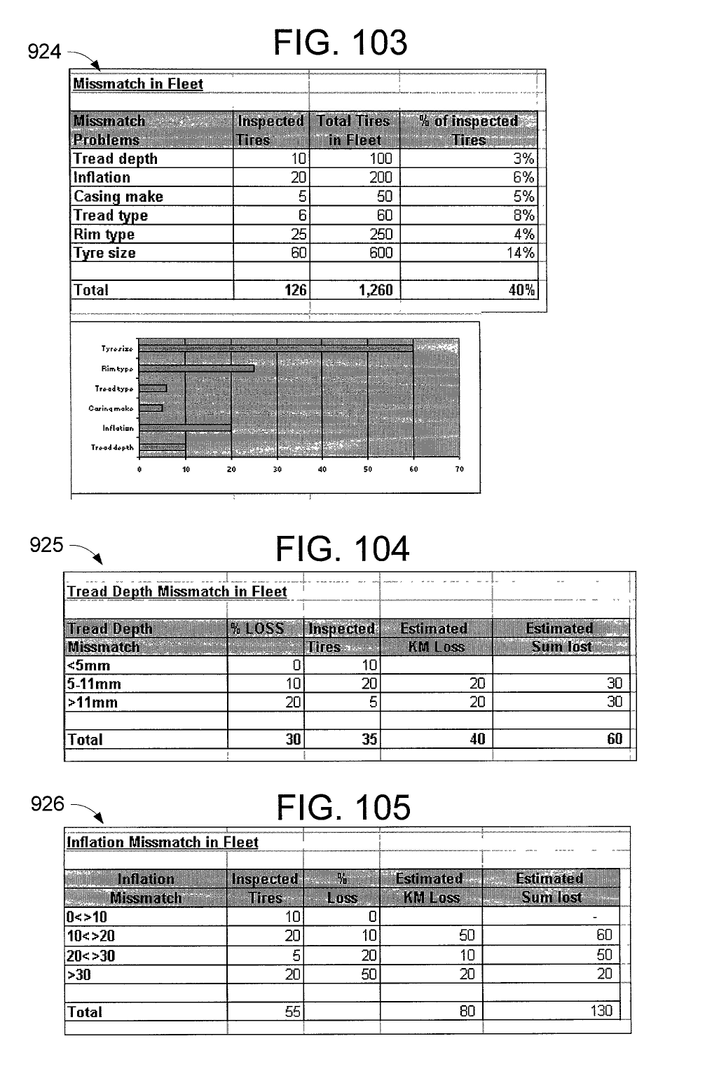

FIG. 103 illustrates an exemplary “Mismatch In Fleet” report component 924 that displays the number of tires that are indicated as having a mismatch grouped by the mismatch problem. In addition to the numeric and graphical information presented by this component as illustrated in FIG. 103, this report component 924 may also include textural information indicating an estimated savings resulting from the correction of the tread depth conditions. FIG. 104 illustrates an exemplary “Tread Depth Mismatch In Fleet” report component 925 that displays an overview of the tires grouped by tread depth mismatch. In this component report 925, the estimated sum loss is calculated as the sum of distance per year of twin tires with tread depth mismatch times the percent loss factor times the extrapolation factor. FIG. 105 illustrates an exemplary “Inflation Mismatch In Fleet” report component 926 that displays an overview of the number of tires to explain the loss because of inflation mismatch. In this component 926 the estimated sum loss is calculated as described above.

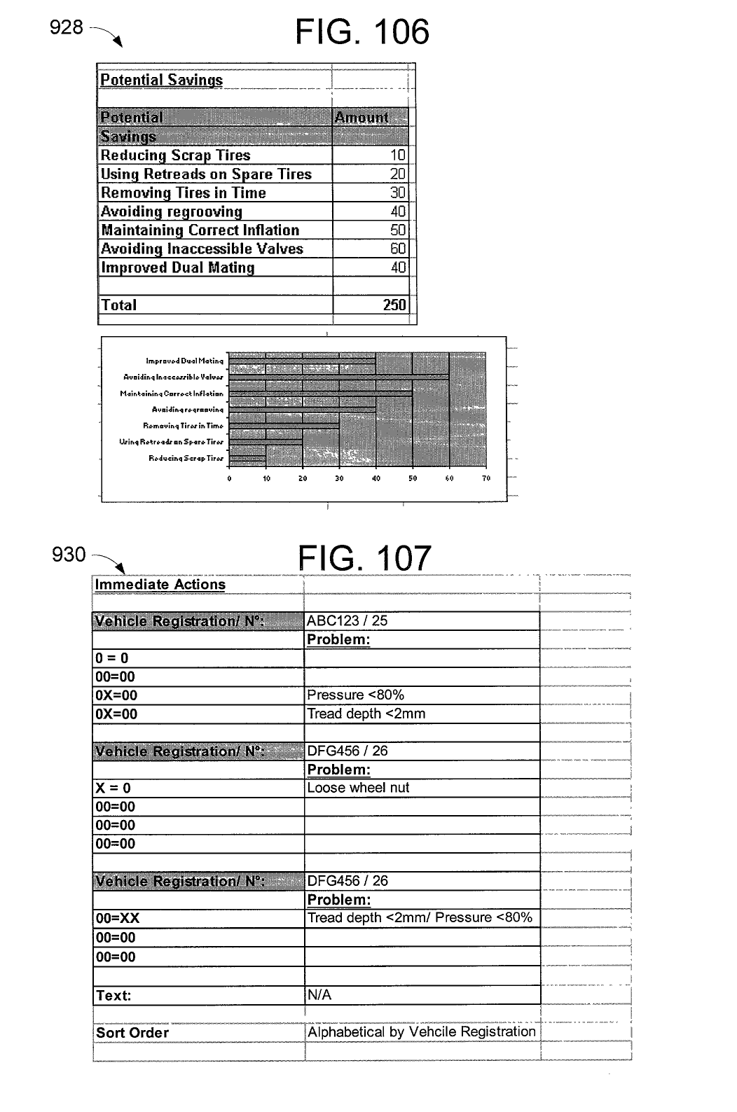

FIG. 106 illustrates an exemplary “Potential Savings” summary report component 928 that displays the potential savings of the selected in-service tire inspection. Each of the potential savings amounts illustrated in this component 928 are calculated as described above with regard to the other components of the in-service tire inspection summary report. For example, the potential savings relating to the reduction of scrap casings by retreading is calculated and displayed as a line item. The potential savings resulting from the use of retreads for all spare tires is also included, as is the benefit provided by removing tires in time. This report also includes a potential savings when regrooving is avoided, and when proper inflation is maintained, both directly and through avoiding inaccessible valves. Further, this report also includes a cost benefit value that may be realized when better mating of tires in dual pairs is accomplished. Finally, this summary report component 928 provides a summation of the total potential operational cost savings that may be realized though a better maintained fleet tire program.

In addition to the in-service tire inspection summary report, a user may choose to generate an in-service immediate action report as a result of an in-service tire analysis. This in-service immediate action report contains for all inspected vehicles the actions that are indicated as “To Be Addressed Immediately.” This report, an exemplary embodiment of which is illustrated in FIG. 107 as report 930, displays only those vehicles where at least one immediate action has been indicated. Of course, one vehicle may have more than one immediate action attached to it. Preferably, the report 930 sorts the immediate actions per tire. In a preferred embodiment, this immediate action report may be printed from the handheld device upon the conclusion of the in-service tire inspection. To do so, the user selects the in-service inspection from the inspection overview list, and indicates which type of report he would like to print (immediate action report or the work order report discussed below). In one embodiment, these are the only two reports that could be printed offline for an in-service tire inspection, although an alternate embodiment of the present invention allows generation of the summary report as well. Once selected this report may be printed on a portable thermal or inkjet printer that the user has brought with him to perform the in-service tire analysis. In this way, the fleet manager may have immediate feedback of the immediate actions that need to be taken for the fleet vehicles just inspected.

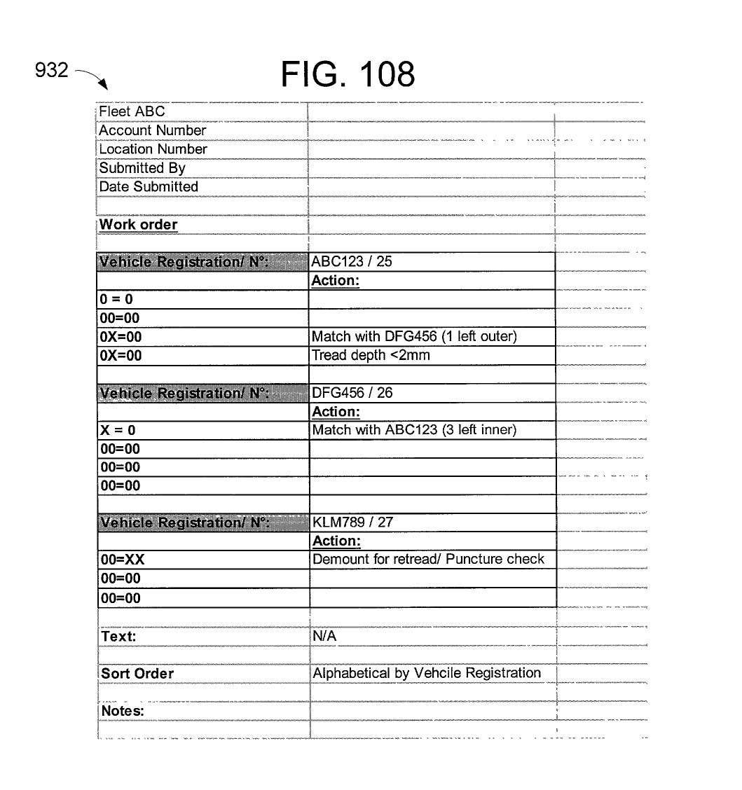

FIG. 108 illustrates an exemplary “In-Service Work Order” report 932 that may also be generated offline via the handheld device upon conclusion of the in-service tire analysis. This report 932 contains, for all inspected vehicles, the actions that are selected and the actions that are indicated as “to be addressed immediately.” This report displays only those vehicles where at least one action is selected, and will also include vehicles that have more than one action attached to it. Actions that have a corrective action registered are also displayed in this report 932, but that are already checked as corrected. Printing of this report offline via the handheld device and portable printer is accomplished as described above with regard to the immediate action report 930 illustrated in FIG. 107.

After an out-of-service tire analysis (OOSTA) has been completed, a user may choose to generate an out-of-service tire inspection report. This report contains information obtained from the physical inspection of the scrapped tire pile combined with the cost data and industry standards. In this report, typically an estimate is calculated of potential savings in tire costs as a result of the observed information in the analysis. Preferably, for each out-of-service tire analysis that is performed, a summary report is printed. In one embodiment this report may only be generated and printed from the web based GFAT application server, although alternate embodiments allow the handheld device to access and generate this report as well. The GFAT system of the present invention generates this report using the proper language and units as selected by the user or as contained in the user profile. The user has the option to select different components that need to be or are desired to be included in the summary of the inspection. Typically, the inspection information in the report is detailed per tire and grouped per brand, type, or tire size. The components that may be selected by a user for inclusion in the out-of-service tire inspection report includes an OOSTA summary component, usable tread by action component, times retreaded by brand component, casing age by brand component, OOSTA category by brand component, OOSTA cause by brand component, casing age by retread brand component, OOSTA cause category by retread component, casing age by times retreaded component, times retreaded by size component, OOSTA cause category by size component, OOSTA cause category by age component, compare OOSTA and ISTI by tire brand component, compare OOSTA and ISTI by retread brand component, compare OOSTA and ISTI by tire size component, and OOSTA conclusion component.

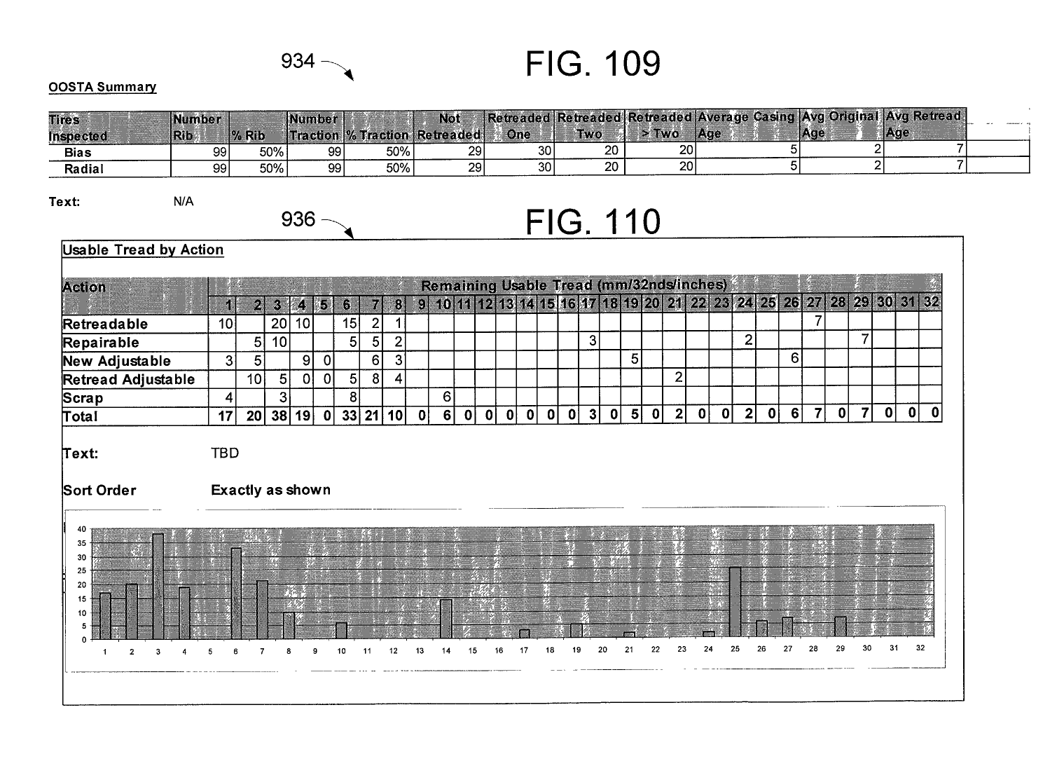

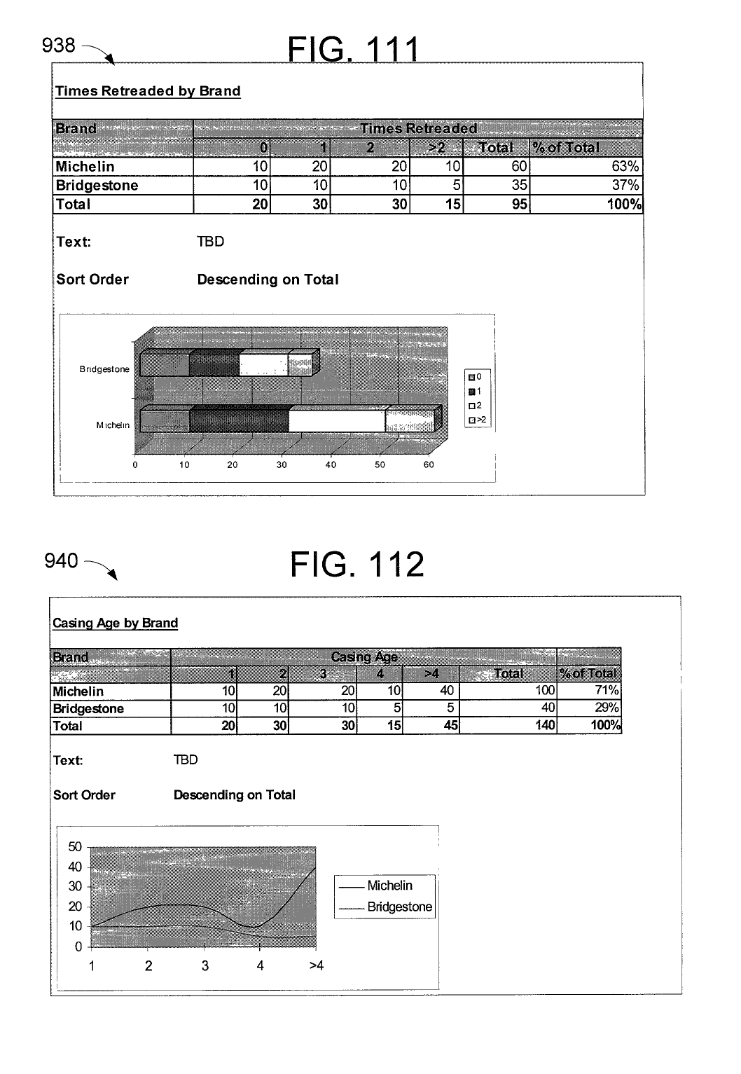

FIG. 109 illustrates an exemplary “OOSTA Summary” report component 934 that displays the tire information of inspected out-of-service tires by tread design. An exemplary “User Tread By Action” report component 936 is illustrated in FIG. 110. This component 936 displays the number of usable tires by action and remaining usable tread depth in exemplary “Times Retreaded By Brand” report component 938 is illustrated in FIG. 111. This component displays the number of retreaded tires grouped by manufacturing code and times retreaded. FIG. 112 illustrates an exemplary “Casing Age By Brand” report component 940 that displays the number of inspected tires by manufacturer and casing age. This report provides an insight to the durability of tires per manufacturer.

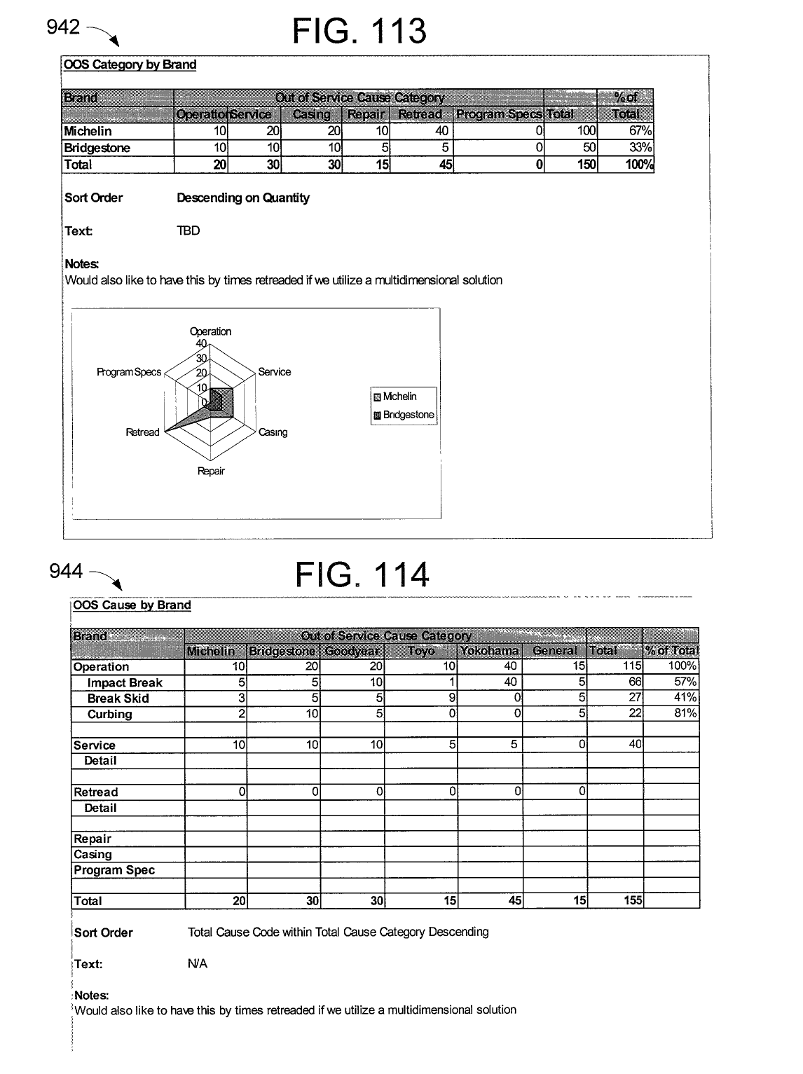

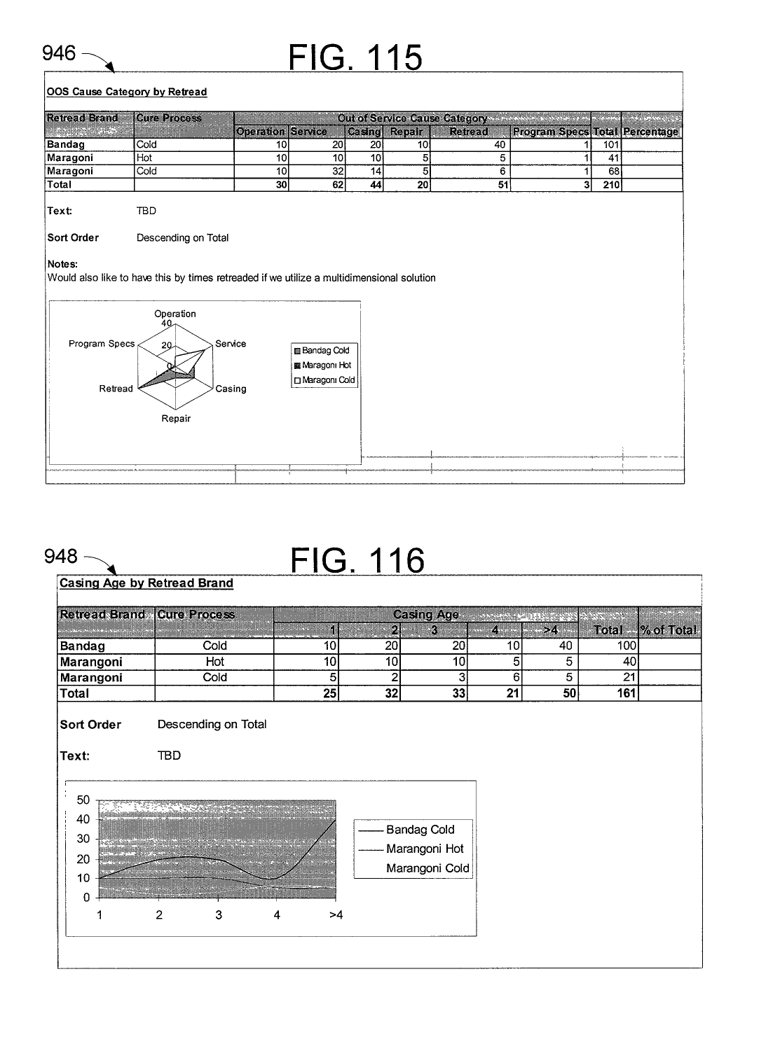

An exemplary “Out-Of-Service Category By Brand” report component 942 is illustrated in FIG. 113. This component 942 displays the relationship between the out-of-service cause and the tire manufacturer. FIG. 114 illustrates an exemplary “Out-Of-Service Cause By Brand” report component 944. This component 944 displays the number of inspected tires with a certain out-of-service cause by manufacturer. An exemplary “Out-Of-Service Cause Category By Retread” report component 946 is illustrated in FIG. 115. This component 946 displays the relationship between out-of-service cause category and the tire manufacturer.

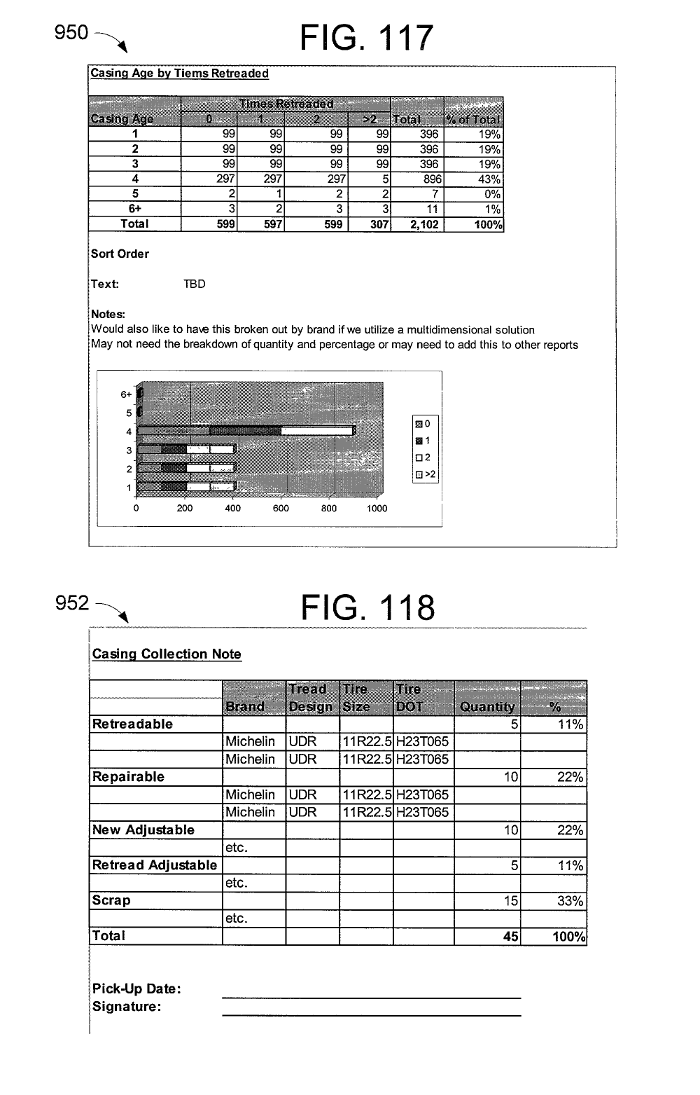

FIG. 116 displays an exemplary “Casing Age By Retread Brand” report component 948 that displays the number of inspected tires by retread manufacturer and casing age. An exemplary “Casing Age By Times Retreaded” report component 950 is illustrated in FIG. 117. This report component 950 displays the number of tires per casing age and times retreaded. FIG. 118 illustrates an exemplary “Casing Collection Note” report 952 that may be printed from the handheld device offline. This report 952 displays per action an overview of the collected tires and may be immediately printed on the portable printer at the conclusion of the OOSTA.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitle

What is claimed is:

1. A web-based information management system for fleet tires, comprising:
a production database which receives via a distributed communications network and stores descriptive information concerning at least one physical characteristic of a plurality of tires of a fleet;
an information management server including data communication circuitry adapted to connect to a distributed communications network, said information management server accessing said production database for the retrieval of said descriptive fleet information for further processing; and
wherein said information management server has stored therein a plurality of web pages accessible by thin clients so that such thin clients may supply said descriptive information and such thin clients may receive fleet tire information.

2. The system of claim 1, wherein said information management server further includes business logic which authenticates access of the thin clients to said web pages.

3. The system of claim 2, wherein said information management server provides the web pages in a language preferred by the thin client based on said business logic authentication.

4. The system of claim 1, wherein said information management server comprises a first regional server located in a first geographic region and containing fleet tire information for said first geographic region, a second regional server located in a second geographic region and containing fleet tire information for said second geographic region, and a global server containing fleet tire information for both said first and said second geographic regions.

5. The system of claim 4, wherein said first regional server communicates with said global server, and said second regional server communicates with said global server.

6. The system of claim 4, wherein said first regional server communicates with both said global server and said second regional server, and said second regional server communicates with both said global server and said first regional server.

7. The system of claim 1, further comprising a portable computing device having a local fleet information database adapted to store at least a portion of the fleet tire information, and wherein said information management server synchronizes said production database and said local database.

8. The system of claim 7, wherein said information management server populates said production database with fleet tire information entered on said web pages from the thin clients and from said local database of said portable computing device.

9. The system of claim 7, wherein said portable computing device is a Windows CE compatible computing device having stored thereon a fleet tire management program.

10. The system of claim 7, wherein said portable computing device is a Palm compatible computing device.

11. The system of claim 7, wherein said portable computing device populates said local fleet information database with data entered thereon, and wherein said data is uploaded to said production database upon synchronization therewith.

12. The system of claim 11, wherein said portable computing device includes speech recognition capability, and wherein the data entered on the portable computing device is spoken by a user.

13. The system of claim 11, wherein said portable computing device includes a graphical illustration of a transportation vehicle's wheel and axle configuration, said graphical illustration operable to associate fleet tire information to a particular tire on the transportation vehicle.

14. The system of claim 1, wherein said information management server further comprises an analysis relational database management system (RDBMS) and an on-line analytical processing (OLAP) system, and wherein said OLAP system and said analysis RDBMS utilize the fleet tire information in said production database to generate a report based on a query from the thin client, said report being stored in said production database and available for viewing on-line by the thin client and for downloading and printing.

15. The system of claim 14, wherein said report includes projected operational cost savings calculated from the fleet tire information in said production database.

16. The system of claim 1, wherein at least a portion of said web pages presents a graphical illustration of a transportation vehicle's wheel and axle configuration, said graphical illustration operable to associate fleet tire information to a particular tire on the transportation vehicle.

17. A method of maintaining fleet tire information, comprising the steps of:
launching an Internet browser application;
connecting to a centralized fleet information management server through the Internet browser application;
transmitting authentication information to the centralized fleet information management server; and
accessing fleet tire information derived from information stored at the fleet information management server.

18. The method of claim 17, wherein said step of accessing comprises the steps of submitting a query to said fleet information management server, receiving a list of information satisfying the query, and selecting an item from the list of information.

19. The method of claim 18, wherein said step of submitting a query comprises the step of submitting a query containing information identifying a particular fleet.

20. The method of claim 18, wherein said step of submitting a query comprises the step of submitting a query containing information identifying a particular dealer.

21. The method of claim 18, wherein said step of submitting a query comprises the step of submitting a query containing information identifying a particular report.

22. The method of claim 17, further comprising the step of submitting fleet tire information to the fleet information management server for storage therein.

23. The method of claim 17, further comprising the step of downloading information from the fleet information management server to a portable computing device.

24. The method of claim 23, further comprising the steps of recording fleet tire information on the portable computing device, and uploading the fleet tire information from the portable computing device to the fleet information management server for storage thereon.

25. The method of claim 23, further comprising the steps of recording fleet tire information on the portable computing device, and printing a report including the fleet tire information recorded on the portable computing device.

26. A method of maintaining information concerning the tires of a fleet through a fleet tire inspection, comprising the steps of:
launching an Internet browser application;
connecting to a centralized fleet information management server through the Internet browser application;
downloading fleet information to a portable computing device from the fleet information management server; and
storing tire inspection data which is accumulated through a physical inspection of individual tires on the portable computing device.

27. The method of claim 26, further comprising the step of printing a report containing at least a portion of the tire inspection data on a portable printer.

28. The method of claim 26, further comprising the step of uploading the tire inspection data from the portable computing device to the fleet information management server.

29. The method of claim 28, further comprising, after the step of uploading, the steps of:
selecting report components from the fleet information management server; and
requesting the fleet information management server to generate a report using the selected report components, the report being stored on the fleet information management server.

30. The method of claim 29, further comprising the step of downloading the report.

31. The method of claim 26, wherein the step of recording comprises the step of speaking tire inspection data to the portable computing device.

32. The method of claim 26, wherein the step of recording comprises the step of accessing a graphical image depicting a wheel and axle configuration of a transportation vehicle, selecting one wheel of the graphical image, and entering tire inspection data relating to a wheel on a transportation vehicle corresponding to the selected one wheel of the graphical image.

33. A method of maintaining information through a web-based system concerning the tires of a fleet, comprising the steps of:
launching an Internet browser application;
connecting to a centralized fleet information management server through the Internet browser application;
accessing a fleet tire inspection page on the fleet information management server;
entering tire inspection data on the fleet tire inspection page on the fleet information server; and
communicating said inspection data to the fleet management server.

34. The method of claim 33, wherein said step of accessing comprises the steps of retrieving a fleet profile for a fleet to be inspected, and selecting a fleet tire inspection page associated with the fleet to be inspected.

35. The method of claim 33, further comprising the step of requesting the fleet information management server to generate a summary report containing at least a portion of the tire inspection data.

36. The method of claim 33, further comprising the steps of:
selecting report components from the fleet information management server; and
requesting the fleet information management server to generate a report using the selected report components, the report being stored on the fleet information management server.

37. The method of claim 33, further comprising the step of downloading the report.

38. The method of claim 33, wherein said step of accessing comprises the steps of creating a fleet profile for a fleet to be inspected on the fleet information management server, and selecting a fleet tire inspection page associated with the fleet to be inspected.

39. A computer-readable medium having computer-executable instructions for performing steps comprising:
storing fleet profile information in a local database;
displaying a user interface screen having a plurality of data entry fields;
receiving data input associated with the data entry fields;
storing the data input in the local database;
connecting to a web-based fleet information management server; and
uploading the data input from the local database to the fleet information management server.

40. The computer-readable medium of claim 39, wherein said step of storing fleet profile information comprises the steps of:
connecting to the web-based fleet information management server; and
downloading the fleet profile information from the web-based fleet information management server into the local database.

41. The computer-readable medium of claim 39, wherein said step of storing fleet profile information comprises the steps of:
displaying a fleet profile user interface screen having a plurality of profile information entry fields;
receiving profile information associated with the profile information entry fields; and
storing the profile information in the local database.

42. The computer-readable medium of claim 39, wherein said step of displaying a user interface screen comprises the step of displaying a user interface screen having a graphical image of a transportation vehicle wheel and axle configuration, each wheel having corresponding data entry fields associated therewith.

43. The computer-readable medium of claim 39, wherein said step of receiving data input comprises the steps of receiving a voice signal corresponding to a data entry field, and transforming the voice signal to a data input for that data entry field.

44. The computer-readable medium of claim 39, further comprising the step of generating a summary report containing at least a portion of the data input from the local database.

45. A method of determining an operational cost savings in a fleet tire management program by addressing a tire characteristic parameter, comprising the steps of:
selecting the tire characteristic parameter having an operational cost impact for a fleet vehicle;
determining a number of tire samples that possess the selected tire characteristic parameter; and
multiplying the number of tire samples by an operational cost impact factor.

46. The method of claim 45, wherein said step of determining a number of tire samples comprises the step of searching a production database to determine a number of data point samples stored therein that meet the selected tire characteristic parameter.

47. The method of claim 46, wherein the number of data point samples is less than all tires in a fleet, further comprising the step of multiplying the number of data point samples by an extrapolation factor to determine a total number of tires in the fleet that possess the selected tire characteristic.

48. The method of claim 45, wherein said step of selecting comprises the step of selecting tires that are available for retread but that are not retreaded, and wherein said step of multiplying comprises the step of multiplying the number of tire samples by a weight figure, a coefficient figure, and a market cost for crude oil to derive an operational cost savings relating to crude oil consumption.

49. The method of claim 45, wherein said step of selecting comprises the step of selecting tires that are available for retread but that are not retreaded, and wherein said step of multiplying comprises the step of multiplying the number of tire samples by a scrap cost per casing to derive an operational cost savings relating to scrapping of casings.

50. The method of claim 45, wherein said step of selecting comprises the step of selecting spare tires that are not retreaded, and wherein said step of multiplying comprises the step of multiplying the number of tire samples by the cost of spare tires and subtracting from this value the product of the number of tire samples times the cost of retread tires to derive an operational cost savings relating to the use of retreads for all spare tires.

51. The method of claim 45, wherein said step of selecting comprises the steps of selecting tires that are improperly inflated, and classifying the tires into groups base on an amount of improper inflation, and wherein said step of multiplying comprises the step of summing for all groups a product of a number of tires in each group and a service loss factor for each group to derive an operational cost savings relating to improper inflation.

52. A method for processing and communicating information pertaining to fleet tire maintenance and fleet performance comprising:
accumulating fleet data on a central production database through a distributed communications network wherein said fleet data comprises tire physical parameters including information relating to at least one physical property of a tire;
processing said fleet data to identify characteristics that present safety risks for continued unaltered use of a particular tire or group of tires of a fleet;
preparing a report to present the characteristics that present safety risks; and
transmitting said report through a distributed communications network wherein said report provides information sufficient to permit the safety concern to be removed.

53. The method of claim 52, wherein said report is communicated to a handheld computing device at the same approximate time as said handheld device is being used to input fleet data.

54. A method for processing and communicating through the web information pertinent to fleet tire management, comprising:
accumulating fleet data on a central production database through a distributed communications network wherein said fleet data comprises tire physical parameters including information relating to at least one physical property of a tire;
processing said fleet data to identify characteristics of a particular tire or group of tires of a fleet that present possibilities to improve fleet performance if the physical characteristic of particular tire or group of tires were altered;
preparing a report to present the characteristics that present opportunities to improve performance characteristics; and,
transmitting said report through a distributed communications network wherein said report provides information sufficient to permit the performance characteristics to be improved.
